(19) United States
(12) Patent Application Publication
(10) Pub. No.: US 2017/0076403 A1
(43) Pub. Date: Mar. 16, 2017

(54) SYSTEMS, METHODS AND ARTICLES TO PROVIDE OLFACTORY SENSATIONS IN A SOCIAL NETWORK ENVIRONMENT

(71) Applicant: VAPOR COMMUNICATIONS, INC., Cambridge, MA (US)

(72) Inventors: David A. Edwards, Boston, MA (US); Rachel Diane Field, Huntington Beach, CA (US)

(21) Appl. No.: 15/121,937

(22) PCT Filed: Oct. 15, 2014
(86) PCT No.: PCT/US2014/060614

§ 371 Date: Aug. 26, 2016

Related U.S. Application Data
(60) Provisional application No. 61/944,866, filed on Feb. 26, 2014.

(51) Int. Cl. G06Q 50/00; B05B 7/24; B05B 7/00

(52) U.S. Cl. CPC G06Q 50/01; B05B 7/0081; B05B 7/2472

(57) ABSTRACT

Systems and methods for dispensing scents in a social network environment. Users of a social network service can combine visual, audio, and olfactory effects into digital posts or messages that can be experienced by other users of the social network service. A program executing on a user computing device facilitates user interaction with the social network service. The program operates to control one or more scent dispensing devices to cause the scent dispensing devices to dispense one or more scents according to a scent specification generated by users of the social network service.

### BACKGROUND

Technical Field

The present disclosure relates generally to the selective dispensing of combinations and sequences scents that are specified in scent specifications.

Description of the Related Art

The sense of smell (i.e., olfactory perception) is extremely important to humans. For example, the smell of smoke can alert a person of the potential dangers of a nearby fire. Additionally, smells can trigger memories and impact our emotions. Various forms of aromatherapy have been investigated in attempts to alter a person's mind, mood, cognitive function, and/or health.

A number of systems and devices have been developed for selectively providing olfactory sensations. For a variety of reasons, such systems and devices have proven to be inadequate and have not gained commercial acceptance. For example, the Smell-O-Vision system was developed over fifty years ago, which caused a number of different odors to be emitted from the seats in a movie theater when triggered by a film's soundtrack. That system was expensive and had technical problems. Accordingly, the Smell-O-Vision system was used in conjunction with only one film.

New approaches that enable users to quickly and easily generate customized scent specifications for communicating specific themes, ideas, and/or feelings using sequences and combinations of scents are desirable. Additionally, new systems and devices that dispense scents based on such scent specifications are desirable.

### BRIEF SUMMARY

A computer-implemented method of messaging in a social network environment may be summarized as including: receiving a scent message at a social network service over a communications network, the scent message including at least one of a scent specification file or a reference to a scent specification file stored in a data storage, the scent specification file specifies at least one scent dispensable by a scent dispensing device; and sending the scent message to a receiving client device of a receiving user of the social network service over the communications network.

The computer-implemented method may further include: sending the scent specification file to the receiving client device. The computer-implemented method may further include: in response to receiving the scent specification file, causing scent dispensing instructions to be sent from the receiving client device to a scent dispensing device. The computer-implemented method may further include: causing at least one scent to be dispensed according to the scent dispensing instructions receive by the scent dispensing device. The scent message may include at least one of an audio portion and a visual portion, and the method may further include: presenting the at least one of the audio portion and the visual portion by the receiving client device during at least a portion of the dispensing of the at least one scent at the scent dispensing device. The scent message may include at least one of an audio portion and a visual portion, and the method may further include: presenting the at least one of the audio portion and the visual portion by the receiving client device. The scent message may include a reference to at least one of an audio portion and a visual portion, the at least one of the audio portion and the visual portion stored in a data storage. The computer-implemented method may further include: receiving the scent specification file from a sending client device over the communications network; and sending the scent specification file to the receiving client device. The scent message may include a reference to the scent specification file stored in the data storage, and the method may further include: receiving a request including the reference to the scent specification file; retrieving the scent specification file from the data storage; and sending the scent specification file to the receiving client device responsive to the received request. The receiving a request may include receiving a request originating at the receiving client device. The scent specification file may include timing information for the dispensing of the at least one scent on a scent dispensing device. The timing information may specify the at least one scent is dispensed sequentially a number N times. The scent message may include at least one of an audio portion and a visual portion, and the timing information may associate playback of the at least one scent with the at least one of the audio portion and the visual portion. The scent specification file may specify a plurality of scents and may include a visual portion, the visual portion providing a time-based visual illustration of the scent specification file. Sending the scent message may include sending a personal message to the receiving client device through the social network service. Sending the scent message may include generating a digital post associated with the scent message on the social network service that is viewable on the receiving client device. Sending the scent message may include sending an email to the receiving client device. The scent message may include at least one of an audio portion and a visual portion. The scent specification file may specify a sequence of scents. The computer-implemented method may further include: receiving a comment from a client device of a user of the social network service; and associating the comment with the scent message. Sending the scent message may include generating a digital post associated with the scent message on the social network service that is accessible on the receiving client device, and associating the comment with the scent message may include adding the received comment to the generated digital post. The computer-implemented method may further include: receiving a modification instruction associated with the scent message from a client device; and generating a modified scent specification file according to the modification instruction. The computer-implemented method may further include: causing a presentation of a scent sequence specification user interface on a display of a sending client device, the scent sequence specification user interface including a scent palette of a set of user selectable scent icons, each of the user selectable scent icons corresponding to a respective scent, the scent sequence specification user interface further including an array of scent specification fields which are selectively populatable via selections of the user selectable scent icons from the scent palette; receiving inputs via the scent sequence specification user interface; and generating the scent specification file based at least in part on the inputs received via the scent sequence specification user interface. The computer implemented method may further include: storing the scent specification file in a data storage. Causing the presentation of the scent sequence specification user interface may include causing a presentation of the scent sequence specification user interface including two or more categories of scents. Causing the presentation of the scent sequence specification user interface may include causing a presentation of a first array of user selectable scent icons each of which represents a respective scent of a first category of scent, and at least a second array of user selectable scent icons each of which represents a respective scent of a second category of scent, the second category of scent different from the first category of scent. The computer-implemented method may further include storing the scent specification file on a data storage of a service other than the social network service.

A computer-implemented method of messaging in a social network environment may be summarized as including: receiving a digital post from a sending client device at a social network service over a communications network, the digital post identifying at least one scent dispensable by a scent dispensing device; and sending the received digital post to a receiving client device of a receiving user of the social network service for viewing on a display of the receiving client device.

The computer-implemented method may further include: receiving a selection of the digital post from the receiving client device; and responsive to receiving the selection of the digital post, sending a scent specification file to the receiving client device, the scent specification file encoding instructions for dispensing the at least one scent. The computer-implemented method may further include: sending scent dispensing instructions from the receiving client device to a scent dispensing device. Receiving a selection of the digital post may include detecting that the receiving user has selected a link using a user interface of the receiving client device. Receiving a digital post may include receiving a digital post that includes at least one of an audio portion and a visual portion. Receiving a digital post may include receiving a digital post that includes a visual portion comprising at least one of a text portion, an image portion, and a video portion. The digital post may include a selectable reference to a scent message, the scent message specifying the at least one scent. The scent message may include at least one of an audio portion and a visual portion. The scent message may include at least one of an audio portion, a visual portion, a reference to an audio portion stored in a data storage, and a reference to a visual portion stored in a data storage.

A client device to facilitate participation in a social network service for a user of the client device may be summarized as including: a user interface including a display; a communications interface that provides communication with a scent dispensing device of the user and communication with the social network service; a processor coupled to the user interface and the communications interface; and a computer-readable storage medium that stores instructions that, when executed by the processor, cause the client device to: present a digital post on the display, the digital post providing an indication of at least one scent specified by a user of the social network service different than the user of the client device; receive a selection of the digital post from the user via the user interface; and receive a scent specification file that includes instructions for the dispensing the at least one scent.

The instructions may cause the client device to: send at least a portion of the scent specification file to the scent dispensing device. The communications interface may be a wireless communications interface, and the instructions may cause the client device to send at least a portion of the scent specification file to the scent dispensing device over the wireless communications interface. The digital post may include a reference to a scent message stored in a data storage, the scent message may specify the at least one scent, and the instructions may cause the client device to: receive the scent message from the data storage via the communications interface. The scent message may include at least one of an audio portion and a visual portion. The scent message may associate the at least one scent with the at least one of the audio portion and the visual portion. The communications interface may include a short-range radio and antenna interface. The instructions may cause the client device to: receive inputs from the user via the user interface; modify a scent specification file for the specified at least one scent based at least in part on the received inputs to generate at least one modified scent specification file; generate a digital post associated with the at least one modified scent specification file; and send the digital post to a computing device of the social network service such that the digital post is subsequently viewable by at least one other client device connected to the social network service. The scent dispensing device may receive a consumable scent cartridge and may store a contents indicator for the consumable scent cartridge when the consumable scent cartridge is removably disposed within the scent dispensing device; wherein the instructions may cause the client device to: send a message to the scent dispensing device requesting the stored contents indicator; and receive a message from the scent dispensing device that includes the requested contents indicator. The consumable scent cartridge may include a memory that stores the contents indicator, and the scent dispensing device may include a memory access portion operative to access the memory of the consumable scent cartridge to read the contents indicator. The memory access portion may include at least one electrical contact that interfaces with an electrical contact of the consumable scent cartridge that is communicatively coupled to the memory of the consumable scent cartridge. The instructions may cause the client device to: identify a social network service contact of the user; send a request for a contents indicator for a scent dispensing device associated with the social media service contact; and receive the contents indicator from a computing device associated with the social network service. The consumable scent cartridge may contain a consumable quantity of scent medium, and the instructions may cause the client device to: monitor a present level of the quantity of scent medium present in the consumable scent cartridge; and provide an indication of the present level to the user via the user interface. The instructions may cause the client device to track at least one of a number of uses and a duration of use for the consumable scent cartridge. The scent dispensing device may include a sensor operative to measure a physical characteristic of the quantity of scent medium, and the instructions may cause the client device to monitor a signal that corresponds to an output of the sensor. The communications interface may provide communication with a plurality of scent dispensing devices, each of the plurality of scent dispensing devices operative to dispense a plurality of scents, and the instructions may cause the client device to: receive inputs from the user via the user interface, the inputs defining at least one scent specification file and a selection of at least one of the plurality of scent dispensing devices; and send the at least one scent specification file to the selected at least one of the plurality of scent dispensing devices over the communications interface, wherein each of the scent dispensing devices in the selected at least one of the plurality of scent dispensing devices dispenses a scent according to the scent specification file. The communications interface may include a wireless interface. The instructions may cause the client device to send the same selected at least one scent specification file to at least two of the plurality of scent dispensing devices. The selected at least one scent specification file may include at least two scent specification files, and the instructions may cause the client device to send the at least two scent specification files to different ones of the plurality of scent dispensing devices.

A client device to facilitate participation in a social network service for a user of the client device may be summarized as including: a user interface including a display; a communications interface operative to provide communication with an external device; a processor coupled to the user interface and the communications interface; and a computer-readable storage medium that stores instructions that, when executed by the processor, cause the client device to: present a scent sequence specification selection interface on the display, the scent sequence specification selection interface including a scent palette of a set of user-selectable scent icons, each of the user selectable scent icons corresponding to a respective scent, the scent sequence specification selection interface further including an array of scent specification fields which are selectively populatable via selections of the user selectable scent icons from the scent palette; receive inputs from the user via the user interface; generate a scent specification file based at least in part on the received inputs; generate a digital post associated with the scent specification file; and send the digital post to a computing device of the social network service so that the digital post is subsequently viewable by at least one other client device connected to the social network service.

The instructions may cause the client device to receive inputs from the user via the user interface specifying at least one of text, audio, and video, and to associate the at least one of text, audio, and video with the digital post. The scent specification file may be stored on a data storage, and the digital post may include a reference to the scent specification file accessible by at least one other client device connected to the social network service. The scent specification file may specify at least one scent and may specify timing information for dispensing of the at least one scent on a scent dispensing device.

A client device to facilitate participation in a social network for a user of the client device may be summarized as including: a user interface including a display; a communications interface that provides communication with a scent dispensing device, the scent dispensing device operative to dispense a plurality of scents; a processor coupled to the user interface and the communications interface; and a computer-readable storage medium that stores instructions that, when executed by the processor, cause the client device to: establish a link with a media player that provides media content for consumption by the user; receive time-based signals from the media player that relate to the media content; and control the dispensing of scents by the scent dispensing device according to the received time-based signals.

The media player may include a video player and the time-based signals may include video time code signals. The media player may include an audio player and the time-based signals may include audio watermark signals. The media player may include an electronic book reader and the time-based signals may be indicative of the user's location in a textual document.

A client device to facilitate participation in a social network for a user of the client device may be summarized as including: a user interface including a display; a communications interface that provides communication with a scent dispensing device, the scent dispensing device operative to dispense a plurality of scents; a processor coupled to the user interface and the communications interface; and a computer-readable storage medium that stores instructions that, when executed by the processor, cause the client device to: establish a link with a sensing device including a sensor operative to sense input and generate a sensor output dependent on the sensed input; receive signals from the sensing device that correspond to the sensor output; and control the dispensing of scents by the scent dispensing device according to the received signals.

The sensor of the sensing device may sense a physical characteristic of the user, and the instructions may cause the client device to control the dispensing of scents by the scent dispensing device dependent on the sensed physical characteristic of the user.

A computer-implemented method of messaging in a social network environment may be summarized as including: providing an image file; providing a graphical icon including a reference to a resource, the resource relating at least one of a scent message or a scent message application; associating the graphical icon with the image file; and posting the image file and the associated graphical icon to a social network service where the graphical icon is selectable by a user of the social network service.

The method may further include: receiving a selection of the graphical icon from a client computing device; and providing the resource to the client computing device responsive to receiving the selection. Providing the resource to the client computing device may include serving a web page to the client computing device. Providing the resource to the client computing device may include sending a scent message to the client computing device.

A computer-implemented method of messaging in a social network environment may be summarized as including: providing a content file that relates to at least one product or service; associating a reference to a resource with the content file, the resource relating to at least one scent dispensable by a scent dispensing device; posting the content file to a social network service; receiving a selection relating to the content file from a client computing device; and causing the resource to be sent to the client computing device responsive to receiving the selection.

Causing the resource to be sent to the client computing device may include causing an application to be sent to the client computing device for execution by a processor of the client computing device, and the application may cause the client computing device to present one or more scent messages to a user of the client computing device. Causing the resource to be sent to the client computing device may include causing a scent message to be sent to the client computing device.

### BRIEF DESCRIPTION OF THE SEVERAL VIEWS OF THE DRAWINGS

FIG. 1A is an isometric view of a scent dispensing device, according to one illustrated embodiment.

FIG. 1B is an exploded view of the scent dispensing device of FIG. 1A.

FIG. 2A is an isometric view of a scent emitter, according to one illustrated embodiment.

FIG. 2B is an exploded view of the scent emitter of FIG. 2A.

FIG. 3A is a front elevational view of a first diffuser part, according to one illustrated embodiment.

FIG. 3B is a rear elevational view of the first diffuser part of FIG. 3A.

FIG. 3C is a top plan view of the first diffuser part of FIG. 3A, with a fan attached thereto.

FIG. 4 is a front elevational view of a second diffuser part, according to one illustrated embodiment.

FIG. 5A is a front elevational view of a scent mixing chamber according to one illustrated embodiment.

FIG. 5B is a bottom plan view of the scent mixing chamber of FIG. 5A.

FIG. 6A is a top plan view of an upper shelf of the scent dispensing device of FIG. 1A.

FIG. 6B is an enlarged view of a portion of the upper shelf of FIG. 6A.

FIG. 7A is a side elevational view of a motor, according to one illustrated embodiment.

FIG. 7B is a top plan view of the motor of FIG. 7A.

FIG. 8A is a top plan view of a lower shelf of the scent dispensing device of FIG. 1A.

FIG. 8B is an enlarged view of a portion of the lower shelf of FIG. 8A.

FIG. 9A is a front elevational view of a scent cartridge, according to one illustrated embodiment.

FIG. 9B is cross-sectional view taken along line I-I of FIG. 9A.

FIG. 9C is a top plan view the scent cartridge of FIG. 9A.

FIG. 9D is top plan view of the scent cartridge of FIG. 9A, with an end portion thereof removed.

FIG. 10A is an isometric view of a scent dispensing device according to one illustrated embodiment.

FIG. 10B is a partially exploded view of the scent dispensing device of FIG. 10A.

FIG. 10C is another partially exploded view of the scent dispensing device of FIG. 10A.

FIG. 10D is cross-sectional view taken along line II-II of FIG. 10A.

FIG. 10E is bottom plan view of a scent mixing chamber of the scent dispensing device of FIG. 10A.

FIG. 11A is a top plan view of a scent cartridge holder of the scent dispensing device of FIG. 10A.

FIG. 11B is an isometric view of the scent cartridge holder of FIG. 11A.

FIG. 12A is an isometric view of a scent cartridge of the scent dispensing device of FIG. 10A.

FIG. 12B is a partially exploded view of the scent cartridge of FIG. 12A.

FIG. 12C is a bottom plan view of the scent cartridge of FIG. 12A.

FIG. 13A is a horizontal slice view taken along line III-III of FIG. 12A, according to one illustrated embodiment.

FIG. 13B is a horizontal slice view taken along line III-III of FIG. 12A, according to one illustrated embodiment.

FIG. 13C is a horizontal slice view taken along line III-III of FIG. 12A, according to one illustrated embodiment.

FIG. 13D is a horizontal slice view taken along line III-III of FIG. 12A, according to one illustrated embodiment.

FIG. 13E is a horizontal slice view taken along line III-III of FIG. 12A, according to one illustrated embodiment.

FIG. 13F is a horizontal slice view taken along line III-III of FIG. 12A, according to one illustrated embodiment.

FIG. 14A is an isometric view of an end portion of a scent cartridge, according to one illustrated embodiment.

FIG. 14B is an exploded view of the end portion of the scent cartridge of FIG. 14A.

FIG. 14C is a bottom plan view of a hermetically sealed membrane of the end portion of the scent cartridge of FIG. 14A, according to one illustrated embodiment.

FIG. 15A an exploded view of a scent cartridge pouch, according to one illustrated embodiment.

FIG. 15B is an exploded view of a scent cartridge blister pack, according to one illustrated embodiment.

FIG. 16 is a network diagram of a scent dispensing system according to one illustrated embodiment.

FIGS. 17A-17F illustrate a schematic diagram of a scent dispensing device, according to one illustrated embodiment.

FIG. 18 is a block diagram of a mobile device, according to one illustrated embodiment.

FIG. 19 is a block diagram of a server, according to one illustrated embodiment.

FIG. 20 is block diagram of a scent sequence specification user interface, according to one illustrated embodiment.

FIG. 21 is a flowchart of a method of operating a scent dispensing system, according to one illustrated embodiment.

FIG. 22 is a flowchart of a method of operating a scent dispensing system, according to one illustrated embodiment.

FIG. 23 is a flowchart of a method of operating a scent dispensing system, according to one illustrated embodiment.

FIG. 24A is a top plan view of a scent cartridge, according to one illustrated embodiment.

FIG. 24B is a top plan view of the scent cartridge of FIG. 24A rotated clockwise by 144°.

FIG. 24C is a top plan view of the scent cartridge of FIG. 24B rotated clockwise by 72°.

FIG. 25 is a flowchart of a method of operating a scent dispensing system, according to one illustrated embodiment.

FIG. 26 is a flowchart of a method of operating a scent dispensing system, according to one illustrated embodiment.

FIG. 27 is a network diagram of a scent dispensing system, according to one illustrated embodiment.

FIG. 28 is a network diagram of a scent dispensing system, according to one illustrated embodiment.

FIGS. 29-72 are screenshots of a graphical user interface for a social media application, according to one illustrated embodiment.

FIG. 73 is a flowchart of a method of operating a scent dispensing system, according to one illustrated embodiment.

FIG. 74 is a flowchart of a method of operating a scent dispensing system, according to one illustrated embodiment.

FIG. 75 is a flowchart of a method of operating a scent dispensing system, according to one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with microcontrollers, motor devices, power supplies such as DC/DC converters, wireless radios (i.e., transmitters, receivers or transceivers), computing systems including client and server computing systems, and networks (e.g., cellular, packet switched), as well as other communications channels, have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

The structure of various embodiments of a scent dispensing device will be described first. A scent dispensing system will then be described. The structure of various components of scent dispensing system will be described next. Several examples of operating of the scent dispensing system will then be described.

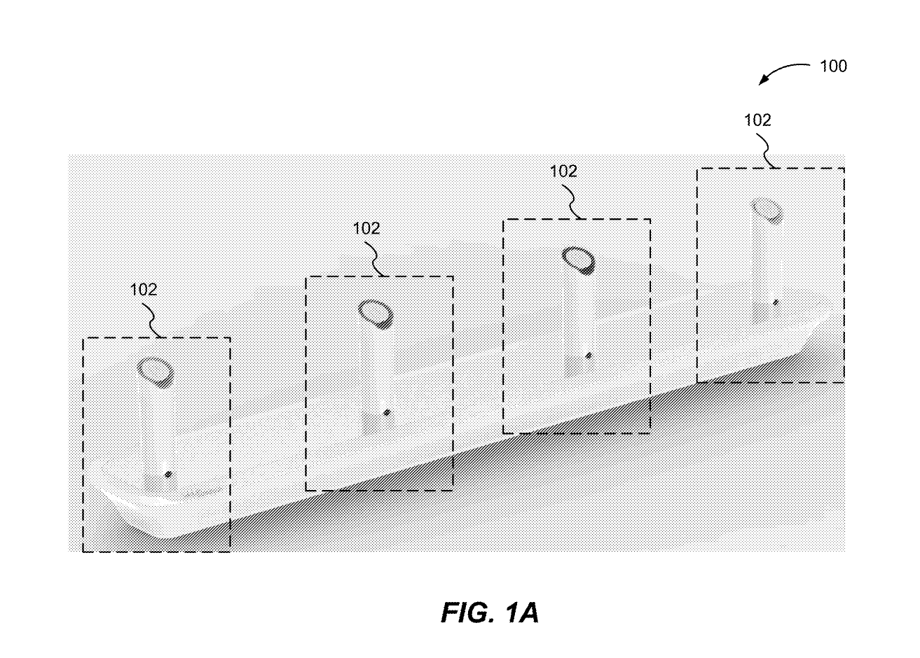

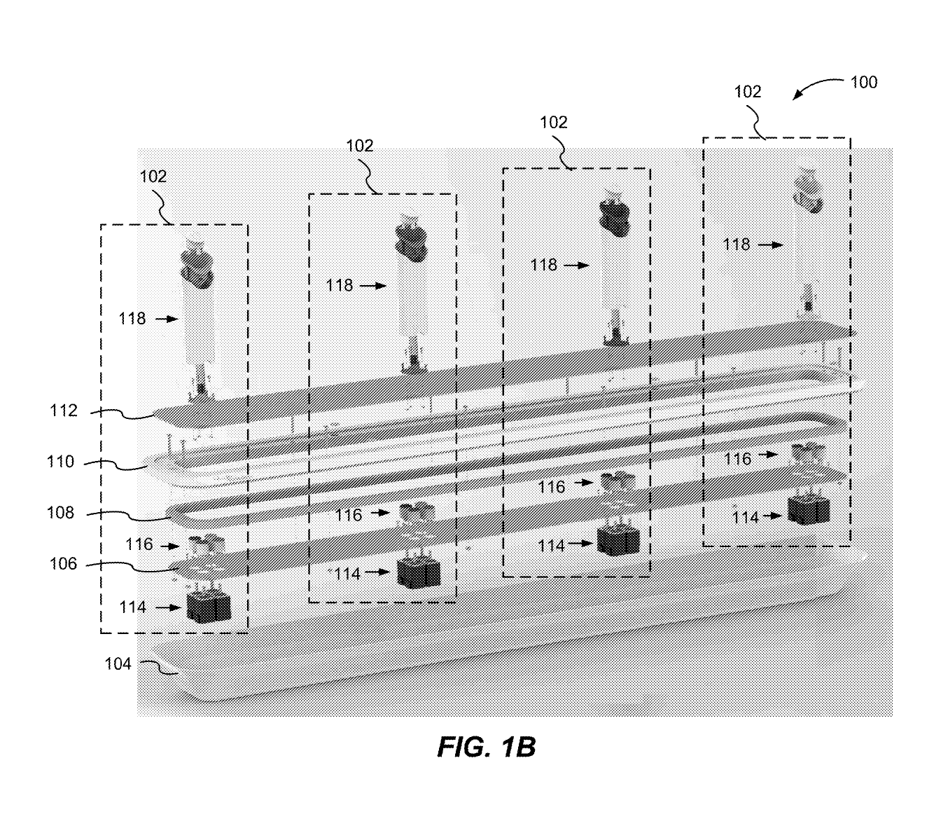

FIG. 1A is an isometric view of a scent dispensing device 100 according to one illustrated embodiment. FIG. 1B is an exploded view of the scent dispensing device 100. The scent dispensing device 100 includes four scent dispensing units 102, a base 104, a lower shelf 106, a spacer 108, a retaining member 110, and an upper shelf 112. Each scent dispensing unit 102 includes four motors 114, four scent cartridges 116, a scent emitter 118, and a number of electronic components that will be described below.

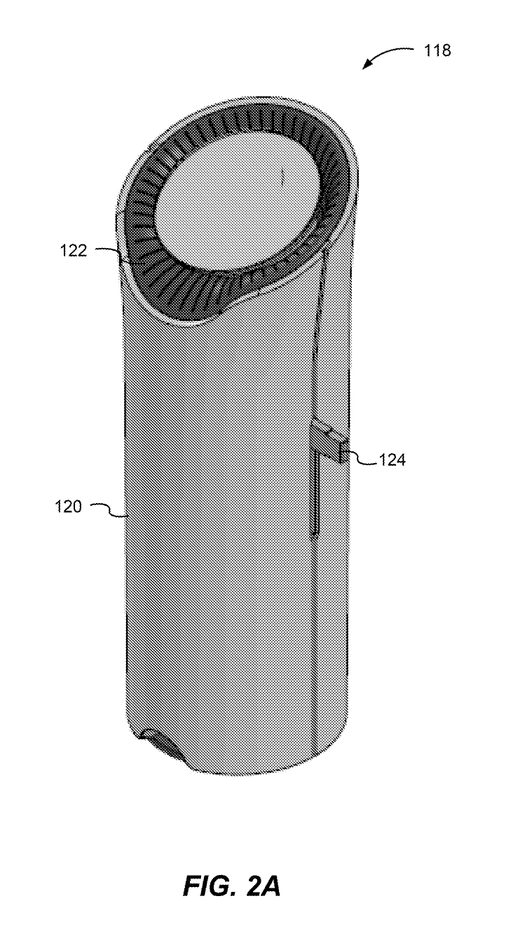

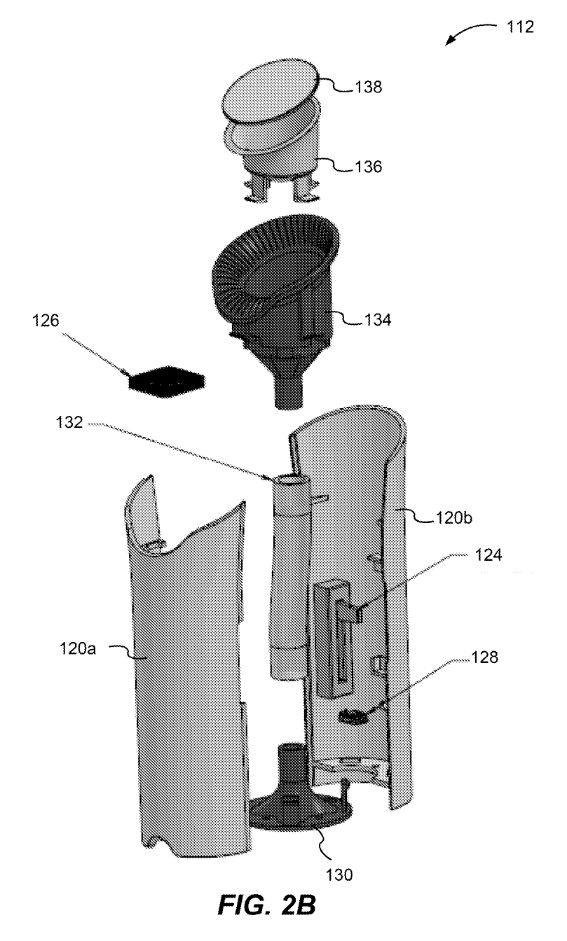

FIG. 2A is an isometric view of the scent emitter 118 according to one illustrated embodiment. FIG. 2B is an exploded view of the scent emitter 118 shown in FIG. 2A. The scent emitter 118 includes a housing 120 having a first housing portion 120a and a second housing portion 120b, a diffuser 122, a switch 124 that is used to control operation of a fan 126, a communications interface connector 128, a scent mixing chamber 130, and a conduit 132. In one embodiment, the communications interface connector 128 is a USB A-Type, female connector. The diffuser 122 includes a first diffuser portion 134, a second diffuser portion 136, and a third diffuser portion 138.

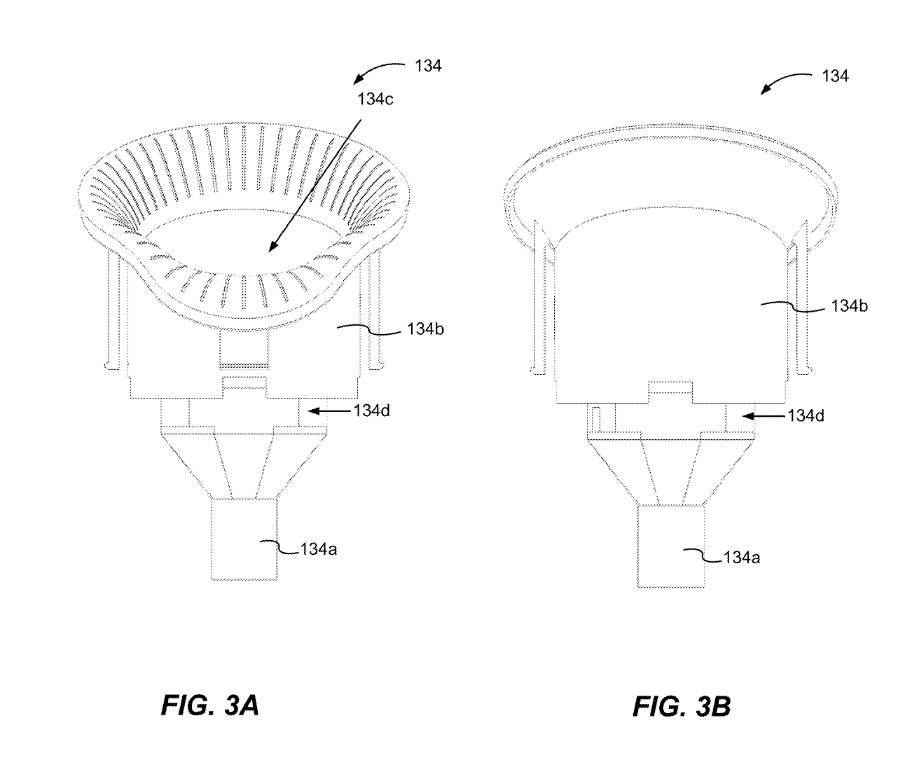

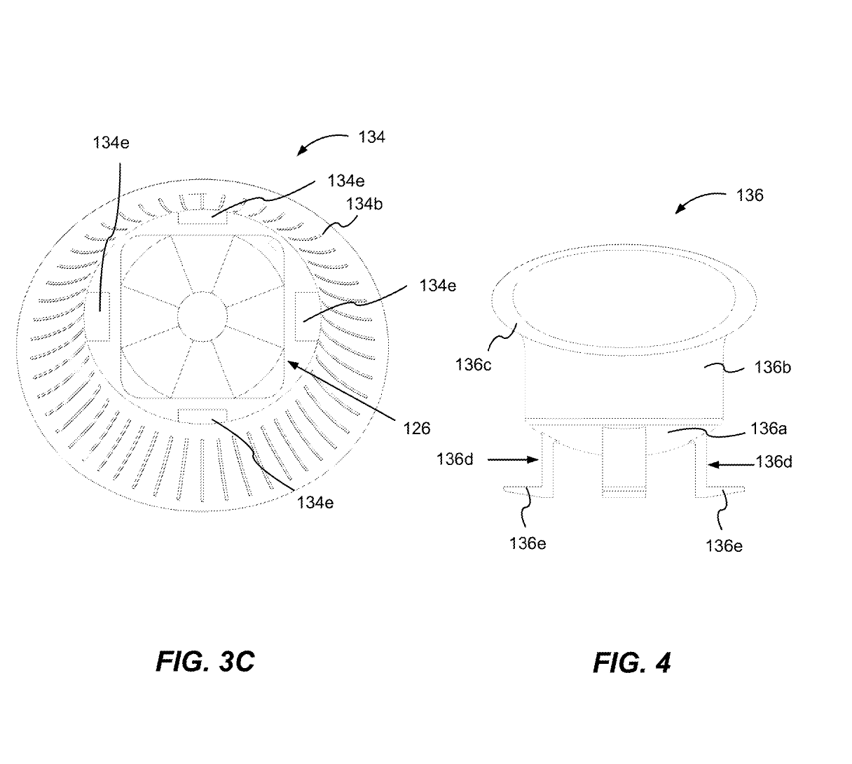

FIGS. 3A-3C show various views of the first diffuser portion 134 shown in FIG. 2B. The first diffuser portion 134 includes an inlet port 134a and a chamber 134b that defines an outlet port 134c. The inlet port 134a of the first diffuser portion 134 serves as an inlet port of the diffuser 122 and the outlet port 134c serves as an outlet port of the diffuser 122. A compartment 134d is disposed between the inlet port 134a and the outlet port 134c. The compartment 134d is sized and dimensioned to hold at least part of the fan 126 therein. The fan 126 is operable to cause air to flow from the inlet port 134a to the outlet port 134c of the first diffuser portion 134. As shown in FIG. 3C, the first diffuser portion 134 includes four rectangular apertures 134e formed in a lower portion of the chamber 134b.

FIG. 4 is a front elevational view of the second diffuser portion 136 shown in FIG. 2B. The second diffuser portion 136 includes a lower portion 136a, an upper portion 136b, and a lip 136c that extends outwardly from the periphery of the top of the upper portion 136b. Four retaining members 136d extend outwardly from the lower portion 136a of the second diffuser portion 136d; only three of the retaining members 136d can be seen in FIG. 4. A tapered portion 136e extends outwardly from each of the retaining members 136d.

The diffuser 122 is assembled by attaching the first diffuser portion 134 to the second diffuser portion 136, and by attaching the third diffuser portion 138 to the second diffuser portion 136. More particularly, the second diffuser portion 136 is placed inside the first diffuser portion 134, the retaining members 136d are aligned with the rectangular apertures 134e formed in a lower portion of the chamber 134b, and the second diffuser portion 136 is advanced toward the first diffuser portion 134 until the tapered portions 136e extend through the rectangular apertures 134e. The third diffuser portion 138 may be attached to the lip 136c of the second diffuser portion 136 using an adhesive. For example, an epoxy resin is placed on the top surface of the lip 136c, the third diffuser portion 138 is placed above the second diffuser portion 136, and the third diffuser portion 138 is advanced toward the second diffuser portion 136 until the bottom surface of the third diffuser portion 138 contacts the epoxy resin on the top surface of the lip 136c.

The first diffuser portion 134 and the second diffuser portion 136 are sized and dimensioned such that, when the second diffuser portion 136 is attached to the first diffuser portion 134, a passage is formed between the interior surfaces of the chamber 134b of the first diffuser portion 134 and the exterior surfaces of the second diffuser portion 136. When the scent emitter 118 is assembled and operated, the fan 126 causes air to flow into the inlet port 134a of the first diffuser portion 134, around the exterior surfaces of the second diffuser portion 136, and out of the outlet port 134c of the first diffuser portion 134.

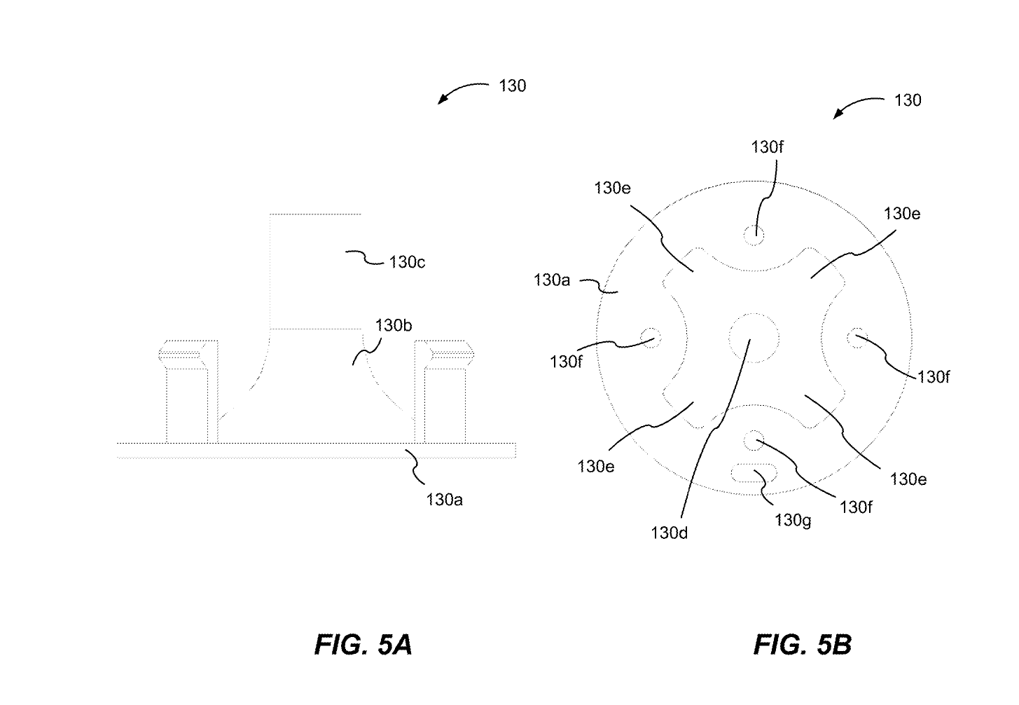

FIGS. 5A and 5B are front and bottom plan views, respectively, of the scent mixing chamber 130. The scent mixing chamber 130 includes a bottom portion 130a, a center portion 130b, and a top portion 130c that serves as an outlet port for the scent mixing chamber 130. As shown in FIG. 5B, the scent mixing chamber 130 includes a plurality of channels 130e that extend from the bottom portion 130a through the center portion 130b to the top portion 130c. The bottom portion 130a of the scent mixing chamber 130 includes four circular apertures 130f and an oval-shaped aperture 130g.

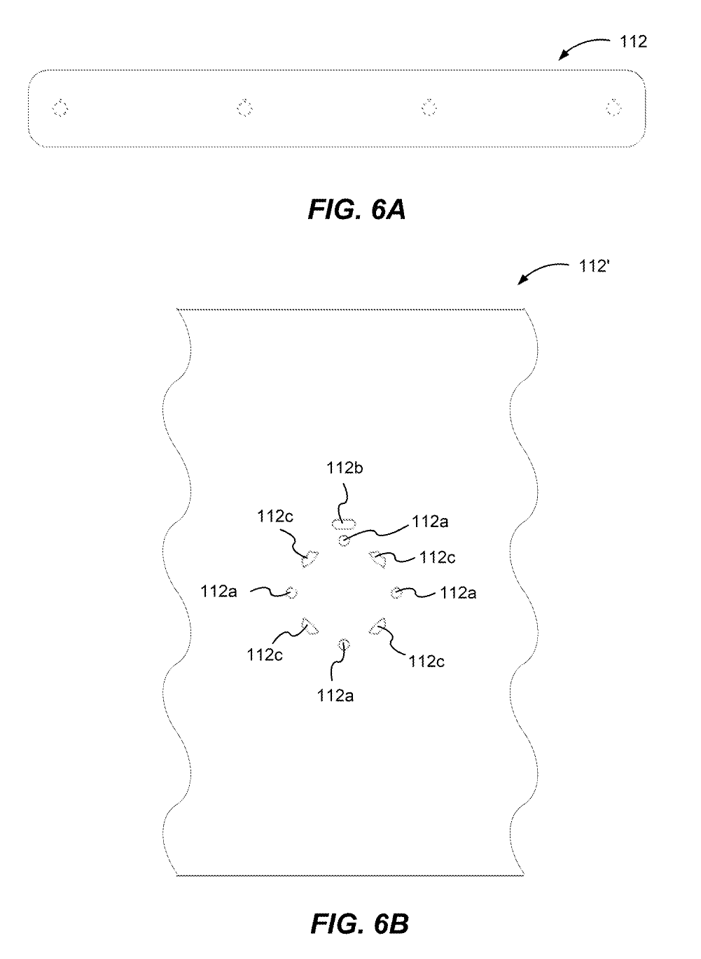

FIG. 6A is a top plan view of the upper shelf 112 of the scent dispensing device 100. FIG. 6B is an enlarged view of a portion 112′ of the upper shelf 112 of the scent dispensing device 100. The portion 112′ of the upper shelf 112 includes four circular apertures 112a, an oval-shaped aperture 112b, and four wedge-shaped apertures 112c.

Four scent mixing chambers 130 are attached to the upper shelf 112 using a plurality of nuts and bolts (not labeled). A process for attaching one of the scent mixing chambers 130 to the upper shelf 112 will now be described with reference to FIGS. 1B, 5A, 5B, 6A, and 6B. The scent mixing chamber 130 is placed on a top surface of the upper shelf 112 such that the circular apertures 130f of the scent mixing chamber 130 are aligned with a group of four circular apertures 112a of the upper shelf 112. Four bolts are inserted into respective circular apertures 130f of the scent mixing chamber 130 and passed through corresponding circular apertures 112a of the upper shelf 112. A nut is then secured to each bolt. The above-described process is repeated for each of the remaining scent mixing chambers 130. When the scent mixing chambers 130 are attached to the upper shelf 112, the wedge-shaped apertures 112c of the upper shelf 112 act as inlet ports to the scent mixing chambers 130.

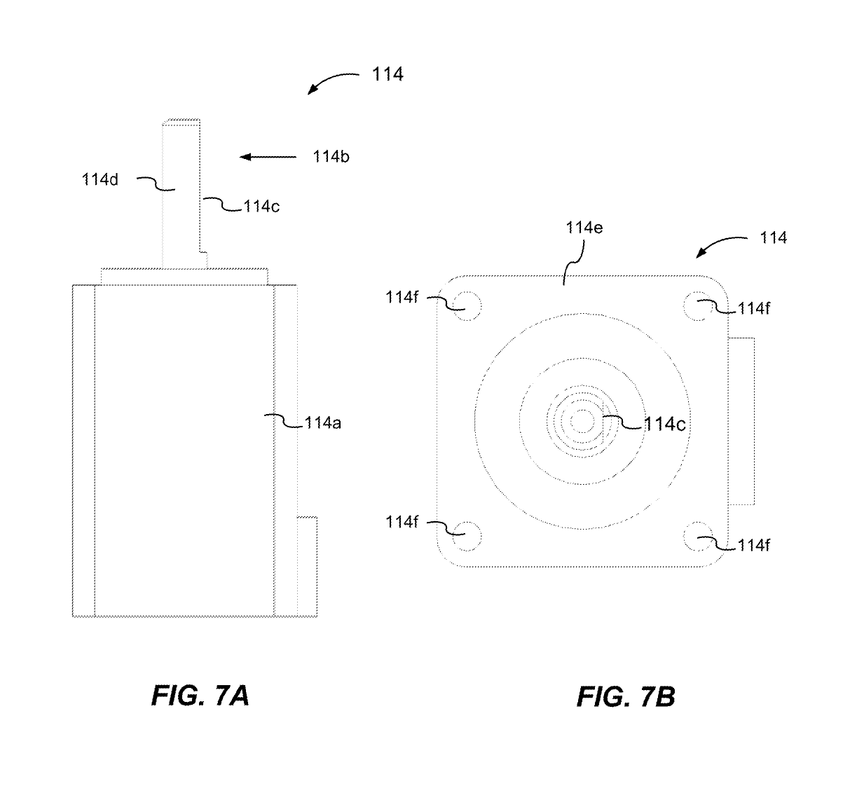

FIG. 7A is a side elevational view of the motor 114 according to one illustrated embodiment. The motor 114 includes a motor housing 114a and a shaft 114b that extends from the motor housing 114a. The shaft 114b includes a flat portion 114c and a truncated cylindrical portion 114d. As shown in FIG. 7B, the motor 114 includes a top portion 114e having a plurality of apertures 114f.

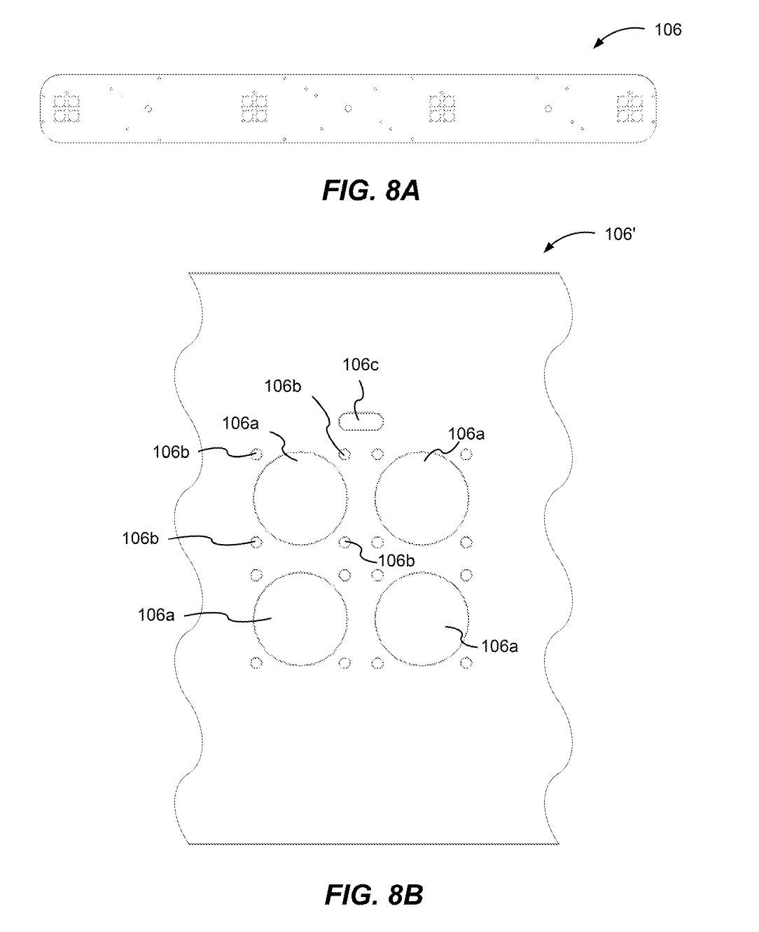

FIG. 8A is a top plan view of the lower shelf 106 of the scent dispensing device 100. FIG. 8B is an enlarged view of a portion 106′ of the upper shelf 106 shown in FIG. 8A. The portion 106′ of the lower shelf 106 includes four large circular apertures 106a, sixteen small circular apertures 106b, and an oval-shaped aperture 106c.

Sixteen motors 114 are attached to the lower shelf 106 using a plurality of bolts (not labeled). A process for attaching one of the motors 114 to the lower shelf 106 will now be described with reference to FIGS. 1B, 7A, 7B, 8A, and 8B. One of the motors 114 is placed below the lower shelf 106 such that the circular apertures 114f of the motor 114 are aligned with a group of four small circular apertures 106b surrounding one of the large circular apertures 106a of the lower shelf 106. The motor 114 is advanced toward the lower shelf 106 and the shaft 114b is passed through the large circular aperture 106a until the top portion 114e of the motor 114 abuts the bottom surface of the lower shelf 106. Four bolts are inserted through respective small circular apertures 106b of the lower shelf 106 and are advanced into the circular apertures 114f of the motor 114. The bolts are rotated to engage threads (not shown) within the motor housing 114a thereby attaching the motor 114 to the lower shelf 106. The above-described process is repeated for the remaining fifteen motors 114.

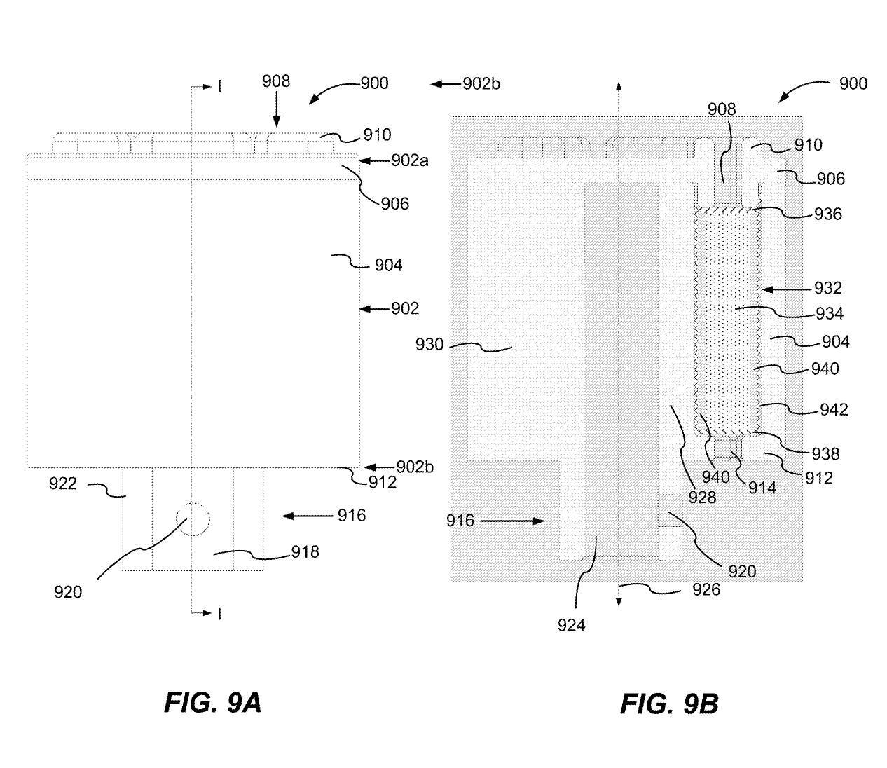

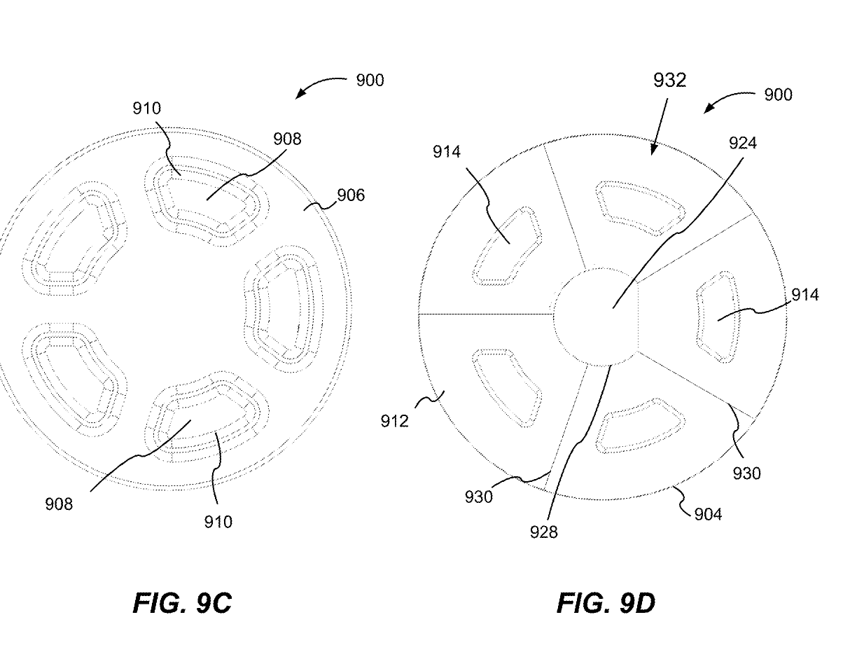

A scent cartridge 900 according to one illustrated embodiment will now be described with reference to FIGS. 9A-9D. FIG. 9A is a front elevational view of the scent cartridge 900. FIG. 9B is cross-sectional view taken along line I-I of FIG. 9A. FIG. 9C is a top plan view the scent cartridge 900. FIG. 9D is top plan view of the scent cartridge of FIG. 900, with a first end portion 906 removed.

As shown in FIG. 9A, the scent cartridge 900 includes a housing 902 having a first end 902a and a second end 902b. A cylindrical outer wall 904 defines a peripheral perimeter of the housing 902. A first end portion 906 is disposed at the first end 902a of the scent cartridge 900. The first end portion 906 includes five wedge-shaped apertures 908. A raised lip 910 extends outwardly from the first end portion 906 around the periphery of each of the apertures 908.

A second end portion 912 is disposed at the second end 902b of the scent cartridge 900. As best shown in FIG. 9D, the second end portion 912 includes five wedge-shaped apertures 914. As best shown in FIG. 9A, an axle 916 extends outwardly from the second end portion 912. The axle 916 includes a planar portion 918 having a circular aperture 920. The axle 916 also includes a truncated cylindrical portion 922. The planar portion 918 and the truncated cylindrical portion 922 form a “D” shaped aperture 924. The aperture 924 of the axle 916 is sized and dimensioned such that the shaft 114b of the motors 114 can be inserted into the aperture 924. When the shaft 114b of one of the motors 114 is inserted into the aperture 924 of the axle 916, the planar portion 114c of the shaft 114b is adjacent the planar portion 918 of the axle 916, which ensures that rotation of the shaft 114d causes rotation of the scent cartridge 900 about a longitudinal axis 926 of the scent cartridge 900.

FIG. 9C is a top view of the scent cartridge 900, and FIG. 9D is a top view of the scent cartridge 900 with the first end portion 906 removed. A plurality of walls extends upwardly from the second end portion 912, including the outer wall 904, an axial wall 928, and five planar walls 930. The planar walls 930 extend radially from the axial wall 928 to the outer wall 904. The first end portion 906, the second end portion 912, the planar walls 930, the axial wall 928, and the outer wall 904 define five chambers 932 within the scent cartridge 900. For each of the chambers 932, one of the apertures 908 formed in the first end portion 906 is aligned with a corresponding aperture 914 formed in the second end portion 912.

Referring now to FIG. 9B, a cross-sectional view of the scent cartridge 900 taken along line I-I of FIG. 9A is shown. Only one of the five chambers 932 can be seen in FIG. 9B. The scent cartridge 900 may have virtually any desired number of scent cartridge chambers 932. One or more of the chambers 932 may be filled with a scent medium 934. The scent medium 934 may be a non-liquid substance such as aromatic particles, a scented powder, which may be in a packed powder form, a scented wax, an air filter, or an unscented material. One or more of the chambers 932 may be empty.

A first selective membrane 936 may be attached to the bottom surface of the first end portion 906 of the scent cartridge 900. The first selective membrane 936 includes apertures (not shown) formed therein that are sized and dimensioned to enable the molecules of the scent medium 934 to flow from the apertures 908 of the first end portion 906 of the scent cartridge 900. For example, the scent medium 934 may be in a particulate form and the first selective membrane 936 selectively passes air or scented air while not passing the scent medium 934 in the particulate form. In one embodiment, the scent cartridge 900 does not include the first selective membrane 936.

A second selective membrane 938 may be attached to the upper surface of the second end portion 912. The second selective membrane 938 may include apertures (not shown) formed therein that are sized and dimensioned to prevent the scent medium 934 from falling out of the apertures 914, and to enable air to flow through the apertures 914. In one embodiment, the second selective membrane 938 is a non-porous plastic material. In another embodiment, the scent cartridge 900 does not include the second selective membrane 938. In one embodiment, the first selective membrane 936 and the second selective membrane 938 are formed from a cotton material having a thread count of 56 threads per centimeter.

As shown in FIG. 9B, the scent medium 934 may be positioned in the chamber 932 such that one or more gaps 940 are formed along the length of the housing 902 between one or more of the walls that define the chamber 932 and the scent medium 934. In FIG. 9B, one of the gaps 940 is formed between the scent medium 934 and the outer wall 904, and one of the gaps is formed between the scent medium 934 and the axial wall 928. The gaps 940 facilitate air flow through the chamber 932.

In one embodiment, one or more interior surfaces of one or more of the walls that define one or more of the scent cartridge chambers 932 have a coating 942 (e.g., wax) formed thereon. In FIG. 9B, the coating 942 is formed on the interior surfaces of the outer wall 904 and the axial wall 928.

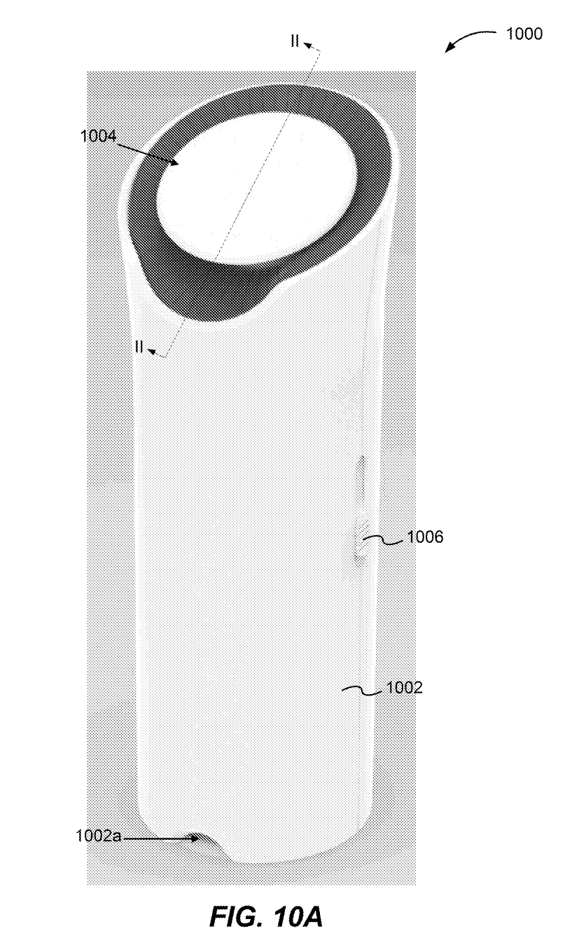

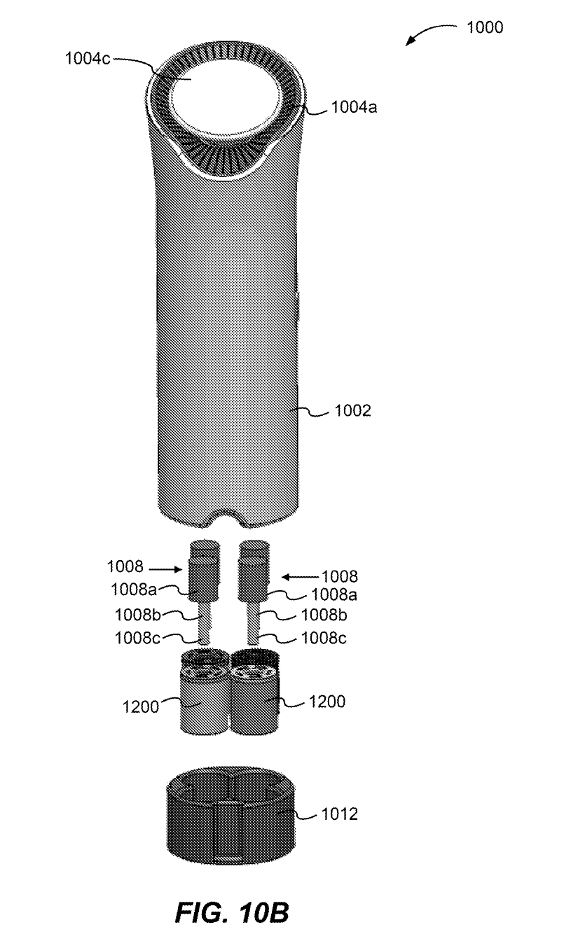

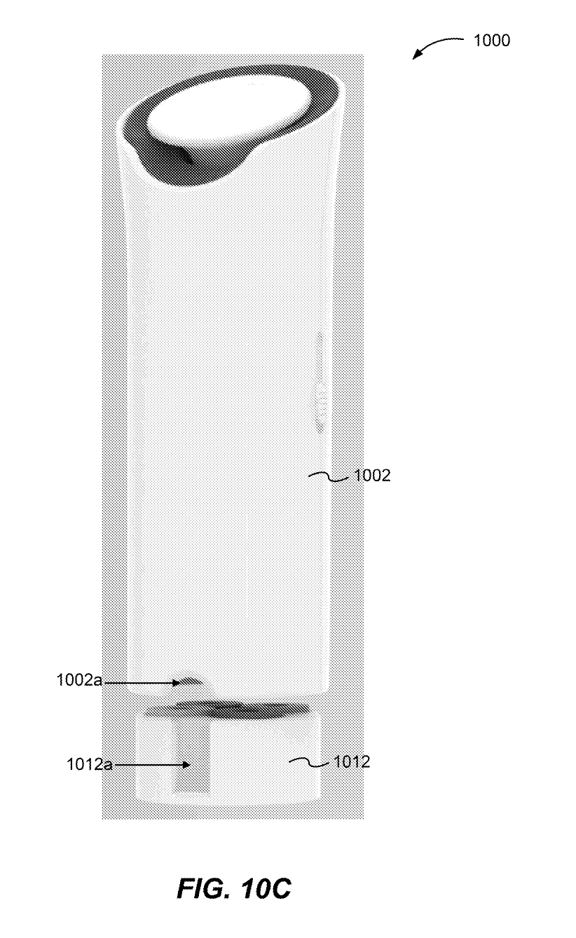

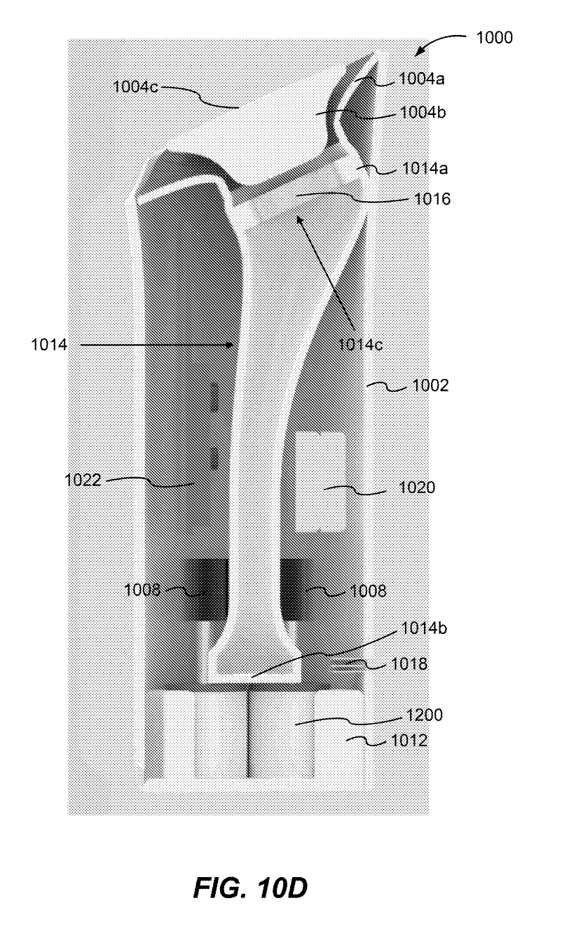

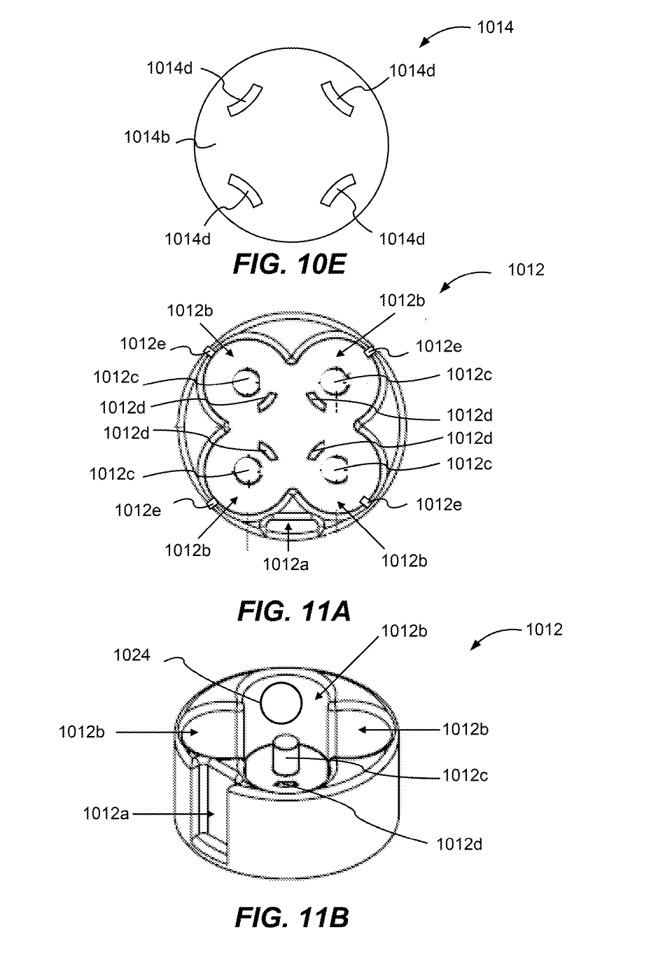

A scent dispensing device 1000 according to one illustrated embodiment will now be described with reference to FIGS. 10A-10E. FIG. 10A is an isometric view of the scent dispensing device 1000. FIGS. 10B and 10C are partially exploded views of the scent dispensing device 1000. FIG. 10D is cross-sectional view taken along line II-II of FIG. 10A. FIG. 10E is a bottom plan view of a scent mixing chamber shown in FIG. 10D.

As shown in FIG. 10A, the scent dispensing device 1000 includes a housing 1002 having a recessed portion 1002a, a diffuser 1004, and a switch 1006. As shown in FIG. 10B, the scent dispensing device 1000 also includes four motors 1008, four scent cartridges 1200, and a scent cartridge holder 1012. Each of the motors 1008 includes a housing 1008a, a shaft 1008b, and an end portion 1008c. In one embodiment, each of the motors 1008 is a stepper motor. As shown in FIG. 10C, the scent cartridge holder 1012 has a recessed portion 1012a that can be aligned with the recessed portion 1002a of the housing 1002. The recessed portions 1002a and 1012a facilitate removal of the scent cartridge holder 1012 from the housing 1002 so that cartridges 1200 can be loaded into and/or unloaded from the scent cartridge holder 1012. The recessed portions 1002a and 1010a also serve as alignment structures that ensure that the scent cartridge holder 1012 has a predetermined orientation relative to the housing 1002 when the scent cartridge holder 1012 is disposed within the housing 1002.

As shown in FIG. 10D, the diffuser 1004 includes a first diffuser portion 1004a, a second diffuser portion 1004b, and a third diffuser portion 1004c. The first diffuser portion 1004a, the diffuser second portion 1004b, and the third diffuser portion 1004c are similar to the first diffuser portion 134, the second diffuser portion 136, and the third diffuser portion 138, respectively. The scent dispensing device 1000 includes a scent mixing chamber 1014 that includes an upper portion 1014a and a lower portion 1014b. The upper portion 1014a of the scent mixing chamber 1014 includes an aperture 1014c that serves as an outlet port for the scent mixing chamber 1014. A fan 1016 is disposed in the aperture 1014c of the scent mixing chamber 1014. The scent dispensing device 1000 also includes an interface connector 1018, one or more batteries 1020, and a printed circuit board 1022. In one embodiment, the communications interface connector 1018 is a USB A-Type, female connector. The printed circuit board 1022 includes various components and circuits for communicating and processing scent information, and for controlling operation of the motors 1008 and the fan 1016 based on such scent information.

As shown in FIG. 10E, the lower portion 1014b of the scent mixing chamber 1014 includes four wedge-shaped apertures 1014d. Each of the wedge-shaped apertures 1014d serves as an inlet port to the scent mixing chamber 1014.

FIG. 11A is a top plan view of the scent cartridge holder 1012 shown in FIG. 10B. FIG. 11B is an isometric view of the scent cartridge holder 1012. The scent cartridge holder 1012 includes four scent cartridge receptacles 1012b, each of which is sized and dimensioned to receive at least a lower portion of one of the scent cartridges 1200. Each scent cartridge receptacle 1012b includes a shaft or axle 1012c, a wedge-shaped aperture 1012d, and an alignment indicator 1012e. The alignment indicator 1012e may take a variety of forms, for example, a marking, an indentation, or a projection.

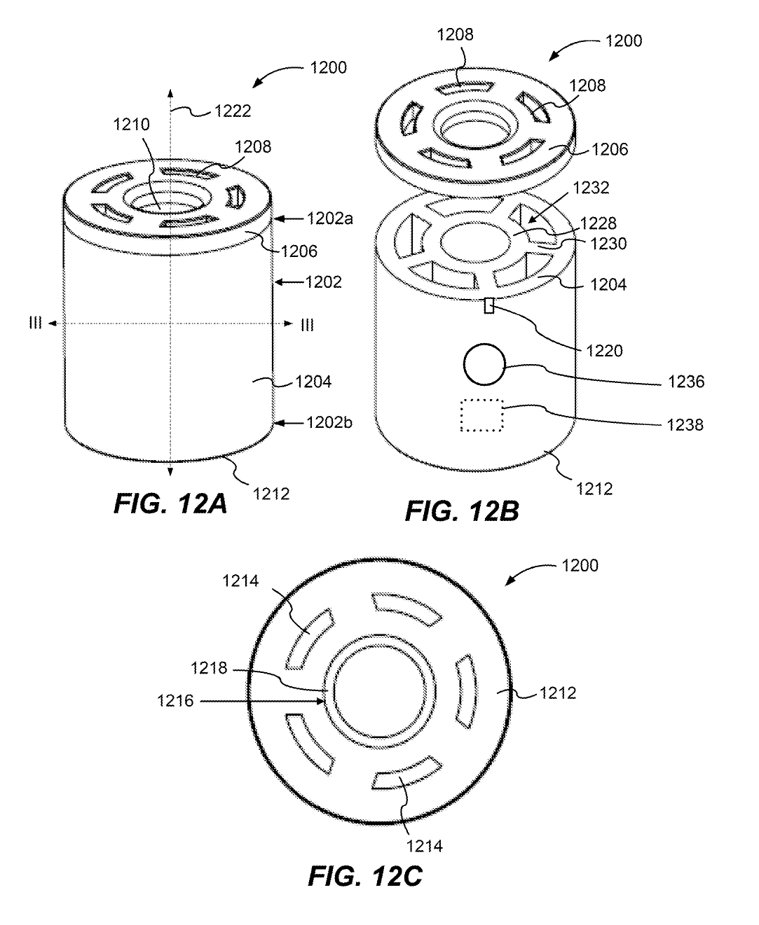

The scent cartridge 1200 according to one illustrated embodiment will now be described with reference to FIGS. 12A-12C. FIG. 12A is an isometric view of the scent cartridge 1200. FIG. 12B is a partially exploded view of the scent cartridge 1200. FIG. 12C is a bottom plan view of the scent cartridge 1200. As shown in FIG. 12A, the scent cartridge 1200 includes a housing 1202 having a circular peripheral perimeter. The housing 1202 includes a first end 1202a and a second end 1202b. A cylindrical outer wall 1204 defines a peripheral perimeter of the housing 1202.

A first end portion 1206 is disposed at the first end 1202a of the housing 1202. The first end portion 1206 includes five wedge-shaped apertures 1208 and an aperture 1210. The aperture 1210 and the end portion 1008c of the shaft 1008b of each of the motors 1008 are sized and dimensioned such that the end portion 1008c can be inserted into the aperture 1210. In one embodiment, the end portion 1008c and the aperture 1210 are circular and the end portion 1008c can be inserted snugly into the aperture 1210 such that rotation of the shaft 1008b causes rotation of the scent cartridge 1200 about a longitudinal, rotational axis 1222. In one embodiment, the end portion 1008c and the aperture 1210 are “D” shaped and the end portion 1008c of the shaft 1008b of each motor 1008 can be inserted into the aperture 1210 such that rotation of the shaft 1008b causes rotation of the scent cartridge 1200 about the longitudinal axis 1222.

A second end portion 1212 is disposed at the second end 1202b of the housing 1202. The second end portion 1212 includes five wedge-shaped apertures 1214. A circular aperture 1216 is formed in the second end portion 1212 and extends upwardly into the housing 1202 and ends a bearing surface 1218. The circular aperture 1216 and the axles 1012c of the scent cartridge holder 1012 are sized and dimensioned such that each axle 1012c can be inserted into the circular aperture 1216 such that the scent cartridge 1200 is able to rotate about the longitudinal axis 1222 when the axle 1012c is inserted into the circular aperture 1216. An annular bearing surface 1018 is included at the second end 1202b of the housing 1200 adjacent the circular aperture 1216. The annular bearing surface 1018 is disposed about the axis of rotation 1222 such that, when the axle 1012c of the scent cartridge holder 1012 is inserted into the circular aperture 1216 and the scent cartridge 1200 is rotated, the annular bearing surface 1018 abuts the side surfaces of the axle 1012c.

As shown in FIG. 12B, a plurality of walls extends upwardly from the second end portion 1212, including the outer wall 1204, an axial wall 1228, and five planar walls 1230. The planar walls 1230 extend radially from the axial wall 1228 to the outer wall 1204. The outer wall 1204, the first end portion 1206, the second end portion 1212, the axial wall 1228, and the planar walls 1230 define five chambers 1232 within the scent cartridge 1200 that are annularly arrayed about the rotational axis 1222. For each of the chambers 1232, one of the apertures 1208 formed in the first end portion 1206 is aligned with a corresponding aperture 1214 formed in the second end portion 1212. Each chamber 1232 defines a channel in which air can be fluidly communicated from the aperture 1214 formed in the second end portion 1212 to the corresponding aperture 1208 formed in the first end portion 1206. The outer wall 1204, the axial wall 1228, and the planar walls 1230 prevent air flowing through one of the chambers 1232 from leaking into any other of the chambers 1232.

As will be explained in detail below, the end portion 1008c of the shaft 1008b of the motors 1008 can engage the aperture 1216 of the scent cartridge 1200 and cause it to rotate into one of five predetermined positions/orientations in which a particular one of the wedge-shaped apertures 1208 of the first end portion 1206 of the scent cartridge 1200 is aligned with one of the wedge-shaped apertures 1014d of the lower portion 1014b of the scent mixing chamber 1014. When the scent cartridge 1200 is in such a position, the corresponding wedge-shaped aperture 1214 of the second end portion 1212 of the scent cartridge 1200 is aligned with one of the wedge-shaped apertures 1012d of the scent cartridge holder 1012. In one embodiment, the size and dimensions of the wedge-shaped apertures 1012d, 1014c, 1208, and 1214 are the same. When the scent cartridge 1200 is in such a position/orientation, the fan 1016 can cause air to flow into one of the wedge-shaped apertures 1012d of the scent cartridge holder 1012, through one of the chambers 1232 via corresponding wedge-shaped apertures 1214 and 1208, through the scent mixing chamber 1014 via apertures 1014d and 1014c, and out of the diffuser 1004.

The scent cartridge 1200 also includes an alignment indicator 1220. The alignment indicator 1220 may take a variety of forms, for example, a marking, an indentation, or a projection. When the alignment indicator 1220 of one of the scent cartridges 1200 is aligned with one of the alignment indicators 1012e of the scent cartridge holder 1012, an aperture 1214 of a predetermined one of the chambers 1232 (i.e., a default chamber) is aligned with one of the apertures 1012d formed in the scent cartridge holder 1012. A user of the scent dispensing device 1000 may align the alignment indicator 1220 of one of the scent cartridges 1200 with one of the alignment indicators 1012e of the scent cartridge holder 1012 when the scent cartridge 1200 is initially installed in the scent cartridge holder 1012. When the alignment indicator 1220 of one of the scent cartridges 1200 is aligned with one of the alignment indicators 1012e of the scent cartridge holder 1012, and the scent cartridge holder 1012 is inserted into the housing 1002 of the scent dispensing device 1000, an aperture 1208 of the first end portion 1206 of the default chamber 1232 of the scent cartridge 1200 is aligned with one of the apertures 1014d of the lower portion 1014b of the scent mixing chamber 1014.

Although the scent cartridge 1200 is described in connection with the scent dispensing device 1000, the scent cartridge 1200 may be used in other scent dispensing devices. For example, the scent cartridge 1200 may be used in other scent dispensing devices that are included with printers, cameras, clothing, chairs, kitchen appliances, and automobiles. Such scent dispensing devices may enable a user to specify a particular scent or scent combination by manually rotating one or more of the scent cartridges 1200 such that a particular chamber 1232 of each of the scent cartridges 1200 has a predetermined orientation. Alternatively, the scent dispensing device 1000 may be integrated with other devices, such as printers, cameras, clothing, chairs, kitchen appliances, and automobiles.

The scent cartridge holder 1012 of the scent dispensing device 1000 described above includes four scent cartridge receptacles 1012b, and each of the scent cartridges 1200 described above includes five chambers 1232. If four of the chambers 1232 of each of the scent cartridges 1200 include a scent medium 1234 (e.g., one of the chambers 1232 of each of the scent cartridges 1200 is empty) and the scent of each scent medium 1234 is different than that of every other scent medium 1234, the scent dispensing device 1000 could dispense 340 different scent combinations (i.e., 4⁴+4³+4²+4¹).

In one embodiment, the scent cartridge holder 1012 of the scent dispensing device 1000 includes five scent cartridge receptacles 1012b, and each of the scent cartridges 1200 includes six chambers 1232. If five of the chambers 1232 of each of the scent cartridges 1200 include a scent medium 1234 (e.g., one of the chambers 1232 of each of the scent cartridges 1200 includes an air filter) and the scent of each scent medium 1234 is different than that of every other scent medium 1234, the scent dispensing device 1000 could dispense 3,905 different scent combinations (i.e., 5⁵+5⁴+5³+5²+5¹).

In another embodiment, the scent cartridge holder 1012 of the scent dispensing device 1000 includes six scent cartridge receptacles 1012b, and each of the scent cartridges 1200 includes seven chambers 1232. If six of the chambers 1232 of each of the scent cartridges 1200 include a scent medium 1234 (e.g., one of the chambers 1232 of each of the scent cartridges 1200 is empty) and the scent of each scent medium 1234 is different than that of every other scent medium 1234, the scent dispensing device 1000 could dispense 55,986 different scent combinations (i.e., 6⁶+6⁵+6⁴+6³+6²+6¹).

Of course, the scent cartridge holder 1012 of the scent dispensing device 1000 may include another number of scent cartridge receptacles 1012b, and each of the scent cartridges 1200 may include another number of chambers 1232. Additionally, the scent media 1234 can be distributed within the chambers 1232 of the scent cartridges 1200 such that the scent dispensing device 1000 could produce virtually any desired number of different scent combinations.

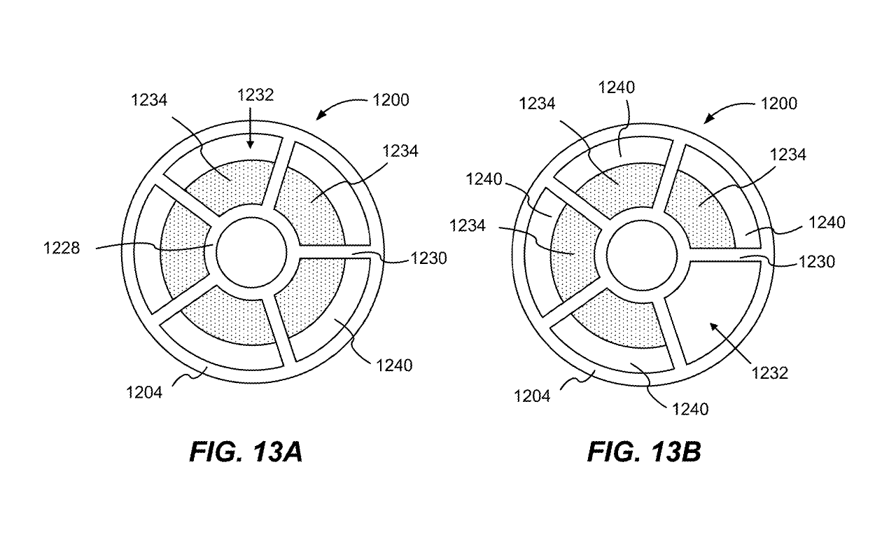

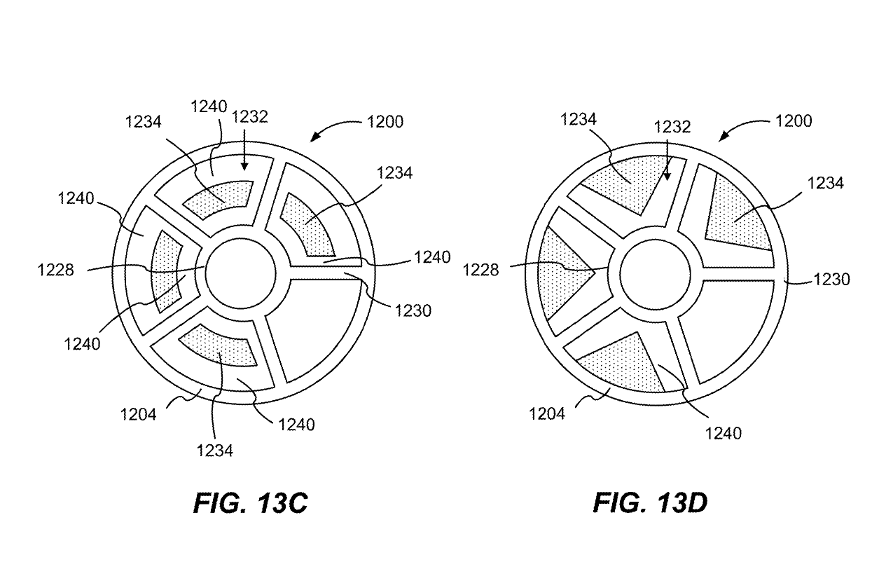

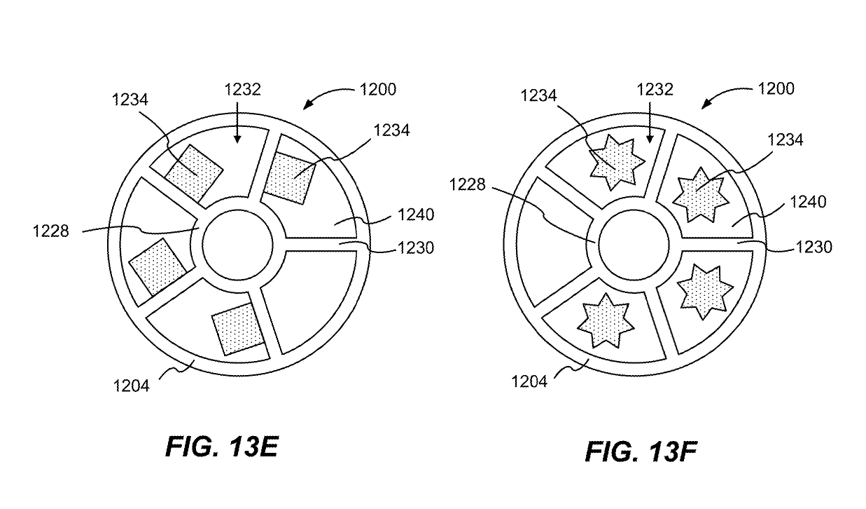

A number of example embodiments of the scent cartridge 1200 will now be described with reference to FIGS. 13A-13F. Each of FIGS. 13A-13F shows a horizontal slice view of the scent cartridge 1200 along the line III-III shown in FIG. 12A. In each of the example embodiments, one or more scent media 1234 are arranged in one or more of the chambers 1232. Each scent medium 1234 is arranged similarly to the scent medium 934 described above in connection with FIG. 9B. For example, each scent medium 1234 may be arranged in one of the chambers 1232 between corresponding ones of the apertures 1208 and 1214 such that a first selective membrane 936 is disposed between the scent medium 1234 and the aperture 1208 and/or a second selective membrane 938 is disposed between the scent medium 1234 and the aperture 1214.

FIG. 13A illustrates an embodiment in which each of the chambers 1232 includes a scent medium 1234. One or more of the scent media 1234 may have a scent or aroma that is the same as or different than that of one or more of the other scent media 1234. For example, each scent medium 1234 may have a scent or aroma that is different than that of the other scent media 1234. One or more of the scent media 1234 may be unscented, for example, an air filter medium (e.g., a medium including a charcoal filter) and/or a scent neutralizing medium (e.g., a medium including baking soda).

As shown in FIG. 13B, one or more of the chambers 1232 may be empty. Additionally, a gap 1240 may be disposed between each of the scent media 1234 and one or more of the walls that define each chamber 1232. For example, within one or more of the chambers 1232, the gap 1240 may be disposed between the scent medium 1234 and the outer wall 1204.

As shown in FIG. 13C, within one or more of the chambers 1232, the gap 1240 may be disposed between the scent medium 1234 and each of the walls that define the one or more chambers 1232. That is, within one or more chambers 1232, the gap 1240 may be disposed between the scent medium 1234 and the outer wall 1204, the axial wall 1228, and a pair of planar walls 1230.

The scent media 1234 may be disposed on one of the walls of one or more of the chambers 1232. For example, each scent medium 1234 may be disposed on the outer wall 1204 as shown in FIG. 13D, or may be disposed on one of the planar walls 1230 as shown in FIG. 13E.

Each scent medium 1234 may be arranged such that greater than fifty percent of the total surface area of the scent medium 1234 is exposed to the air that flows through one of the chambers 1232. For example, the dimensions of each scent medium 1234 shown in FIG. 13E may be as follows: the length is equal to 1 centimeter (cm), the width is equal to 1 cm, and the height is 5 cm. Accordingly, the total surface area of each scent medium 1234 is the surface area of four side portions (i.e., 4×1 cm×5 cm=20 cm²) plus the surface area of two end portions (i.e., 2×1 cm×1 cm=2 cm²) or 22 cm². The surface area of the side portion touching one of the planar walls 1230 is 1 cm×5 cm or 5 cm². Assuming that the apertures 1208 and 1214 of the first and the second end portions 1206 and 1212, respectively, are sized and dimensioned such that one-hundred percent of the surface area of each end portion of the scent media 1234 is exposed to air flowing in each chamber 1232, the surface area of each scent medium 1234 that is exposed to air flowing through one of the chambers 1232 is the surface area of three side portions (i.e., 3×1 cm×5 cm=15 cm²) plus the surface area of two end portions (i.e., 2×1 cm×1 cm=2 cm²) or 17 cm². Accordingly, roughly 72% (i.e., 17 cm²/22 cm²) of each scent medium 1234 is exposed to air flowing through one of the chambers 1232.

FIG. 13F shows an example in which a star-shaped scent medium 1234 is provided in four of the chambers 1232, such that the gap 1240 is provided between the scent media 1234 and inner surfaces of each of the walls that define the chambers 1232. Assuming that the apertures 1208 and 1214 of the first and the second end portions 1206 and 1212, respectively, are sized and dimensioned such that one-hundred percent of the surface area of each end portion of the scent media 1234 is exposed to air flowing in the chambers 1232, one-hundred percent of the surface area of each scent medium 1234 is exposed to air flowing through one of the chambers 1232.

The example cross-sectional shapes and positions of the scent media 1234 shown in FIGS. 13A-13F are illustrative and are not limiting. The cross-sectional shapes of the scent media 1234 may take a variety of shapes including circles, squares, rectangles, triangles, ovals, wedges, stars, etc. Additionally, each scent medium 1234 may be arranged such that the gap 1240 is provided between the scent medium 1234 and an inner surface of at least one wall of the one of the chambers 1232, wherein the gap 1240 extends along the length of the housing 1202.

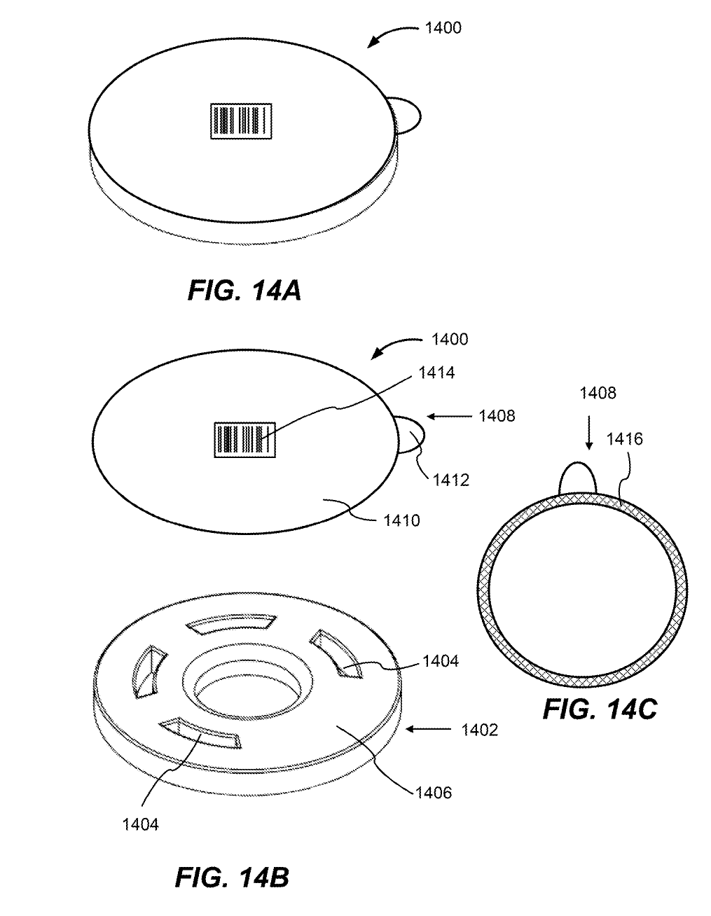

FIG. 14A is an isometric view of the top of a scent cartridge 1400, according to one illustrated embodiment. FIG. 14B is an exploded view of the top of the scent cartridge 1400. The scent cartridge 1400 is similar to the scent cartridge 1200 shown in FIGS. 12A-12C. The scent cartridge 1400 includes an end portion 1402 having four wedge-shaped apertures 1404 and a sealed portion 1406, which is provided between two of the apertures 1404. The surface area of the sealed portion 1406 may be less than, greater than, or equal to the surface area of each of the apertures 1404.

The scent cartridge 1400 also includes one or more hermetically sealed membranes 1408. The hermetically sealed membrane 1408 may be formed from tin foil, aluminum foil, or a foil formed from an alloy thereof, for example. The hermetically sealed membrane 1408 includes a main portion 1410, a tab 1412, and a contents indicator 1414 formed on an upper surface of the main portion 1410.

The contents indicator 1414 may include a picture, text, and/or a computer-readable structure (e.g., a barcode or RFID tag) indicating the particular scents, aromas, or other items contained in each of the chambers of the scent cartridge 1400. For example, the contents indicator 1414 may indicate that a first specified chamber includes particles having a first scent (e.g., the scent of hazelnut coffee), a second specified chamber includes particles having a second scent (e.g., the scent of espresso), a third specified chamber includes particles having a third scent (e.g., the scent of Kona coffee), that a forth specified chamber includes particles that neutralize odors (e.g., baking soda), and that a fifth specified chamber is empty. In one embodiment, the contents indicator 1414 is provided on a housing of the cartridge 1400.

FIG. 14C shows a bottom plan view of the hermetically sealed membrane 1408. A pressure sensitive adhesive 1416 is provided about a peripheral portion of a lower surface of the hermetically sealed membrane 1408. The hermetically sealed membrane 1408 may be placed above the first end portion 1402 and advanced toward the first end portion 1402 until the pressure sensitive adhesive 1416 contacts an upper surface of the first end portion 1402. Pressure may be applied to the upper surface of the main portion 1410 of the hermetically sealed membrane 1408 such that the main portion 1410 forms a seal around the apertures 1404 and prevents air and moisture from flowing from through the apertures 1404, which can degrade the scent media included in chambers of the scent cartridge 1400. The hermetically sealed membrane 1408 may be removed from the first end portion 1402 prior to use of the cartridge 1400, and may be reattached to the first end portion 1402 after use of the cartridge 1400 to protect the scent media therein. The cartridge 1400 also may include a second hermetically sealed membrane 1408 that can be attached to a second end portion of the cartridge 1400 that is similar to the second end portion 1212 shown in FIG. 12C.

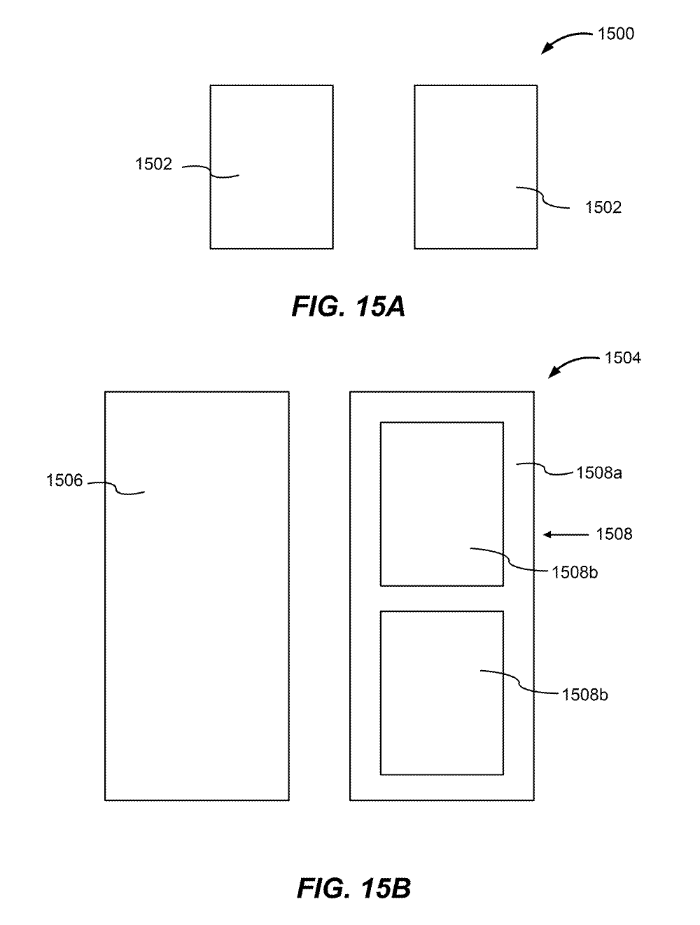

FIG. 15A is an exploded view of a pouch 1500 according to one illustrated embodiment. The pouch 1500 includes one or more side portions 1502. In one embodiment, the pouch 1500 includes two side portions 1502 formed of a plastic material that does not enable air and moisture to pass therethrough. One or more scent cartridges (e.g., cartridge 1200) are placed between the side portions 1502, and corresponding edges of the side portions 1502 are welded together such that an air tight and moisture proof pouch is formed around the cartridge, which protects the contents of the cartridge prior to use of the cartridge. In one embodiment, one side portion 1502 is provided, which is folded around one or more scent cartridges, and corresponding edges of the side portion 1502 are welded together to form an air tight and moisture proof pouch around the cartridges. In one embodiment, the pouch 1500 includes a desiccant (e.g., calcium oxide or silica gel) that can absorb moisture that may be contained in the pouch 1500 after the pouch 1500 is sealed.

FIG. 15B is an exploded view of a scent cartridge blister pack 1504 according to one illustrated embodiment. The blister pack 1504 includes a backing substrate 1506 and a blister substrate 1508. The blister substrate 1508 includes a border portion 1508a and one or more compartments 1508b that extend outwardly from a first surface of the blister substrate 1508. After a scent cartridge is placed in each of the compartments 1508b, an adhesive is applied to the border portion 1508a on a second surface opposite the first surface of the blister substrate 1508, and the backing substrate 1506 is brought into contact with the adhesive on the border portion 1508a. The backing substrate 1506 hermetically seals each of the compartments 1508b, thereby protecting the contents of the cartridges sealed therein from external air and moisture. In one embodiment, each of the compartments 1508b includes a desiccant (e.g., calcium oxide or silica gel) that can absorb moisture that may be contained in the compartments 1508b after the compartments 1508b are sealed.

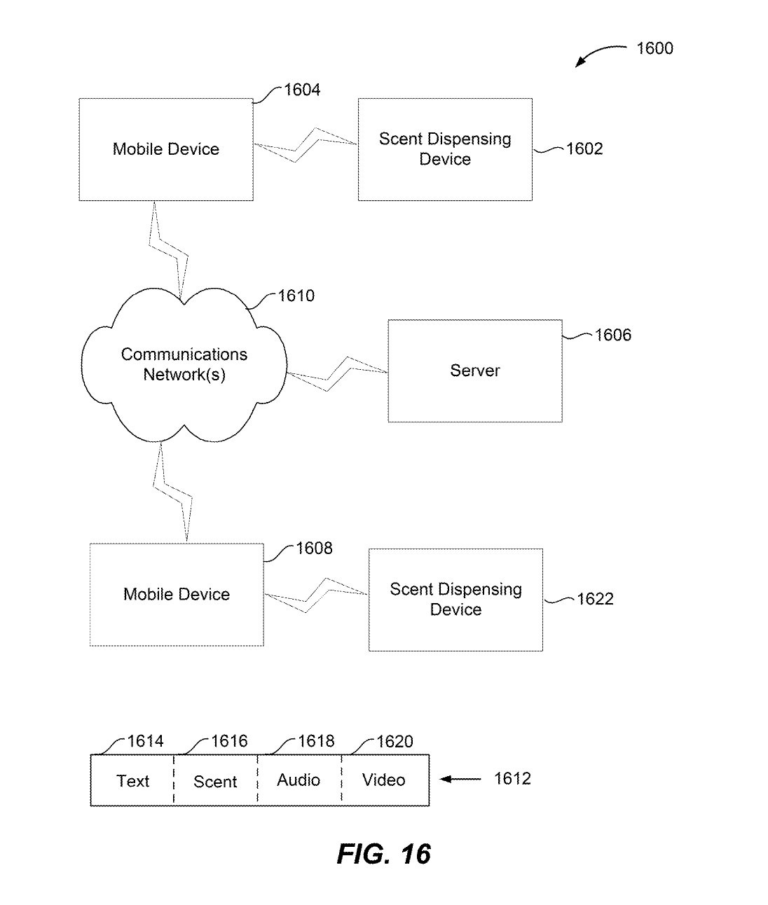

FIG. 16 is a network diagram of a scent dispensing system 1600 according to one illustrated embodiment. The scent dispensing system 1600 includes a first scent dispensing device 1602, a first mobile device 1604, a server 1606, at least a second scent dispensing device 1622, and at least a second mobile device 1608. One or more communications networks 1610 provide communications paths between the first mobile device 1604, the server 1606, and the second mobile device 1608. The first scent dispensing device 1602 and the first mobile device 1604 communicate via wired or wireless communications. In one embodiment, the first scent dispensing device 1602 and the first mobile device 1604 communicate via Bluetooth communications. Similarly, the second scent dispensing device 1622 and the second mobile device 1608 communicate via wired or wireless communications. For example, the first mobile device 1604 and the first scent dispensing device 1602 may belong to a first user of the system 1600, and the second mobile device 1608 and the second scent dispensing device 1622 may belong to a second user different than the first user.

The first mobile device 1604 and the second mobile device 1608 may be various types of computing devices including, but not limited to, smart phones, tablet computers, desktop computers, notebook computers, in-flight entertainment systems (IFE systems), built-in automotive computing devices, and the like.

As will be explained below, the first mobile device 1604, the server 1606, and/or the second mobile device 1608 may include computer-executable code that, when executed by a processor, generates one or more messages 1612. The messages 1612 may be in the form of a “digital post” published on a social network service. Each message 1612 may include a text portion 1614, a scent portion 1616, an audio portion 1618, and/or a video portion 1620. The first mobile device 1604 stores a software application including computer-executable instructions that, when executed by a processor, cause the first mobile device 1604 to process the messages 1612. For example, the first mobile device 1604 may begin to execute such instructions when one or more of the messages 1612 are received via one or more applications, such as a text message application, an electronic mail application and/or a social media application. Non-limiting examples of social media applications include Facebook®, Twitter®, Instagram®, Pinterest®, Vine®, Snapchat®, Yelp®, Foursquare®, and Youtube®.

Upon receipt of one or more of the messages 1612 the software application may, for example, instruct or cause the processor to cause a display device (e.g., a touch screen) of the first mobile device 1604 to display the text portion 1614, which may include a description of the scent portion 1616, the audio portion 1618, and/or the video portion 1620 of the message 1612. A user of the first mobile device 1604 may indicate using an input device (e.g., a key pad or touch screen) whether the message 1612 or a sequence of related messages 1612 may be processed further. If the processor receives an indication that the message(s) 1612 are to be processed further, the processor may cause the first mobile device 1604 to send information corresponding to the scent portion 1616 to the first scent dispensing device 1602. The processor also may cause a speaker to produce one or more sound(s) corresponding to the audio portion 1618 and/or a display device to display one or more image(s) corresponding to the video portion 1620.

Additionally, one or more software applications may include computer-executable instructions for gathering information regarding the contents of scent cartridges (e.g., scent cartridges 900, 1200, or 1400). For example, the software application may enable a user to indicate that one or more scent cartridges are being or have been loaded into the first scent dispensing device 1602. In response, the software application instructs the processor to cause a display device (e.g., a tough screen) of the first mobile device 1604 to display a series of prompts for a user to input information regarding each cartridge that has been or is being loaded into the first scent dispensing device 1602. Such information may include information regarding a particular location within the first scent dispensing device 1602 (e.g., a particular scent cartridge receptacle 1012b of a scent cartridge holder 1012) and information regarding the contents of each scent chamber (e.g., an identifier of each scent chamber 1232 and an identifier of the contents thereof). For example, the user may respond to the prompts indicating that the front, right scent cartridge receptacle 1012b has been loaded with a scent cartridge that includes five chambers, wherein a first predefined chamber contains a first scent, a second predefined chamber contains a second scent, a third predefined chamber contains a third scent, a fourth predefined chamber contains an odor neutralizer (e.g., baking soda, activated carbon), and a fifth predefined chamber is empty.

Additionally or alternatively, the software application may cause the display device of the first mobile device 1604 to display a message instructing the user to place a machine-readable symbol (e.g., barcode symbol) included with the scent cartridge within the field of view of a camera of the first mobile device. The software application may then instruct the processor to cause the camera to take or capture an image and to process corresponding image data to obtain the information regarding the contents of the cartridge. In this case, the user may simply enter information regarding the location within the first scent dispensing device 1602 (e.g., a particular scent cartridge receptacle 1012b of a scent cartridge holder 1012) in which the cartridge is being or has been placed. After the software application has caused the processor to store information regarding the contents and locations of the cartridges loaded within the first scent dispensing device 1602 into a memory of the first mobile device 1604, the application can process the messages 1612.

In some embodiments, the scent cartridge 1200 may include a memory 1238 that stores information regarding its contents, and electrical contacts 1236 (FIG. 12B) for facilitating access to the memory. The scent dispensing device 1000 may include one or more corresponding electrical contacts to capture the information regarding the contents of the scent cartridge. For example, in the embodiment shown in FIG. 11A, each of the scent cartridge receptacles 1012b includes electrical contacts 1024 (only one shown) that interface with corresponding electrical contacts 1236 on the scent cartridge. Using the electrical connection, the scent dispensing device 1602 is able to obtain the information regarding the contents of the scent cartridge and to transmit the information to the first mobile device 1604, which may transmit the information to the server 1606. The electrical contacts 1236 may be positioned at any location on the scent cartridge 1200. For example, existence of an electrical connection may be interpreted as a “1” while absence of an electrical connection may be interpreted as a “0,” thereby forming a binary pattern (e.g., byte, word) which encodes information (e.g., identifier, type) about the scent cartridge 1200. In some embodiments, in addition to or instead of the electrical contacts 1236, the scent cartridge 1200 may include a wireless transponder (e.g., an RFID tag or transponder) encoding information that is readable by a component of the scent dispensing device 1000.

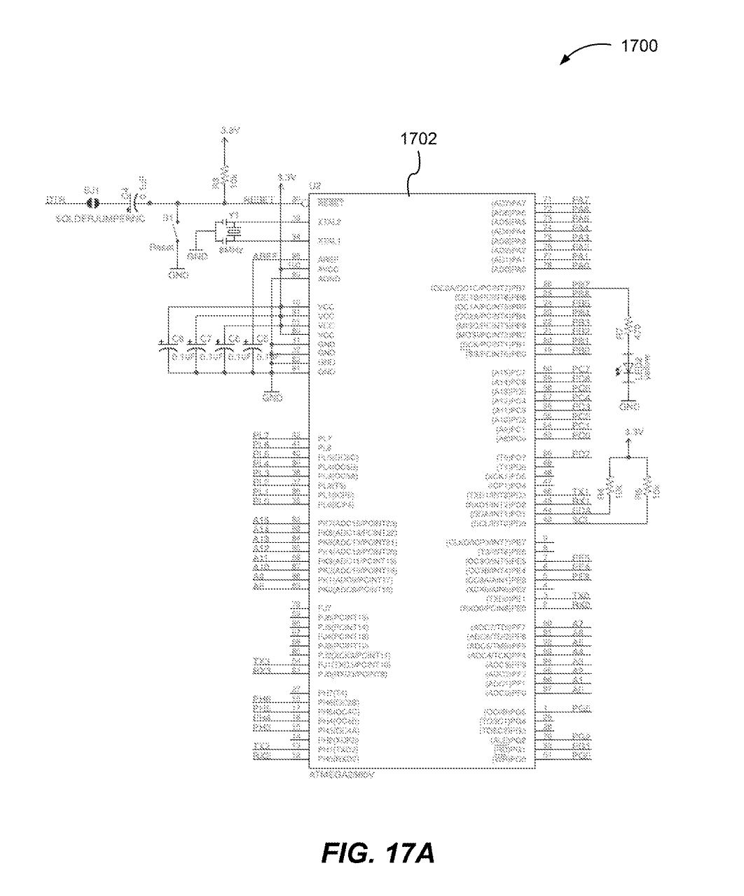

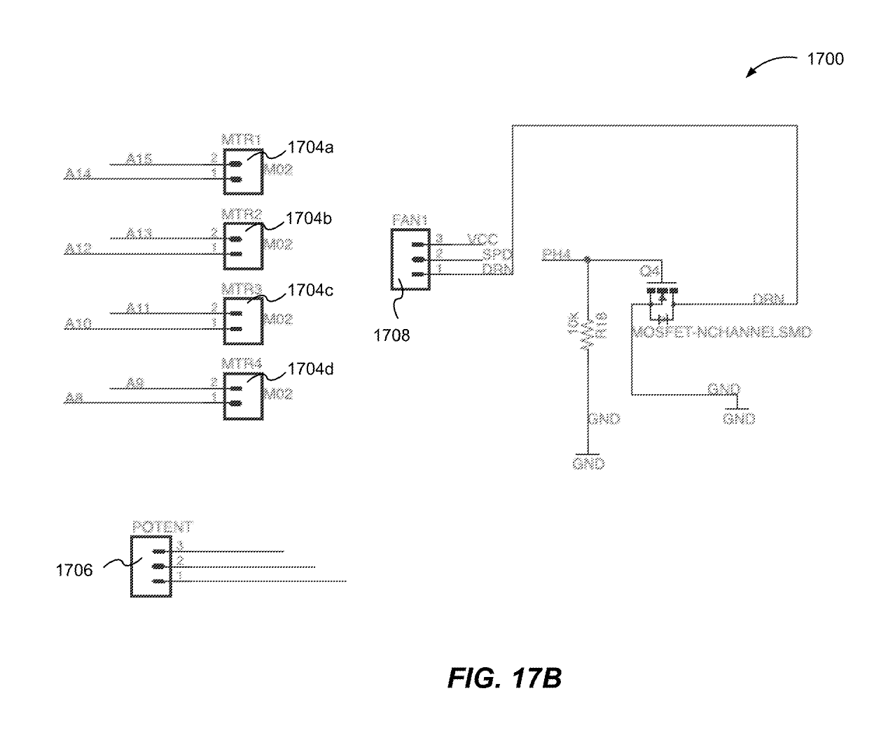

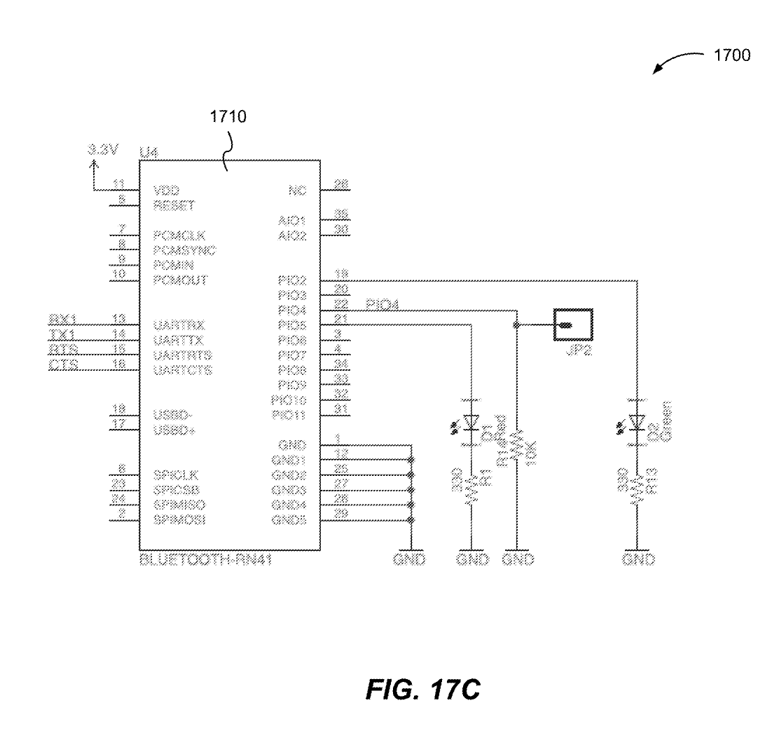

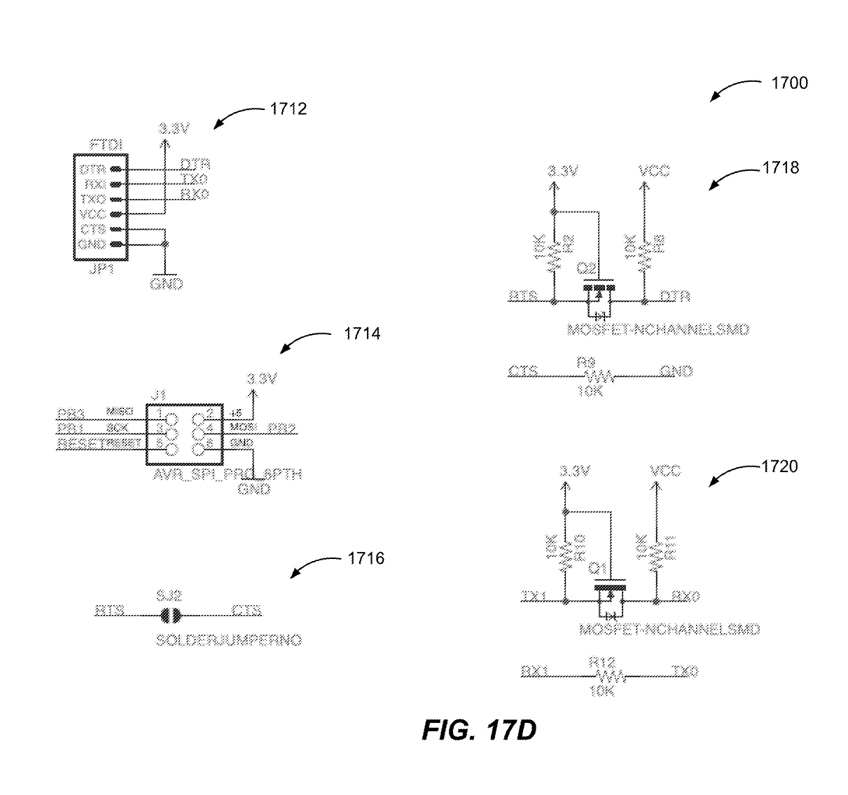

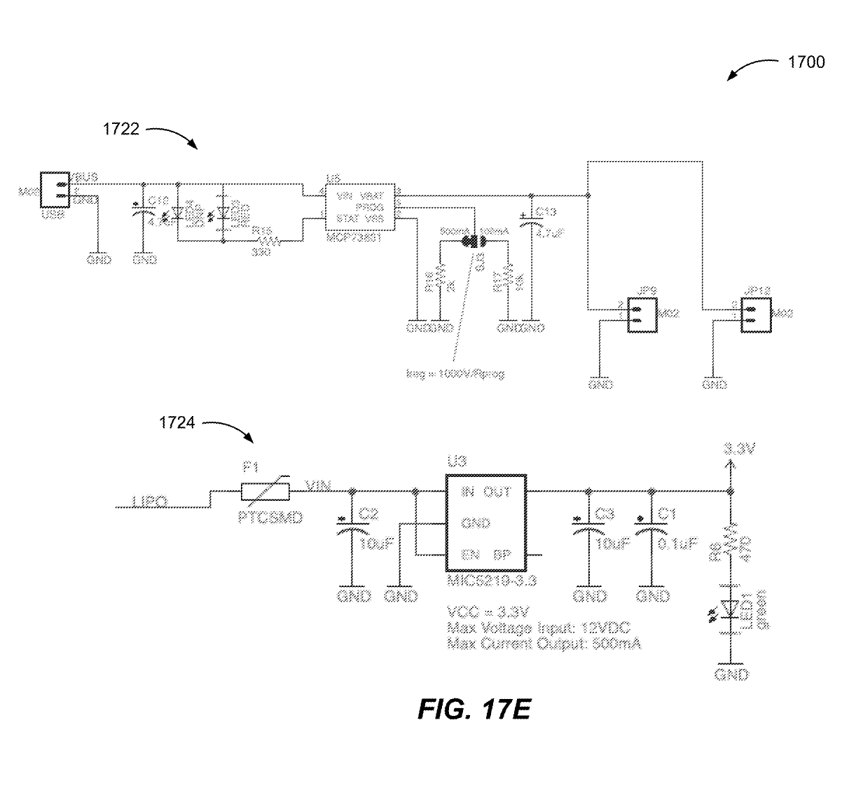

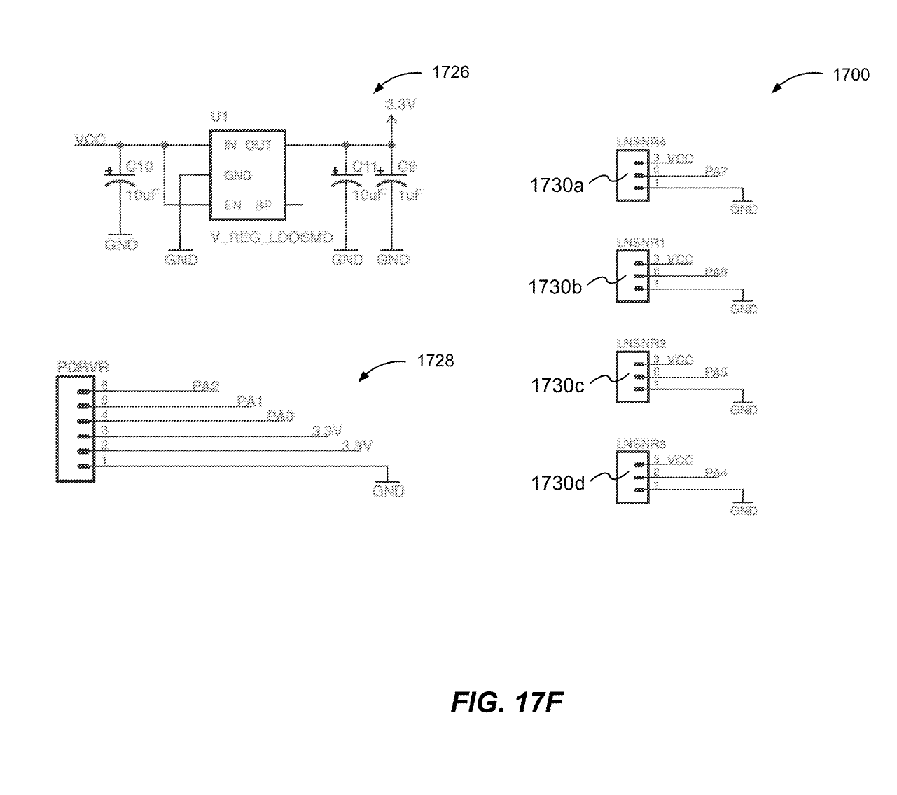

FIGS. 17A-17F illustrate various portions of a schematic diagram of a computing device 1700 according to one illustrated embodiment. The computing device 1700 may be used to implement the first scent dispensing device 1602 (or the second scent dispensing device 1622) shown in FIG. 16. The computing device 1700 includes a microcontroller 1702, four stepper motors 1704a-1704d (collectively 1704), a slide potentiometer 1706, a fan 1708, and a Bluetooth communications module 1710. In one embodiment, the microcontroller 1702 is a model ATMEGA2560V microcontroller by Atmel Corporation. The computing device 1700 also includes circuits 1712, 1714, 1716, 1718, 1720, 1722, 1724, 1726, and 1728, which perform various functions such as regulating power, charging batteries, monitoring battery levels, distributing power, biasing components, and processing USB communications. Additionally, the computing device 1700 may include four sensors 1730a-1730d (e.g., cameras) that can provide image data that the microcontroller 1702 can process to determine one or more orientations/positions of one or more scent cartridges.

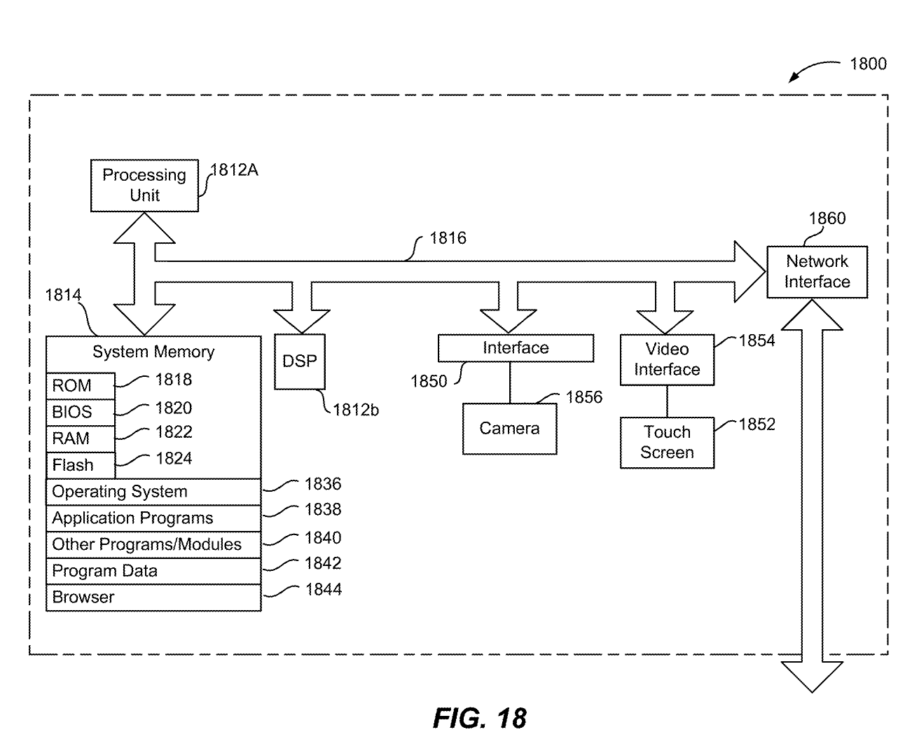

FIG. 18 is a block diagram of a computer system 1800 according to one illustrated embodiment. The computer system 1800 may be used to implement the first mobile device 1604 and/or the second mobile device 1608 shown in FIG. 16. The computer system 1800 is suitable for facilitating generation and processing of scent messages (e.g., message 1612). The computer system 1800 may include one or more processing units 1812a and 1812b (collectively processing unit 1812), a system memory 1814 and a system bus 1816 that couples various system components including the system memory 1814 to the processing units 1812. The processing unit 1812 may be any logic processing unit, such as one or more central processing units (CPUs) 1812a, digital signal processors (DSP) 1812b, application-specific integrated circuits (ASICs), field programmable gate arrays (FPGAs), etc. The system bus 1816 can employ any known bus structures or architectures, including a memory bus with memory controller, a peripheral bus, and a local bus. The system memory 1814 includes read-only memory (ROM) 1818, random access memory (RAM) 1822, and flash memory 1824. A basic input/output system (BIOS) 1820, which can form part of the ROM 1818, contains basic routines that help transfer information between elements within the computer system 1800, such as during start-up.

The computer system 1800 may also include a plurality of interfaces such as network interface 1860 and interface 1850 supporting any other wireless/wired interfaces. Computer-readable storage media can be used to store the information that may be accessed by processing unit 1812a. For example, such computer-readable storage media may include, but is not limited to, random access memory (RAM), read-only memory (ROM), electrically erasable programmable read-only memory (EEPROM), flash memory, or other solid state memory or any other medium.

Program modules can be stored in the system memory 1814, such as an operating system 1836, one or more programs 1838, other programs or modules 1840, and program data 1842. Programs 1838 may include instructions that cause the processor unit(s) 1812 to generate, process, and/or receive scent messages and scent information. Other program modules 1840 may include instructions for handling security such as password or other access protection and communications encryption. The system memory 1814 may also include communications programs, for example, a Web client or browser 1844 for permitting the computer system 1800 to access and exchange data with sources such as Web sites of the Internet, corporate intranets, extranets, or other networks and devices as described herein, as well as other server applications on server computing systems. The browser 1844 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. A number of Web clients or browsers are commercially available such as those from Mozilla, Google, and Microsoft.

An operator can enter commands and information into the computer system 1800 through input devices such as a touch screen 1852, and/or via a graphical user interface. Other input devices can include a microphone, a pointing device, etc. These and other input devices, such as camera unit 1856, are connected to one or more of the processing units 1812 through the interface 1850 such as a serial port interface that couples to the system bus 1816, although other interfaces such as a parallel port, a game port or a wireless interface or a universal serial bus (USB) can be used. The touch screen device 1852 or other display device is coupled to the system bus 1816 via a video interface 1854, such as a video adapter.

The computer system 1800 can operate in a networked environment using logical connections to one or more remote computers and/or devices as described above with reference to FIG. 16. For example, the computer system 1800 can operate in a networked environment using logical connections to one or more mobile devices, landline telephones and other service providers or information servers. Communications may be via a wired and/or wireless network architecture, for instance wired and wireless enterprise-wide computer networks, intranets, extranets, telecommunications networks, cellular networks, paging networks, and other mobile networks.

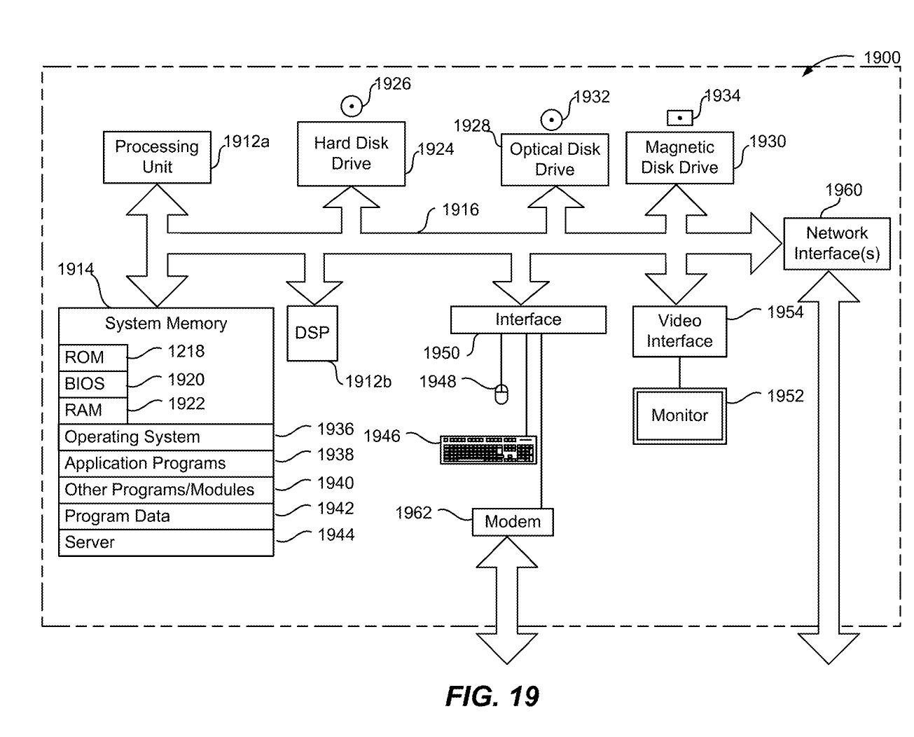

FIG. 19 shows an example computer system 1900, according to one illustrated embodiment. The computer system 1900 may be used to implement the server 1606 shown in FIG. 16. For example, the server 1606 in some embodiments may be used to implement a social network service or a scent messaging service. The computer system 1900 will at times be referred to in the singular herein, but this is not intended to limit the embodiments to a single device, since in typical embodiments, there may be more than one computer system or device involved. Unless described otherwise, the construction and operation of the various blocks shown in FIG. 19 are of conventional design. As a result, such blocks need not be described in further detail herein, as they will be understood by those skilled in the relevant art.

The computer system 1900 may include one or more processing units 1912a, 1912b (collectively 1912), a system memory 1914 and a system bus 1916 that couples various system components including the system memory 1914 to the processing units 1912. The processing units 1912 may be any logic processing unit, such as one or more central processing units (CPUs) 1912a, digital signal processors (DSPs) 1912b, application-specific integrated circuits (ASICs), field programmable gate arrays (FPGAs), etc. The system bus 1916 can employ any known bus structures or architectures, including a memory bus with memory controller, a peripheral bus, and a local bus. The system memory 1914 includes read-only memory (ROM) 1918 and random access memory (RAM) 1922. A basic input/output system (BIOS) 1920, which can form part of the ROM 1918, contains basic routines that help transfer information between elements within the computer system 1900, such as during start-up.

The computer system 1900 may also include a plurality of interfaces such as a network interface 1960 and an interface 1950 supporting a modem 1962 or any other wireless/wired interfaces.

The computer system 1900 may include a hard disk drive 1924 for reading from and writing to a hard disk 1926, an optical disk drive 1928 for reading from and writing to removable optical disks 1932, and/or a magnetic disk drive 1930 for reading from and writing to magnetic disks 1934. The optical disk 1932 can be a CD-ROM, while the magnetic disk 1934 can be a magnetic floppy disk or diskette. The hard disk drive 1924, optical disk drive 1928 and magnetic disk drive 1930 may communicate with the processing unit 1912 via the system bus 1916. The hard disk drive 1924, optical disk drive 1928 and magnetic disk drive 1930 may include interfaces or controllers (not shown) coupled between such drives and the system bus 1916, as is known by those skilled in the relevant art. The drives 1924, 1928 and 1930, and their associated computer-readable storage media 1926, 1932, 1934, may provide non-volatile and non-transitory storage of computer-readable instructions, data structures, program modules and other data for the computer system 1900.

Although the depicted computer system 1900 is illustrated employing the hard disk drive 1924, optical disk drive 1928 and magnetic disk drive 1930, those skilled in the relevant art will appreciate that other types of computer-readable storage media that can store data accessible by a computer may be employed, such as magnetic cassettes, flash memory, Bernoulli cartridges, RAMs, ROMs, smart cards, etc. For example, computer-readable storage media may include, but is not limited to, random access memory (RAM), read-only memory (ROM), electrically erasable programmable read-only memory (EEPROM), flash memory, compact disc ROM (CD-ROM), digital versatile disks (DVD) or other optical disk storage, magnetic cassettes, magnetic tape, magnetic disk storage or other magnetic storage devices, solid state memory or any other medium which can be used to store the desired information and which may be accessed by processing unit 1912a.

Program modules can be stored in the system memory 1914, such as an operating system 1936, one or more programs 1938, other programs or modules 1940, and program data 1942. Programs 1938 may include instructions that cause the processor(s) 1912 to generate, process, transmit, and/or receive scent messages 1612 and scent information. Other program modules 1940 may include instructions for handling security such as password or other access protection and communications encryption. The system memory 1914 may also include communications programs, for example, a Web server 1944 for permitting the computer system 1900 to be accessed and exchange data with Web browsers of the Internet, corporate intranets, extranets, or other networks and devices as described herein, as well as other server applications on server computing systems. The Web server 1944 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. A number of Web clients or browsers are commercially available such as those from Mozilla, Google, and Microsoft.

While shown in FIG. 19 as being stored in the system memory 1914, all or portions of the operating system 1936, programs 1938, other programs/modules 1940, program data 1942 and server 1944 can be stored on the hard disk 1926 of the hard disk drive 1924, the optical disk 1932 of the optical disk drive 1928 and/or the magnetic disk 1934 of the magnetic disk drive 1930.

An operator can enter commands and information into the computer system 1900 through input devices such as keyboard 1946 and/or a pointing device such as a mouse 1948, and/or via a graphical user interface. Other input devices can include a microphone, joystick, game pad, tablet, scanner, etc. These and other input devices are connected to one or more of the processing units 1912 through an interface 1950 such as a serial port interface that couples to the system bus 1916, although other interfaces such as a parallel port, a game port or a wireless interface or a universal serial bus (USB) can be used. A monitor 1952 or other display device is coupled to the system bus 1916 via a video interface 1954, such as a video adapter. The computer system 1900 can include other devices, such as speakers, printers, etc.

The computer system 1900 can operate in a networked environment using logical connections to one or more remote computers and/or devices as described above with reference to FIG. 16. For example, the computer system 1900 can operate in a networked environment using logical connections to one or more mobile devices, landline telephones and other service providers or information servers. Communications may be via a wired and/or wireless network architecture, for instance wired and wireless enterprise-wide computer networks, intranets, extranets, telecommunications networks, cellular networks, paging networks, and other mobile networks.

It should be understood that the various techniques described herein may be implemented in connection with hardware, software and/or firmware or, where appropriate, with a combination of such. Thus, the methods and apparatuses of the disclosure, or certain aspects or portions thereof, may take the form of program code (i.e., instructions) embodied in tangible media, such as floppy diskettes, CD-ROMs, DVDs, hard drives, flash drives, or any other machine-readable or processor-readable storage medium wherein, when the program code is loaded into and executed by a machine, such as a processor of a computer or mobile device, the machine becomes an apparatus for practicing various embodiments. In the case of program code execution on programmable computers or mobile devices, such generally includes a processor, a storage medium readable by the processor (including volatile and non-volatile memory and/or storage elements), at least one input device, and at least one output device. One or more programs may implement or utilize the processes described in connection with the disclosure, e.g., through the use of an API, reusable controls, or the like. Such programs are preferably implemented in a high level procedural or object-oriented programming language to communicate with a computer system including the computer system 1900 depicted in FIG. 19. However, the program(s) can be implemented in assembly or machine language, if desired. In any case, the language may be a compiled or interpreted language, and combined with hardware implementations.

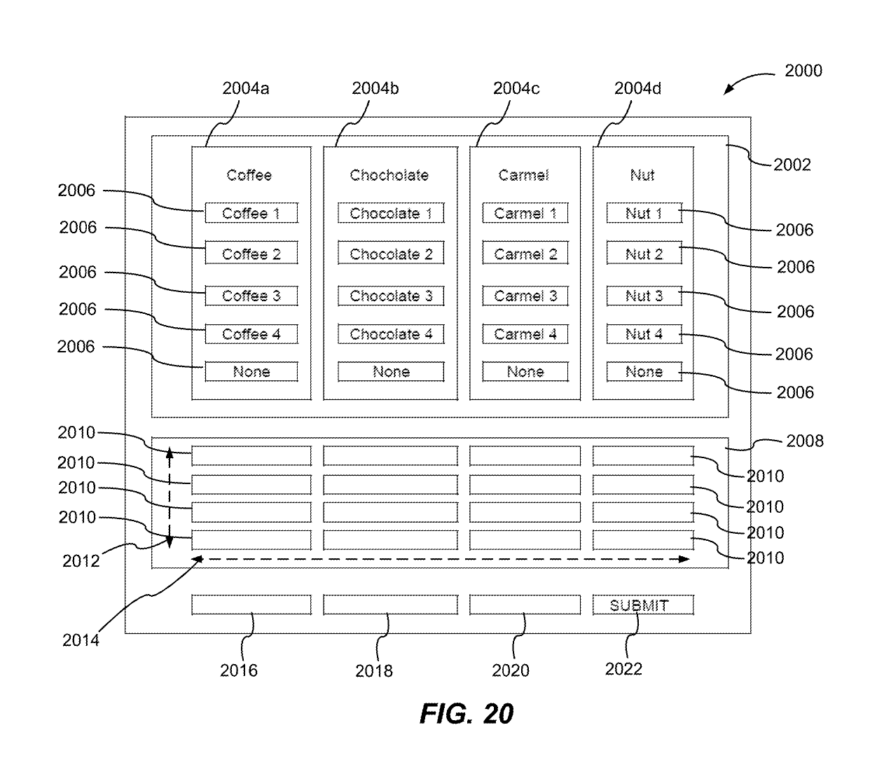

FIG. 20 is block diagram of a scent sequence specification user interface 2000 according to one illustrated embodiment. The scent sequence specification user interface 2000 may be provided by the server 1606. The scent sequence specification user interface 2000 may additionally or alternatively be provided by the applications programs 1838 of the system 1800. For example, the server 1606 may provide HTML formatted information corresponding to the scent sequence specification user interface 2000 to the second mobile device 1608. When the second mobile device 1608 receives the information, a processor of the device (e.g., processing unit 1812a) causes a display device (e.g., touch screen 1852) to display the scent sequence specification user interface 2000. When a user selects icons or inputs text (e.g., via the touch screen 1852), the processor of the second mobile device 1608 causes corresponding information to be transmitted to the server 1606 via the network 1610. As will be explained, a processor (e.g., processing unit 1912a) of the server 1606 executes predetermined instructions (e.g., that are stored in the programs 1938) in response to receipt of information from the first mobile device 1604 and/or the second mobile device 1608.

The scent sequence specification user interface 2000 includes a scent palette 2002 that includes four categories of scents 2004a-2004d. The first category of scents 2004a includes four different coffee scents. The second category of scents 2004b includes four different chocolate scents. The third category of scents 2004c includes four different caramel scents. The fourth category of scents 2004d includes four different nut scents. The categories of scents 2004a-2004d include twenty selectable icons 2006, each of which indicates a particular scent (or absence of a scent). For example, one or more of the selectable icons 2006 may include text, symbols, and/or pictures that represent a particular scent.

The scent sequence specification user interface 2000 also includes a two-dimensional array of scent specification fields 2008. The array of scent specification fields 2008 includes sixteen text input boxes 2010. The text input boxes 2010 are arranged along a first axis 2012 and a second axis 2014, which is perpendicular to the first axis 2012. A distribution of the scent specifications fields (e.g., text input boxes 2010) along the first axis 2012 of the array of scent specification fields 2008 represents a position in a temporal sequence. For example, the scents specified via the text input boxes 2010 in the top row of the array of scent specification fields 2008 may be produced before the scents specified via the text input boxes 2010 in the bottom row of the array of scent specification fields 2008. A distribution of the scent specification fields (e.g., text input boxes 2010) along the second axis 2014 of the array of scent specification fields 2008 represents one or more scents to be dispensed at a respective position in the temporal sequence. For example, the scents specified via the text input boxes 2010 in a first row of the array of scent specification fields 2008 may be produced at a first time, the scents specified via the text input boxes 2010 in a second row of the array of scent specification fields 2008 may be produced at a second time, etc. That is, the scents specified via the text input boxes 2010 in each of the rows of the array of scent specification fields 2008 may represent a compound scent that is a mixture or combination of the scents specified via the input boxes 2010 in that row. Additionally, the scents specified via the text input boxes 2010 in the four illustrated rows of the array of scent specification fields 2008 may represent a sequence of four such compound scents.

When each of the selectable icons 2006 is selected, the server 1606 causes one of the text input boxes 2010 to display corresponding text. For example, if a user of the second mobile device 1608 selects the selectable icon 2006 labeled “Coffee 1,” the second mobile device 1608 sends the server 1606 information indicating that the selectable icon 2006 has been selected and, in response, the server 1606 causes the top text input box 2010 under the first category of scents 2004a to display “Coffee 1.” The scent sequence specification user interface 2000 also includes a text input box 2016, a text input box 2018, a text input box 2020, and a submit button 2022.

The server 1606 may initially enable the text input boxes 2010 in the first row (e.g., top row) of the two-dimensional array of scent specification fields 2008 to be populated, and then the scent specification fields 2008 in the second row, and so on. The scent sequence specification user interface 2000 may include a display area (not shown) in which instructions are displayed. The instructions may indicate that the scent sequence specification user interface 2000 can be used to generate up to four scent messages, each of which specifies a user-defined combination of up to four scents. The instructions may indicate that a theme or a name to be associated with the scent messages can be specified by entering text into the text input box 2016, that a sender to be associated with the scent messages can be specified by entering text into the text input box 2018, and that a recipient of the scent messages can be specified by entering text (e.g., an e-mail address) into the text input box 2020.

For example, a user of the second mobile device 1608 may initially select the selectable icons 2006 labeled “Coffee 1,” “Chocolate 1,” “Caramel 1,” and “Nut 1,” respectively, which causes the server 1606 to populate the text input boxes 2010 of the first row of the array of scent specification fields 2008 with text corresponding to the labels of the selectable icons 2006 that were selected. The user may then select the selectable icons 2006 labeled “Coffee 2,” “Chocolate 2,” “Caramel 2,” and “Nut 2,” respectively, which causes the server 1606 to populate the text input boxes 2010 of the second row of the array of scent specification fields 2008 with text corresponding to the labels of the selectable icons 2006 that were selected. The user may then select the selectable icons 2006 labeled “Coffee 3,” “Chocolate 3,” “Caramel 3,” and “None,” respectively, which causes the server 1606 to populate the text input boxes 2010 of the third row of the array of scent specification fields 2008 with text corresponding to the labels of the selectable icons 2006 that were selected. The user may then select the selectable icons 2006 labeled “Coffee 4,” “None,” “Caramel 1,” and “None,” respectively, which causes the server 1606 to populate the text input boxes 2010 of the fourth row of the array of scent specification fields 2008 with text corresponding to the labels of the selectable icons 2006 that were selected. The user may then enter a name or description to be associated with the selected scent combinations in the text input box 2016. The user also may enter her name in the text input box 2018, and an e-mail address of an intended recipient in the text input box 2020, and then select the submit button 2022.

In response, the server 1606 generates a scent specification file including a sequence of four scent messages 1612, each of which includes indicators of the scents specified in one of the rows of the array of scent specification fields 2008. Generally, a scent specification file is composed of a series of time-dependent instructions to enable a scent dispensing device to generate a desired set of scents. A scent specification file serves to depict the progression of the delivery of those scents. The modulation of scent can be a single scent which is released in a rhythmic pattern (e.g., timed pauses, or rests, between the releases of the scent), or a variety of layered scents which change and alternate over time. This progression of scents is associated with a visual representation of the scent progression, shown to the user (e.g., using a display of a mobile device, such as a phone or tablet computer). The scent specification file may also assign the appropriate wired or wireless signals (e.g., Bluetooth), so that if the application is linked to the scent dispensing device, the proper signals will be transmitted for the scent progression to be released.

In some embodiments, the server 1606 also generates an e-mail message and attaches the scent specification file to the e-mail message and sends the e-mail message using the e-mail address input in the text input box 2020. Instead of or in addition to an email message, the server 1606 may publish a scent notification or “digital post” to a social network service that includes the scent specification file or a reference thereto that is viewable and selectable by a user of the social network service. The server 1606 also may include a default or user-specified duration (e.g., in seconds) for each scent message. For example, the scent specification file may include information corresponding to the information shown in Table 1 below.

TABLE 1
Scent Specification Name = Alice's scent combinations
From = Alice
To = Bob@example.com

| | |
|---|---|
| Scent Message 1A: | Scent Message 1B: |
| Scent 1 = Coffee 1 | Scent 1 = Coffee 2 |
| Scent 2 = Chocolate 1 | Scent 2 = Chocolate 2 |
| Scent 3 = Caramel 1 | Scent 3 = Caramel 2 |
| Scent 4 = Nut 1 | Scent 4 = Nut 2 |
| Duration = 10 | Duration = 10 |
| Scent Message 1C: | Scent Message 1D: |
| Scent 1 = Coffee 3 | Scent 1 = Coffee 4 |
| Scent 2 = Chocolate 3 | Scent 2 = None |
| Scent 3 = Caramel 3 | Scent 3 = Caramel 1 |
| Scent 4 = None | Scent 4 = None |
| Duration = 10 | Duration = 10 |

Each scent message portion 1A-1 D of the scent message may be referred to as a “scent measure,” similar to a bar or measure in music terminology. When the e-mail message from the server 1606 is received at the first mobile device 1604, a user may open the message and select the attached file, which causes a processor of the first mobile device 1604 (e.g., processing unit 1812a) to execute an application for processing the scent specification file. The application may cause the processor to display a user interface on a touch screen (e.g., on the touch screen 1852). For example, the application may instruct the processor to cause a user interface to be displayed that displays a message indicating a name or theme of the scent messages (e.g., the text entered into the text input box 2016), from whom the message was sent (e.g., the text entered into the text input box 2018). Additionally, the displayed message may indicate the amount of time required for the scents specified in the scent specification file. For example, the processor may add the time durations specified in each scent measure and cause the resulting sum to be displayed in the message. The user interface also may include selectable icons labeled “Continue,” and “Cancel,” for example. The displayed message may indicate that the user can select the “Continue” icon to continue processing the scent messages, and indicate that the user can select the “Cancel” icon at any time to cancel processing of the scent messages.

When the message is sent as a digital post to one or more social network services, the server 1606 may serve the post to a program executing on the first mobile device 1604. The user may select the post (e.g., by clicking on or touching a link, etc.), which causes the program to process the scent specification file as discussed above. In some embodiments, the program may execute one or more additional programs to process the scent specification file. For example, the user may select the post in a social network service application which causes a separate scent processing application to execute and process the scent specification file.

The scent sequence specification user interface 2000 may include categories of scents 2004a-2004d other than those described above. For example, the scents included in the scent sequence specification user interface 2000 may correspond to different flowers, and the scent sequence specification user interface 2000 may be used to create scent combinations and sequences that represent different bouquets of flowers.

Additionally, the scent sequence specification user interface 2000 may be used be to create paragraphs that convey ideas and/or emotions. Each paragraph may include a number of sentences, each of which is comprised of a number of words. Similarly, the scent sequence specification user interface 2000 can be used to generate symphonies of scents, wherein each symphony includes a paragraph.

For example, each of the scents may correspond to a scent that has been observed in a particular city, and the scent sequence specification user interface 2000 may be used to generate paragraphs that represent experiences in that city. A user of the second mobile device 1608 may use the scent sequence specification user interface 2000 to generate a paragraph and cause a corresponding scent specification file to be transmitted to a user of the first mobile device 1604 so that the scent dispensing device 1602 can dispense a combination of scents in a particular sequence that is intended to remind the user of the first mobile device 1604 of a morning the two users had spent together in Paris. A first sentence included in the paragraph may include a number of words or particular scents observed while walking to a café (e.g., the scents of bread and other goods being baked). A second sentence may include a number of words or particular scents observed while dining in the café (e.g., the scents of coffee and croissants). A third sentence may include a number of words or particular scents observed while walking through a park on the way to the metro (e.g., the scents different trees). A fourth sentence may include a number of words or particular scents observed while riding the metro (e.g., the scents of subways and perfumes). A fifth sentence may include a number of words or particular scents observed while walking in the Jardin du Luxembourg (e.g., the scents of different flowers). Similarly, the user of the second mobile device 1608 may use the scent sequence specification user interface 2000 to generate another paragraph that is intended to remind the user of the first mobile device 1604 of another time the two users had spent together in Paris.

In one embodiment, the scent sequence specification user interface 2000 generates sentences according to predetermined grammatical rules. For example, the scent sequence specification user interface 2000 enables a user to select one or more of the selectable icons 2006 to specify: a scent or a scent combination that is the subject of a sentence, a scent or a scent combination that is the verb of the sentence, a scent or a scent combination that is a modifier of the subject of the sentence, and a scent or a scent combination that is a modifier of the verb of the sentence. In response to the user selections, the server 1606 generates information in which the scent corresponding to the subject is specified in one or more predetermined locations in the sequence (e.g., the first scent and the last scent of the sequence), the scent corresponding to the modifier of the subject is included immediately following or immediately the scent corresponding to the subject, the scent corresponding to the verb is repeated a predetermined number of times in the sequence (e.g., 3), and the scent corresponding to the modifier of the verb is included immediately before and/or immediately after each instance of the scent corresponding to the verb.

In one embodiment, the scent sequence specification user interface 2000 enables a user to specify information corresponding to the text portion 1614, the scent portion 1616, the audio portion 1618, and the video portion 1620 of a plurality of messages 1612. For example, the scent sequence specification user interface 2000 may be used to generate a message 1612 having a text portion 1614 that includes a text message, a scent portion 1616 that specifies a scent combination corresponding to the aroma of a particular coffee, an audio portion 1618 that specifies a recording of milk being frothed, and a video portion 1620 that specifies a picture of a cup of coffee. When the scent message 1612 is processed by the first mobile device 1604, a processing unit (e.g., processing unit 1812) of the first mobile device 1604 causes a display device to display the text corresponding to the text portion 1614, causes the first scent dispensing device 1602 to dispense a scent corresponding to the scent portion 1616, causes speakers to emit sounds corresponding to the audio portion 1618, and causes the display device to display a picture corresponding to the video portion 1620. The audio portion 1618 and the video portion 1620 of the message 1612 may include references to attached files and/or links (e.g., URIs) to files that are stored by other devices (e.g., the server 1606).

The software application also may cause information regarding an amount of usage of each scent medium included in each chamber of each scent cartridge to be stored. For example, the software application may cause a first variable and a second variable to be stored for each scent medium, wherein the first variable indicates a number of seconds of actual use time and the second variable indicates a total number of seconds of expected use time. The software application may cause the first variable to be incremented each time the scent medium is used, and cause the second variable to be initialized to a particular value when a scent cartridge containing the scent medium is loaded into a scent dispensing device (e.g., first scent dispensing device 1602). Additionally, the software application may cause a message to be displayed when the actual use time indicated by the first variable exceeds a predetermined threshold (e.g., 90% of the total expected use time indicated by the second variable). In some embodiments, the scent cartridges may include a sensor that senses the amount of each scent medium present in each chamber. For example, in embodiments where the scent medium includes scented wax, a sensor may be provided that senses the stability of the wax remaining in each chamber.

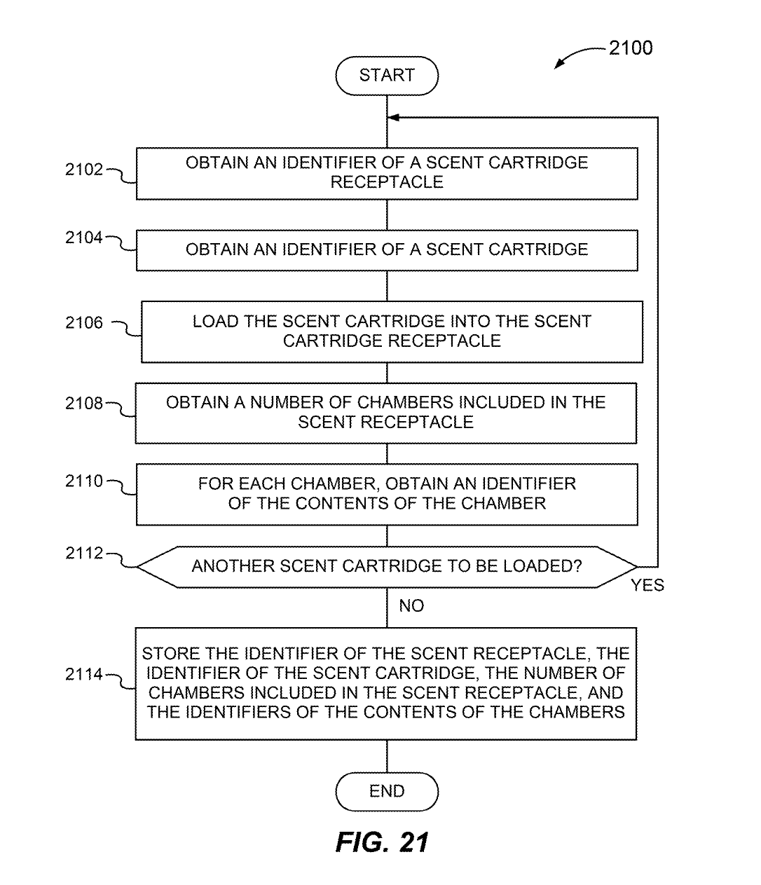

FIG. 21 is a flowchart of a method 2100 of operating the scent dispensing system 1600 shown in FIG. 16, according to one illustrated embodiment. One or more acts included in the method 2100 may be performed by the first mobile device 1604, for example, after a processing unit (e.g., processing unit 1812) of the first mobile device 1604 loads a software application including computer-executable instructions into RAM (e.g., RAM 1822) and executes the instructions. The application may instruct the processing unit to cause a touch screen (e.g., touch screen 1852) to display a series of prompts, receive information input in response to the prompts, and store the received information in program data in system memory (e.g., program data 1842).

At 2102, the processing unit of the first mobile device 1604 causes the touch screen to display a prompt requesting the user to enter an identifier of a scent cartridge receptacle in which a scent cartridge is to be loaded. For example, the identifier of the scent cartridge receptacle may be embossed, printed, provided on a label, or is otherwise visible to the user on an upper surface of one of the axles 1012c of one of the scent cartridge receptacles 1012b of the scent cartridge holder 1012 shown in FIG. 11A. The user may enter the identifier of the scent cartridge receptacle via the touch screen. In response, the processor obtains the identifier of the scent cartridge receptacle and stores it in RAM.

At 2104, the processing unit of the first mobile device 1604 causes the touch screen to display a prompt requesting the user to enter an identifier of the scent cartridge that is to be loaded into the scent cartridge receptacle. For example, the identifier of the scent cartridge may be embossed, printed, provided on a label, or is otherwise visible to the user on an exterior portion of the scent cartridge. The user may enter the identifier of the scent cartridge via the touch screen. In response, the processor obtains the identifier of the scent cartridge and stores it in RAM.

In one embodiment, at 2104, the processing unit of the first mobile device 1604 causes the touch screen to display a prompt requesting the user to take a picture using a camera (e.g., camera unit 1856) of a computer-readable symbol (e.g., barcode) included on the housing 1202 of the scent cartridge 1200 shown in FIG. 12A, or that is included in the contents indicator 1414 formed on the outer surface of the main portion 1410 of the hermetically sealed membrane 1408 shown in FIG. 14A, for example. The processing unit obtains the identifier of the scent cartridge by processing image data corresponding to an image of the computer-readable symbol using conventional techniques. In some embodiments the processing unit of the first mobile device 1604 obtains information about the scent cartridge using wired or wireless communication with the scent cartridge or the first scent dispensing device 1602. For example, in some embodiments the scent cartridge includes electrical contacts communicatively coupled to a memory that stores information about the scent cartridge. The scent cartridge receptacles 1012b may include corresponding electrical contacts operative to couple with the electrical contacts of the scent cartridge to obtain the information from the memory of the scent cartridge. The scent dispensing device may then communicate the information to the first mobile device 1604, which may communicate the information to the server 1606.

At 2106, the user loads the scent cartridge identified at 2104 into the scent cartridge receptacle of the first scent dispensing device 1602 identified at 2102. For example, the user loads the scent cartridge 1200 into one of the scent cartridge receptacles 1012b of the scent cartridge holder 1012 show in FIG. 11A.

At 2108, the processing unit causes the touch screen to display a prompt requesting the user to enter a number of chambers included in the scent cartridge that was loaded into the scent cartridge receptacle of the first scent dispensing device 1602 at 2102. In response, the processing unit obtains the number of chambers and stores the number in RAM. In one embodiment, the processor obtains the number of chambers from image data obtained at 2104.

At 2110, the processing unit causes the touch screen to display a series of prompts requesting the user to enter an identifier of the contents of each of the chambers included in the scent cartridge that was loaded into the scent cartridge receptacle at 2106. In response, the processing unit obtains the identifiers of the contents the chambers and stores them in RAM. In one embodiment, the processor obtains the identifiers of the contents of the chambers from image data obtained at 2104. In another embodiment, the processing unit obtains the identifiers of the contents each of the chambers from system memory. For example, the processing unit obtains the identifiers of the contents of each of the chambers from a table stored in program data, which is associated with the identifier of the scent cartridge obtained at 2104.

At 2112, the processing unit determines whether another scent cartridge is to be loaded into the first scent dispensing device 1602. For example, the processing unit causes the touch screen to display a prompt requesting the user to select a selectable icon to indicate whether another scent cartridge is to be loaded. If the user indicates via the touch screen that another scent cartridge is to be loaded, the method returns to 2102. If the user indicates via the touch screen that no other scent cartridge is to be loaded, the method proceeds to 2114.

At 2114, the processing unit causes one or more of the following to be stored in system memory: the identifier of the scent cartridge receptacle obtained at 2102, the identifier of the scent cartridge obtained at 2104, the number of chambers included in the scent cartridge receptacle obtained at 2108, and the identifiers of the contents of the chambers obtained at 2110. For example, the processing unit causes information corresponding to Table 2 or Table 3 below to be stored in program data at 2110.

TABLE 2
Scent Cartridge Receptacle Identifier = A
Scent Cartridge Identifier = CHO001

| Chamber Number | Content Identifier |
|---|---|
| 1 (default) | Empty |
| 2 | Chocolate 1 |
| 3 | Chocolate 2 |
| 4 | Chocolate 3 |
| 5 | Chocolate 4 |

TABLE 3
Scent Cartridge Receptacle Identifier = B
Scent Cartridge Identifier = COF001

| Chamber Number | Content Identifier |
|---|---|
| 1 (default) | Empty |
| 2 | Coffee 1 |
| 3 | Coffee 2 |
| 4 | Coffee 3 |
| 5 | Coffee 4 |

After the information is stored at 2114, the touch screen of the first mobile device 1604 may display a selectable icon that, when selected, causes the processing unit to display a user interface that enables a user to specify scents to be dispensed by the first scent dispensing device 1602. For example, the user interface may include a plurality of selectable icons, wherein each selectable icon includes one of the identifiers of the contents of the chambers obtained at 2110. In response to each of the icons being selected, the processing unit generates a message including a scent specification that identifies a scent corresponding to the selected icon and transmits the message to the first scent dispensing device 1602. After the first scent dispensing device 1602 receives each scent specification, the first scent dispensing device 1602 causes a corresponding scent to be dispensed, as will be explained below.

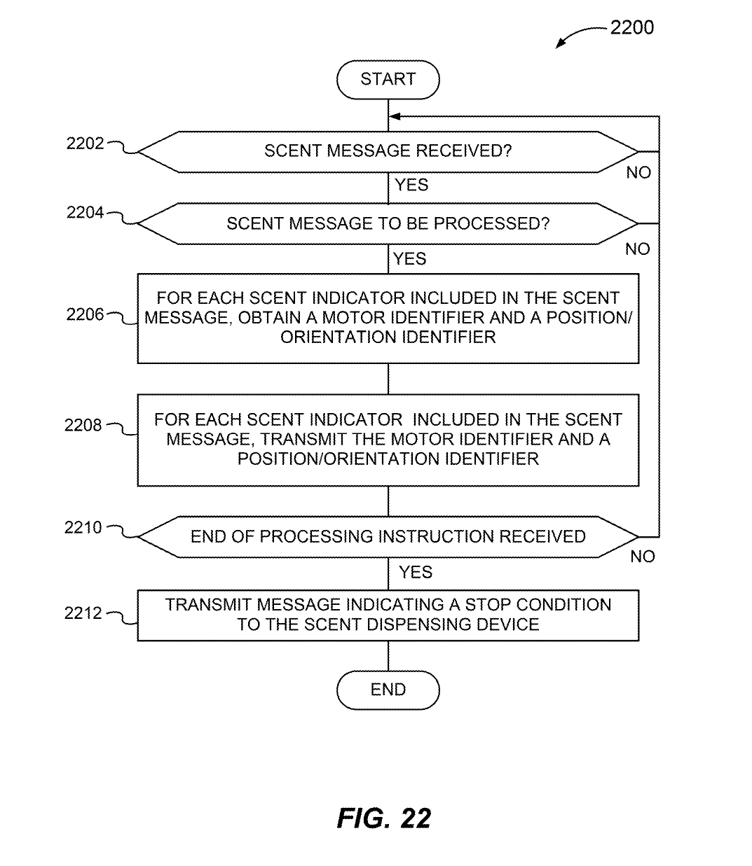

FIG. 22 is a flowchart of a method 2200 of operating the scent dispensing system 1600, according to one illustrated embodiment. One or more acts included in the method 2200 may be performed by the first mobile device 1604, for example, after a processing unit (e.g., processing unit 1812) of the first mobile device 1604 loads a software application including computer-executable instructions into RAM (e.g., RAM 1822) and executes the instructions. The application may instruct the processing unit to cause a touch screen (e.g., touch screen 1852) to display a series of prompts, receive information input in response to the prompts, store the received information in RAM (e.g., RAM 1822) of system memory (e.g., system memory 1814), process and/or transform the received information, and transmit information corresponding to the received information via a network interface (e.g., network interface 1860).

At 2202, the processing unit determines whether a scent message has been received. For example, the processing unit inspects a message buffer in the system memory for the presence of a scent message. If the processing unit determines that a scent message has not been received, the method returns to 2202. If the processing unit determines that a scent message has been received, the method proceeds to 2204.

At 2204, the processing unit determines whether the scent message is to be processed. For example, the processing unit 1812 causes the touch screen to display a prompt requesting the user to select a selectable icon indicating whether the scent message is to be processed. If the processing unit determines that the scent message is not to be processed, the method returns to 2202. If the processing unit determines that the scent message is to be processed, the method proceeds to 2206.

At 2206, the processing unit parses the scent message and identifies each scent indicator included in the scent message. Each scent indicator may indicate, for example, a particular scent (e.g., Chocolate 1) or a lack of particular scent (e.g., an empty chamber or a chamber including a particular type of air filter). For example, the processing unit obtains a first scent identifier of “Coffee 3” and a second scent identifier of “Chocolate 2” from the scent message. The processing unit then obtains a scent cartridge receptacle identifier and a chamber identifier that correspond to the first scent identifier. For example, the processing unit accesses information corresponding to Table 3 above and determines that the scent “Coffee 3” is included in chamber number 4 of the scent cartridge loaded in the scent cartridge receptacle “B,” and also information corresponding to Table 2 above and determines that the scent “Chocolate 2” is included in chamber number 3 of the scent cartridge loaded in the scent cartridge receptacle “A.” The processing unit then obtains the corresponding motor identifiers and position identifiers from information corresponding to Tables 4 and 5 below, for example. That is, the processing unit obtains, from information corresponding to Table 4, a motor identifier of “00,” which corresponds to the scent cartridge receptacle identifier “A” and a motor identifier of “01,” which corresponds to the scent cartridge receptacle identifier “B.” The processing unit also obtains, from information corresponding to Table 5, a position/orientation identifier of “010,” which corresponds to the chamber number 3, and a position/orientation identifier of “011,” which corresponds to the chamber number 4.

TABLE 4

| Scent cartridge receptacle | |
|---|---|
| Identifier | Motor Identifier |
| A | 00 |
| B | 01 |
| C | 10 |
| D | 11 |

TABLE 5

| Chamber Number | Orientation/Position Identifier |
|---|---|
| 1 | 000 |
| 2 | 001 |
| 3 | 010 |
| 4 | 011 |
| 5 | 100 |

At 2208, the processing unit transmits the motor identifier and the position/orientation identifier obtained at 2206 for each scent identifier included in the scent message to the first scent dispensing device 1602. The processing unit may cause a network interface for Bluetooth communications (e.g., network interface 1860) to transmit a first message for the first scent identifier and a second message for the second scent identifier to the first scent dispensing device 1602. For example, for the first scent identifier of “Coffee 3,” the first message includes a motor identifier of “01” and a position/orientation identifier of “011” and, for the second scent identifier of “Chocolate 2,” the second message includes a motor identifier of “00” and a position/orientation identifier of “010.” The first and the second messages may include other information, for example, network addresses of the first scent dispensing device 1602 and the first mobile device 1604. The first and the second messages may also include other information, such as control information indicating whether each message is the first or last message of a group of messages that create a particular scent combination or sequence of scent combinations.

At 2210, the processing unit determines whether an end of processing instruction has been received. For example, the processing unit 1812 causes the touch screen to display a selectable icon that, when selected, causes the processing unit to receive the end of processing instruction. If the processing unit determines that the end of processing instruction has not been received, the method returns to 2202. If the processing unit determines that the end of processing instruction has been received, the method proceeds to 2212.

At 2212, the processing unit 1812 causes the network interface to transmit a predefined message that indicates a stop condition to the first scent dispensing device 1602. The method 2200 ends after the message is transmitted at 2212.

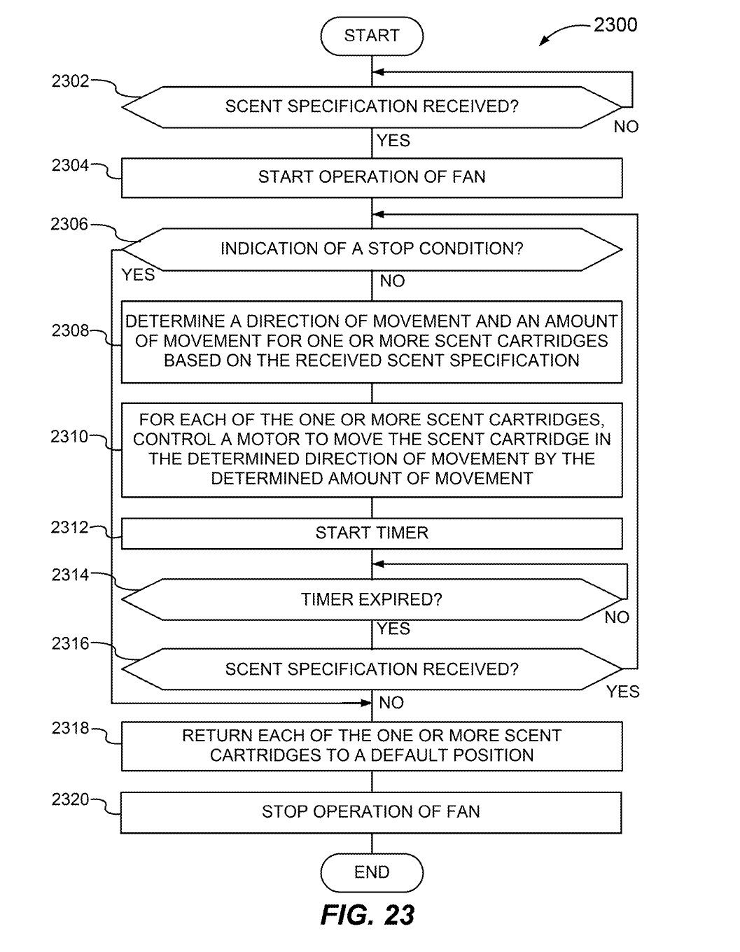

FIG. 23 is a flowchart of a method 2100 of operating the scent dispensing system 1600 shown in FIG. 16, according to one illustrated embodiment. One or more acts included in the method 2300 may be performed by the first scent dispensing device 1602, for example, after a user operates a switch (e.g., slide potentiometer 1706) that causes power to be supplied to the first scent dispensing device 1602. In response, a microcontroller (e.g., microcontroller 1702) causes processor-executable instructions stored in an internal memory to be loaded into an internal RAM and begins executing the instructions.

At 2302, the microcontroller determines whether a scent specification has been received. For example, the microcontroller may inspect an internal Universal Asynchronous Receiver/Transmitter (UART) to determine whether a message from the first mobile device 1604 has been received via a Bluetooth communications module (e.g., Bluetooth communications module 1710). The received scent specification may be included in, or correspond to, information included in a scent specification file generated using the scent sequence specification user interface 2000 shown in FIG. 20, for example. If the microcontroller determines that the scent specification has not been received, the method returns to 2302. If the microcontroller determines that the scent specification has been received, the method proceeds to 2304.

At 2304, the microcontroller starts operation of a fan (e.g., fan 1708) by causing an appropriate control signal to be provided to the fan. The particular control signal provided to the fan may depend on the position of a switch (e.g., slide potentiometer 1706). For example, if the switch is at a first position, the microcontroller provides a first control signal to the fan and, if the switch is at a second position, the microcontroller provides a second control signal to the fan, wherein the first control signal causes the fan to rotate faster than the second control signal.

At 2306, the microcontroller determines whether an indication of a stop condition is present. For example, the microcontroller monitors a particular input/output line that is connected to a circuit that provides an indication when the charge remaining in a battery that supplies power to the first scent dispensing device 1602 falls below a predetermined threshold. The predetermined threshold is selected such that the charge remaining in the battery is sufficient to move each of the motors and thus each of the scent cartridges of the first scent dispensing device 1602 to a default position or orientation. At 2306, the microcontroller also may determine whether a predetermined message indicating a stop condition has been received from the first mobile device 1604. If the microcontroller determines that the indication of the stop condition is present, the method proceeds to 2318. If the microcontroller determines that the indication of the stop condition is not present, the method proceeds to 2308.

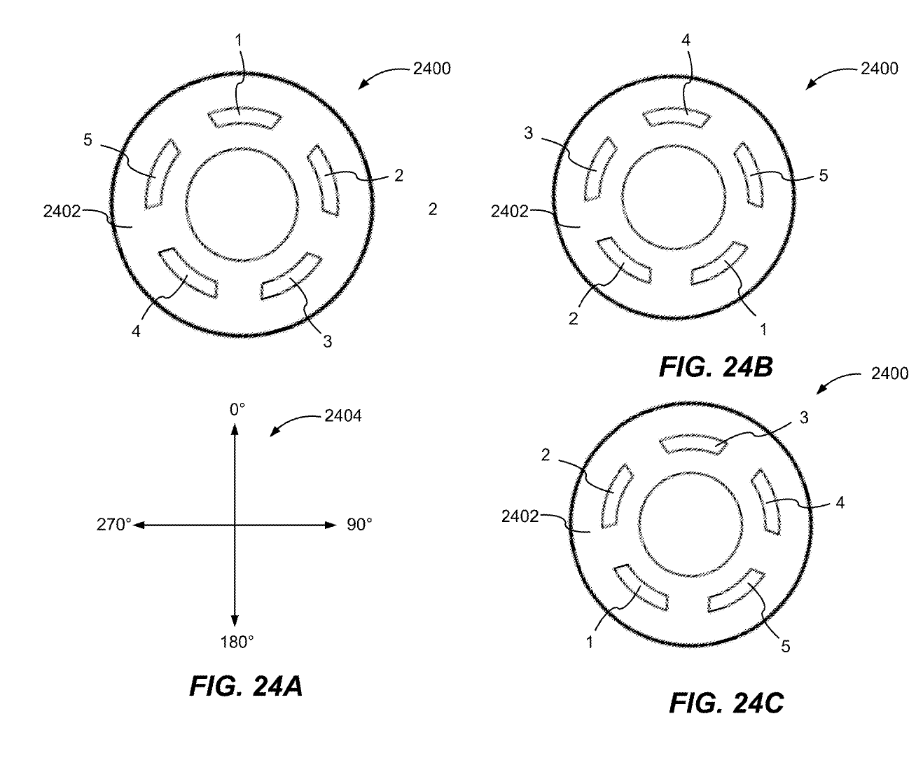

At 2308, the microcontroller determines a direction of movement and an amount of movement of one or more cartridges and/or motors. The acts performed at 2308 will be described with reference to FIGS. 24A-24C. FIG. 24A shows a top plan view of a scent cartridge 2400, according to one illustrated embodiment. An end portion 2402 of the cartridge 2400 includes five apertures that function as outlet ports for five chambers numbered 1-5. The cartridge 2400 shown in FIG. 24A is in a default orientation or position, in which the aperture corresponding to chamber 1 is aligned with an inlet port of a scent mixing chamber (not shown) of the first scent dispensing device 1602. A reference coordinate system 2404 also is shown in FIG. 24A.

For example, the aperture corresponding to chamber 1 may be aligned with an aperture 1014c formed in the bottom portion 1014b of the scent mixing chamber 1014 shown in FIG. 10E. More particularly, the cartridge 2400 may be positioned below the scent mixing chamber 1014 such that a lower surface of the bottom portion 1014b of the scent mixing chamber 1014 is parallel to an upper surface of the end portion 2402 of the cartridge 2400, and the cartridge 2400 is rotated, positioned, or otherwise oriented such that the aperture corresponding to chamber 1 is vertically aligned with the aperture 1014c. For example, the cross-sectional areas of the aperture corresponding to chamber 1 the aperture 1014c are sized and dimensioned the same and, if the cross-sectional area of the aperture 1014c is projected downwardly, the projected area would pass through the aperture corresponding to chamber 1 and would not pass through other areas of the end portion 2402.

Table 6 below shows an example of information that may be stored in internal memory of the microcontroller. In one embodiment, the apertures in the end portion 2402 of the cartridge 2400 have the same size and dimensions, and are uniformly spaced on the end portion 2402 of the cartridge 2400. The orientation of the center of each chamber can be defined by the orientation of a line that starts at the center of the end portion 2402 of the cartridge 2400 and passes through the center of the aperture corresponding to the chamber. The microcontroller can cause the shaft of stepper motors (e.g., stepper motors 1704) to move one step at a time, wherein 200 steps cause one full rotation of the shaft. Table 6 also includes the number of steps that are required to rotate the cartridge 2400 counterclockwise from the default position shown in FIG. 24A such that a particular chamber is aligned with one of the apertures 1014c formed in the bottom portion 1014b of the scent mixing chamber 1014, for example.

TABLE 6

| Chamber | Orientation | Orientation of Center | Relative |
|---|---|---|---|
| Number | Identifier | of Chamber | Steps |
| 1 | 000 | 0° | 0 |
| 2 | 001 | 72° | 40 |
| 3 | 010 | 144° | 80 |
| 4 | 011 | 216° | 120 |
| 5 | 100 | 288° | 160 |

Table 7 shows a table similar to Table 6 that is for clockwise rotation. Information corresponding to Table 7 may be stored in internal memory of the microcontroller.

TABLE 7

| Chamber | Orientation | Orientation of Center | Relative |
|---|---|---|---|
| Number | Identifier | of Chamber | Steps |
| 1 | 000 | 0° | 0 |
| 2 | 001 | 288° | 160 |
| 3 | 010 | 216° | 120 |
| 4 | 011 | 144° | 80 |
| 5 | 100 | 72° | 40 |

The processing performed at 2308 will be explained with reference to a series of calculations performed by the scent dispensing device 1602 in response to receiving a scent specification corresponding to a scent specification file, for example, generated using the scent sequence specification user interface 2000 shown in FIG. 20 and described above. The scents specified in a sequence of scent specifications require the first scent dispensing device 1602 to determine corresponding orientations of the scent cartridge 2400. For example, the scent cartridge 2400 is initially a default or first orientation or position shown in FIG. 24A, the first scent dispensing device 1602 determines a second orientation of the scent cartridge 2400 corresponding to FIG. 24B, and then a third orientation of the scent cartridge 2400 corresponding to FIG. 24C.

As noted above, the scent cartridge 2400 initially is in the default orientation shown in FIG. 24A, and the first scent dispensing device 1602 determines the second orientation corresponding to FIG. 24B. For example, the scent specification includes information indicating that the aperture corresponding to chamber number 4 of the scent cartridge 2400 is to be aligned with aperture 1014c formed in the bottom portion 1014b of the scent mixing chamber 1014. The microcontroller first determines the amount of rotation required if the scent cartridge 2400 is rotated in a clockwise direction and the amount of rotation required if the scent cartridge 2400 is rotated in a counterclockwise direction. That is, the microcontroller determines that the scent cartridge 2400 shown in FIG. 24A must be rotated by 144° (or 80 steps) in the clockwise direction, or alternatively must be rotated by 216° (or 120 steps) in the counterclockwise direction, for the scent cartridge 2400 to become oriented as shown in FIG. 24B. Because less rotation of the scent cartridge 2400 is required in the clockwise direction (e.g., fewer steps), the microcontroller determines at 2308 that the direction of movement is the clockwise direction, and that the amount of movement is 144° (or 80 steps).

At 2310, the microcontroller controls the motor coupled to the scent cartridge 2400 to move in the direction of movement determined at 2308, by the amount of movement determined at 2308. For example, the microcontroller 1702 provides control signals to the stepper motor 1704a that cause the shaft of the stepper motor 1704a to move 80 steps in the clockwise direction to orient the scent cartridge 2400 as shown in FIG. 24B.

At 2312, the microcontroller starts an internal timer. In one embodiment, the microcontroller initializes the timer started at 2312 using a default timer value (e.g., 5000 milliseconds). In another embodiment, the microcontroller initializes the timer started at 2312 using a timer value (e.g., 10 seconds) that is included in the scent specification received at 2302.

At 2314, the microcontroller determines whether the timer has expired. For example, the microcontroller monitors the timer for a predetermined voltage level that indicates that the amount of time used to initialize the timer has elapsed after the timer was set at 2312. If the microcontroller 1702 determines that the timer has not expired, the method returns to 2314. If the microcontroller 1702 determines that the timer has expired, the method proceeds to 2316.

At 2316, the microcontroller determines whether an additional scent specification has been received. For example, the microcontroller performs the same acts as described above in connection with 2302. If the microcontroller determines that the additional scent specification has been received, the method returns to 2306.

For example, at 2306, the microcontroller determines that the indication of the stop condition has not been received and proceeds to 2308. At 2308, the microcontroller determines the third orientation corresponding to FIG. 24C. For example, the scent specification includes information indicating that the aperture corresponding to chamber number 3 of the scent cartridge 2400 is to be aligned with aperture 1014c formed in the bottom portion 1014b of the scent mixing chamber 1014. The microcontroller determines the amount of rotation required if the scent cartridge 2400 is rotated in the clockwise direction and the amount of rotation required if the scent cartridge 2400 is rotated in the counterclockwise direction. That is, the microcontroller determines that the scent cartridge 2400 shown in FIG. 24B must be rotated by 72° (or 40 steps) in the clockwise direction, or alternatively must be rotated by 288° (or 160 steps) in the counterclockwise direction, for the scent cartridge 2400 to become oriented as shown in FIG. 24C. Because less rotation of the scent cartridge 2400 is required in the clockwise direction, the microcontroller determines at 2308 that the direction of movement is the clockwise direction, and that the amount of movement is 72° (or 40 steps). The microcontroller then performs the acts described above at 2310, 2312, and 2314.

At 2316, if the microcontroller determines that the additional scent specification has not been received, the method proceeds to 2318. At 2318, the microcontroller returns each cartridge that was moved based on the controlling performed at 2310 to its default orientation or position. For example, if the cartridge 2400 is currently oriented/positioned as shown in FIG. 24C, the microcontroller causes the cartridge 2400 to be oriented/positioned as shown in FIG. 24A. That is, the microcontroller performs processing similar to that performed at 2308 and 2310 to cause the cartridge 2400 to be oriented/positioned as shown in FIG. 24A.

At 2318, the microcontroller causes the fan to stop operating. For example, the microcontroller 1702 provides a control signal to the fan 1708 that causes the fan 1708 to turn off.

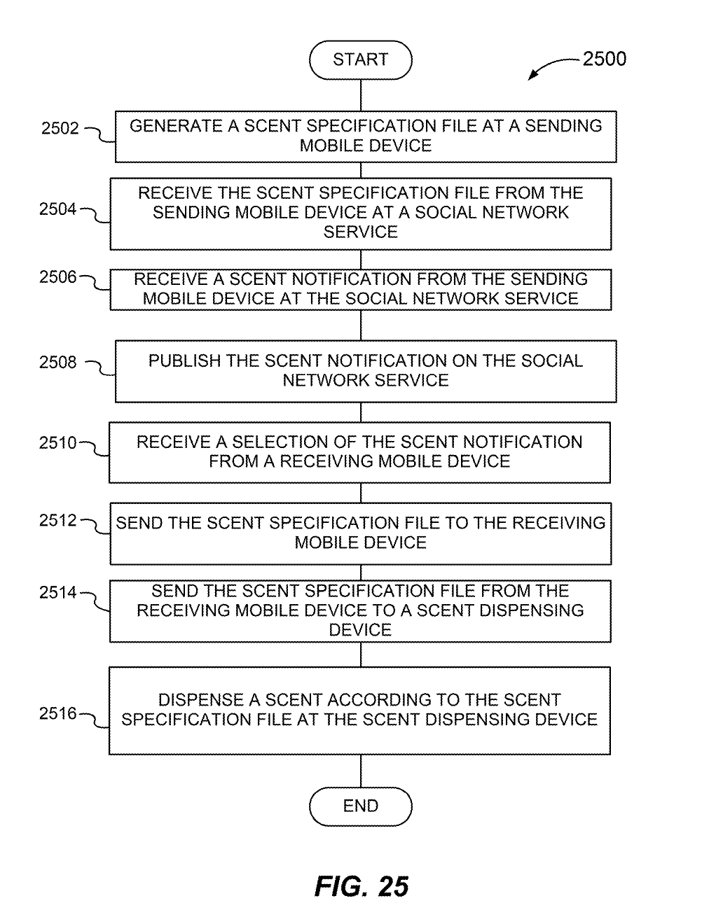

FIG. 25 is a flowchart of a method 2500 of operating the scent dispensing system 1600 in a social network environment, according to one illustrated embodiment. One or more acts included in the method 2500 may be performed by the first mobile device 1604 or the second mobile device 1608, for example, after a processing unit (e.g., processing unit 1812) of the first mobile device 1604 loads a software application including computer-executable instructions into RAM (e.g., RAM 1822) and executes the instructions. The application may instruct or cause the processing unit to cause a touch screen (e.g., touch screen 1852) to display a series of prompts, receive information input in response to the prompts, store the received information in RAM (e.g., RAM 1822) of system memory (e.g., system memory 1814), process and/or transform the received information, and transmit information corresponding to the received information via a network interface (e.g., network interface 1860). One or more acts included in the method 2500 may also be performed by the server 1606, for example, after a processing unit (e.g., processing unit 1912a) of the server loads a software application including computer-executable instructions into RAM (e.g., RAM 1922) and executes the instructions.

At 2502, a sending user of the second mobile device 1608 (e.g., a sending client device) may generate a scent specification file. The scent specification file may be generated through the scent sequence specification user interface 2000, which may be provided by the server 1606 and/or by the program 1838 executing on the second mobile device 1608. For example, a processor of the device (e.g., processing unit 1812a) causes a display device (e.g., touch screen 1852) to display the scent sequence specification user interface 2000. As discussed below, a processor (e.g., processing unit 1912a) of the server 1606 executes predetermined instructions (e.g., that are stored in the programs 1938) in response to receipt of information from the first mobile device 1604 and/or the second mobile device 1608.

At 2504, the server 1606 receives the scent specification file from the second mobile device 1608, and a digital post or scent notification is received by the server at 2506. The scent notification may instruct the server 1606 to publish a message or digital post to a social network service operated by the server 1606 or operatively coupled to the server. Intended recipients of the scent notification may include one or more users specifically selected by a user of the second mobile device 1608. Intended recipients may also include a group of associated users, such as users that are social contacts of the user of the second mobile device 1608. As another example, the intended recipients may include users that have agreed to receive scent notifications from the user of the second mobile device 1608 (e.g., “subscribers” or “followers”).

At 2508, the server 1606 publishes the scent notification on the social network service. The scent notification is then viewable by one or more users of the social network service. For example, a user of the first mobile device 1604 may be able to view the scent notification when a processor of the device (e.g., processing unit 1812a) causes a display device (e.g., touch screen 1852) to display the scent notification on the user's “wall” or news feed, or other display area. As discussed above, in addition to including the scent specification file that specifies at least one scent, the scent notification may also include a text portion, audio portion, and/or video portion. In one embodiment, the scent sequence specification user interface 2000 enables a user to specify information corresponding to the text portion 1614, the scent portion 1616, the audio portion 1618, and the video portion 1620 of a plurality of scent notifications. For example, the scent sequence specification user interface 2000 may be used to generate a scent notification having a text portion 1614 that includes a text message, a scent portion 1616 that specifies a scent combination corresponding to the aroma of a particular coffee, an audio portion 1618 that specifies a recording of milk being frothed, and a video portion 1620 that specifies a picture of a cup of coffee.

At 2510, the server 1606 receives a selection of the scent notification one of the client devices, such as the first mobile device 1604. The user of the first mobile device 1604 may select the scent notification (e.g., by clicking on or touching a link associated with the scent notification, etc.), which causes the server 1606 to send the scent specification file to the first mobile device 1604 at 2512. At 2512, the program executing on the first mobile device 1604 causes the first mobile device to send the scent specification file to the scent dispensing device 1602. This may be accomplished using wired or wireless communications. For example, as discussed above the first mobile device 1604 and the scent dispensing device 1602 may communicate via a wireless Bluetooth connection. In some embodiments, the server 1606 may send the scent specification file directly to the scent dispensing device 1602 through wired or wireless communications.

A processor executing the program processes the scent specification file and the scent notification as discussed above. When the scent notification is processed by the first mobile device 1604, a processing unit (e.g., processing unit 1812) of the first mobile device 1604 causes a display device to display the text corresponding to the text portion 1614 causes speakers to emit sounds corresponding to the audio portion 1618, and causes the display device to display a picture corresponding to the video portion 1620. The audio portion 1618 and the video portion 1620 scent notification may include references to attached files and/or links (e.g., URIs) to files that are stored by other devices (e.g., the server 1606). At 2516, the processing unit causes the first scent dispensing device 1602 to dispense a scent according to the scent specification file.

In some embodiments, the program will postpone causing the first scent dispensing device 1602 to dispense one or more scents according to the scent specification file. For example, the user of the first mobile device 1604 may receive or view the scent notification when the user is not located near the scent dispensing device 1602 (e.g., the scent dispensing device is at the user's home and the user is away from home). In this case, the program may allow the user to view the scent notification without dispensing the scent, and then view the scent notification at a later time with the scent when the user is once again near the scent dispensing device 1602. The program may provide an indicator for the user to easily determine that a scent notification has not yet been experienced so the user may experience the scent notification at a later time.

In some embodiments, the program allows the user of the first mobile device 1604 to modify the scent specification file. For example, a user may vary the one or more scents or may add scents to or subtract scents from the scent specification file. The first mobile device 1604 may then publish the modified scent specification file to the social network service for viewing by other users, as discussed above. In addition to allowing users to modify or customize the scent specification file, the program may also allow users to add comments to the scent notification to be shared with other users of the social network service.

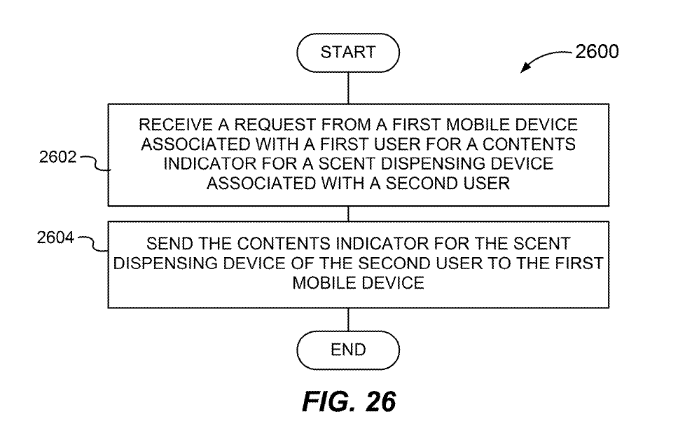

FIG. 26 is a flowchart of a method 2600 of operating the scent dispensing system 1600 in a social network environment, according to one illustrated embodiment. One or more acts included in the method 2600 may be performed by the first mobile device 1604 or the second mobile device 1608, for example, after a processing unit (e.g., processing unit 1812) of the first mobile device 1604 loads a software application including computer-executable instructions into RAM (e.g., RAM 1822) and executes the instructions. The application may instruct the processing unit to cause a touch screen (e.g., touch screen 1852) to display a series of prompts, receive information input in response to the prompts, store the received information in RAM (e.g., RAM 1822) of system memory (e.g., system memory 1814), process and/or transform the received information, and transmit information corresponding to the received information via a network interface (e.g., network interface 1860). One or more acts included in the method 2600 may also be performed by the server 1606, for example, after a processing unit (e.g., processing unit 1912a) of the server loads a software application including computer-executable instructions into RAM (e.g., RAM 1922) and executes the instructions.

At 2602, the server 1606 receives a request from a mobile device (e.g., the first mobile device 1604) associated with a first user for a contents indicator of a scent dispensing device (e.g., the scent dispensing device 1622) associated with a second user different than the first user. As discussed above, one or more software applications may include computer-executable instructions for gathering information regarding the contents of scent cartridges (e.g., scent cartridges 900, 1200, or 1400). For example, the software application executing on the second mobile device 1608 may enable a user to indicate that one or more scent cartridges are being or have been loaded into the second scent dispensing device 1622. Additionally or alternatively, the software application may cause the display device of the second mobile device 1608 to display a message instructing the second user to place a machine-readable symbol (e.g., barcode symbol) included with the scent cartridge within the field of view of a camera of the second mobile device. The software application may then instruct the processor to cause the camera to take or capture an image and to process corresponding image data to obtain the information regarding the contents of the cartridge. In this case, the second user may simply enter information regarding the location within the second scent dispensing device 1622 (e.g., a particular scent cartridge receptacle 1012b of a scent cartridge holder 1012) in which the cartridge is being or has been placed. As discussed above, the scent cartridge 1200 may include a memory that stores information regarding its contents and electrical contacts 1236 (FIG. 12B) for allowing access to the memory. Each of the scent cartridge receptacles 1012b may include electrical contacts 1024 (only one shown) that interface with corresponding electrical contacts 1236 on the scent cartridge. Using the electrical connection, the second scent dispensing device 1622 is able to obtain the information regarding the contents of the scent cartridge.

After the software application executing on the second mobile device 1608 has caused the processor to store the information regarding the contents and locations of the cartridges loaded within the second scent dispensing device 1622 into a memory of the second mobile device 1608, the program may send the information to the server 1606. At 2604, the server 1606 may send the contents indicator for the second scent dispensing device 1622 to the first mobile device 1604 associated with the first user.

The program executing on the first mobile device 1604 may allow the first user to generate a scent specification file directed to the second user taking into account the particular contents information of the second scent dispensing device 1622 associated with the second user. Thus, the first user can generate scents for the second user that the second scent dispensing device 1622 will be able to dispense without requiring the second user to obtain different scent cartridges from those already disposed within the second scent dispensing device 1622. Although this example describes obtaining the contents information for one other user's scent dispensing device, it should be appreciated that the program may provide contents information on the first mobile device 1604 for numerous users. This may allow the first user to create a scent specification file that can be experienced by all users in a group, and/or may be used to tailor scents directed to users based on the contents information for the users' respective scent dispensing devices.

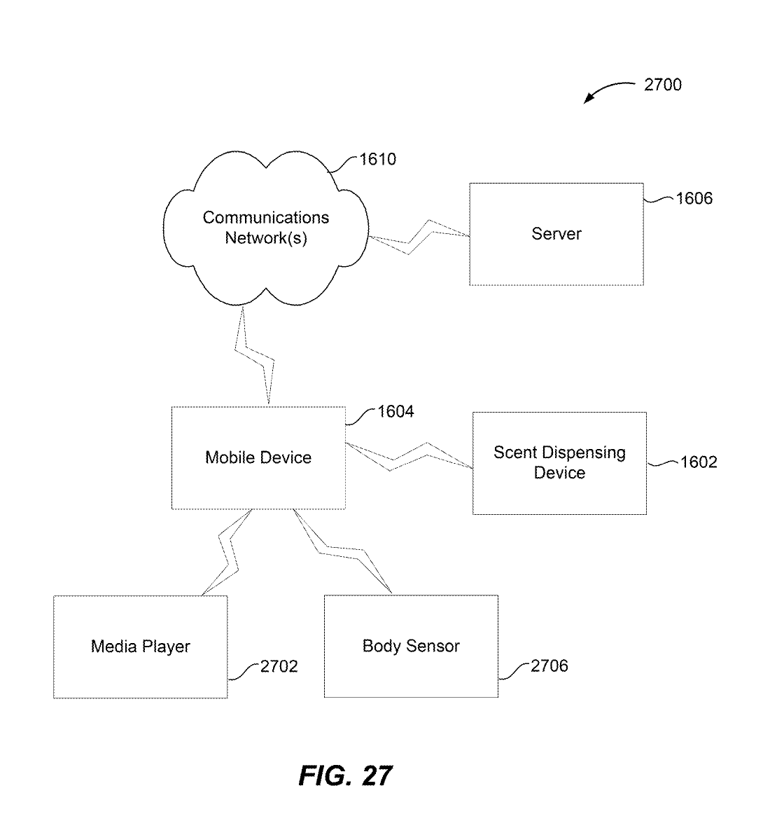

FIG. 27 is a network diagram of a scent dispensing system 2700, according to one illustrated embodiment. The scent dispensing system 2700 is similar in many respects to the scent dispensing system 1600 of FIG. 16, so much of the discussion of the scent dispensing system 1600 applies to the scent dispensing system 2700 as well.

In this embodiment, the mobile device 1604 is configured to communicate with a media player 2702. The media player 2702 may be any type of media player, such as a television, stereo, audio player, tablet computer, smart phone, notebook computer, video projector, or the like. The mobile device 1604 may communicate with the media player 2702 using any suitable wired or wireless interface, such as Bluetooth, Wi-Fi, USB, or the like. In some embodiments, the media player 2702 may be a software application executing on the mobile device 1604.

In this embodiment, the scent sequence specification user interface 2000 can be used to generate a sequence of messages 1612 that correspond to media content, for example, a novel, a song, or a movie. An electronic or physical copy of such media content may be accompanied by a group of scent cartridges (e.g., scent cartridges 900, 1200, or 1400) that includes scents for creating the scent combinations specified in the scent portions 1616 of a group of messages 1612 corresponding to the media content. The media content and/or the scent cartridges may include a code or a link for accessing additional contents specified in the messages 1612. For example, a paper copy of a novel may include a machine-readable symbol (e.g., a Quick Response Code) that, when scanned and decoded by the first mobile device 1604, causes the first mobile device 1604 to access a web page from which image files, audio files, and/or video files may be obtained. The first mobile device 1604 may also cause the media player 2702 to access media content or begin playback of the media content.

The first mobile device 1604 may process each message 1612 such that a scent specified in the scent portion 1616 is dispensed by the first scent dispensing device 1602 while sounds are emitted by speakers of the media player 2702 and/or images are displayed by a display device of the media player. For example, the program may cause information identifying a sequence of messages 1612 corresponding to the media content to be stored in system memory (e.g., program data 1842) in association with an identifier of the next message 1612 that is to be processed, which may be incremented each time one of the messages 1612 is processed. The program may control the timing of when each of the messages 1612 is processed to be synchronized with the media content. For example, in some embodiments the program is configured to utilize video time codes or audio watermarks associated with the media content to control when each of the messages is processed. In the case where the media content is a novel stored on an electronic reader, the program may receive the page information from the electronic reader (e.g., current page number) that is used to synchronize the scent messages 1612 with the story of the novel.

The mobile device 1604 of the scent dispensing system 2700 is also operative to communicate with a body sensor 2706 wearable by a user of the mobile device 1604. The body sensor 2706 is responsive to one or more physical characteristics, and provides signals to the mobile device 1604 based on the sensed (e.g., detected, measured) characteristics. The program of the mobile device 1604 receives the signals from the body sensor 2706 and causes the scent dispensing device 1602 to dispense one or more scents based on the received signals. For example, the body sensor 2706 may be operative to sense the pulse rate of a user of the mobile device 1604. The body sensor 2706 sends the user's pulse rate information to the program executing on the mobile device 1604. In response to detecting an elevated pulse rate, the program may cause the scent dispensing device 1602 to emit one or more scents believed to have a calming effect. As another example, the body sensor 2706 may be operative to sense that a user is drowsy or is falling asleep (e.g., by monitoring the user's movements). In response to detecting the user is drowsy, the program may cause the scent dispensing device 1602 to emit one or more scents believed to cause the user to be more alert (e.g., a coffee scent). Other combinations of body sensors and scents may be used as desired.

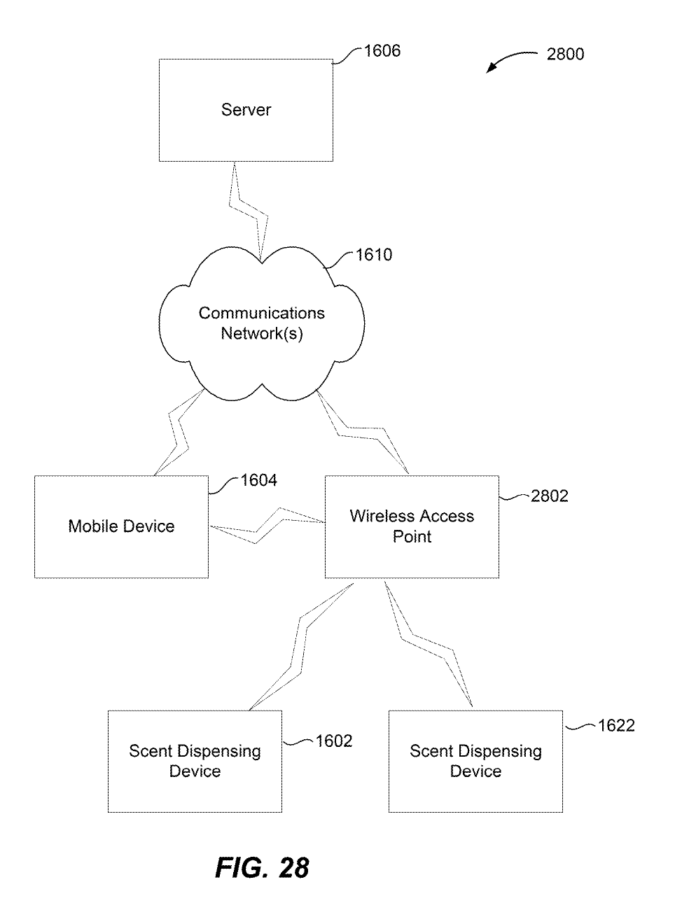

FIG. 28 is a network diagram of a scent dispensing system 2800, according to one illustrated embodiment. The scent dispensing system 2800 is similar in many respects to the scent dispensing systems 1600 and 2700 of FIGS. 16 and 27, respectively, thus much of the discussion of the scent dispensing systems 1600 and 2700 applies to the scent dispensing system 2800 as well. In this embodiment, the program executing on the mobile device 1604 operates to control a plurality of scent dispensing devices, such as scent dispensing devices 1602 and 1622. The mobile device 1604 may be communicatively coupled to the plurality of scent dispensing devices using any suitable wired or wireless protocol. In the illustrated embodiment, the scent dispensing devices communicate wirelessly with the mobile device 1604 via a wireless access point 2802 (e.g., a Wi-Fi router). For example, the mobile device 1604 may be used to control multiple scent dispensing devices throughout a home, movie theater, vehicle, etc. The program executing on the mobile device 1604 may send the same or different scents to each of the plurality of scent dispensing devices.

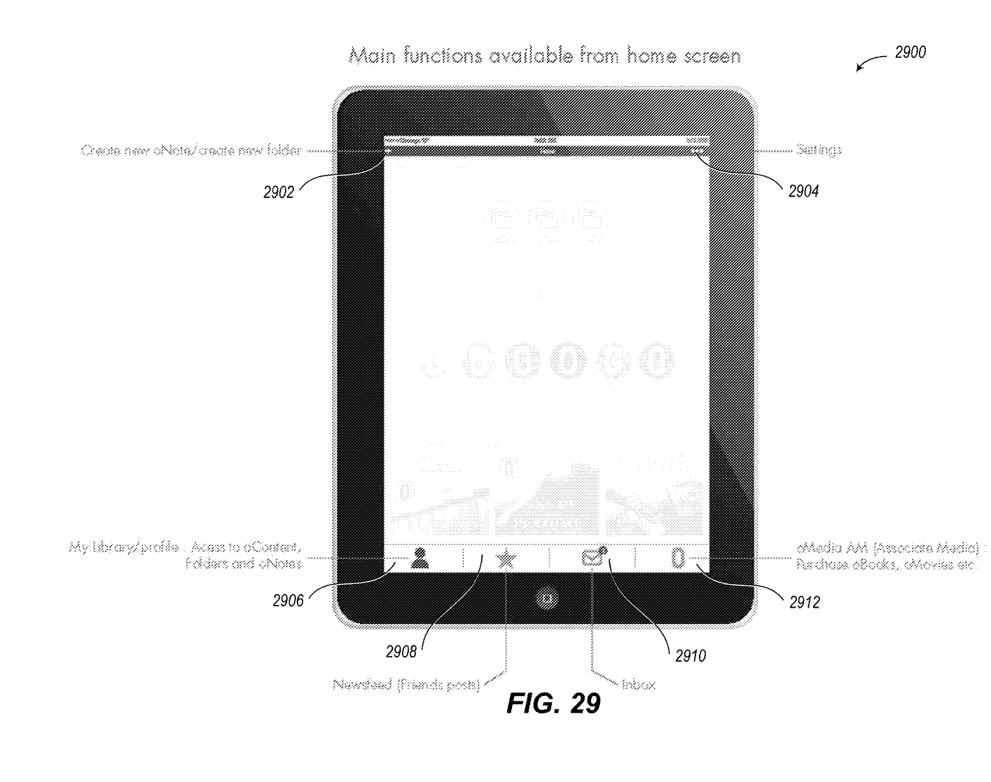

FIGS. 29-72 are screenshots of a graphical user interface for a social media application, according to one illustrated embodiment. The social media application may execute on a processor of a computing device, such as the processor 1812A of the mobile device 1800 shown in FIG. 18. A memory of a computing device, such as the system memory 1814 of the mobile device 1800, may store the social media application.

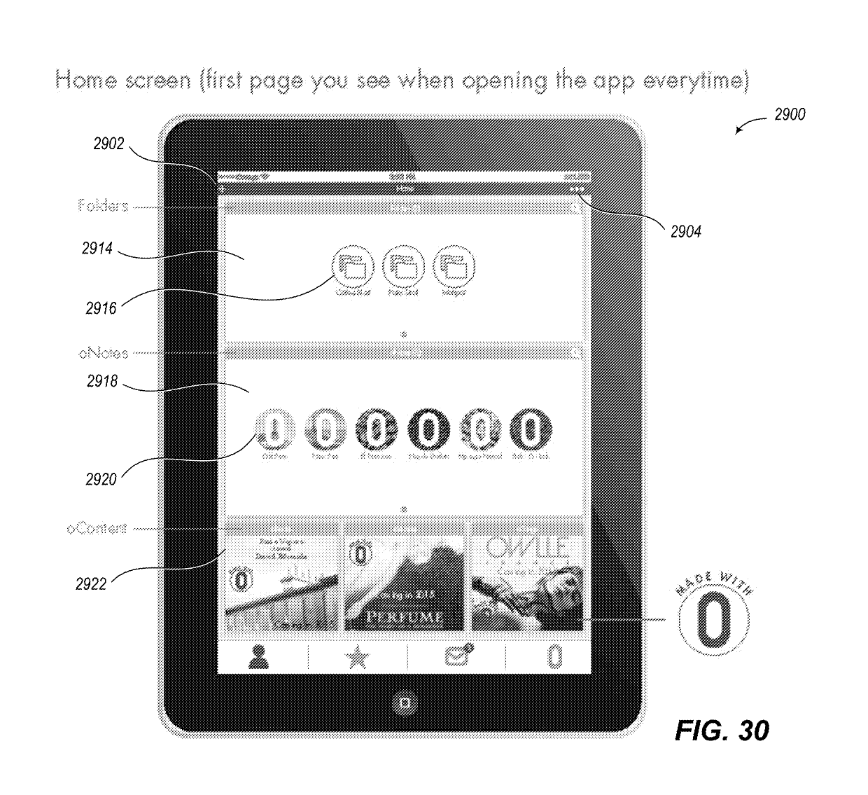

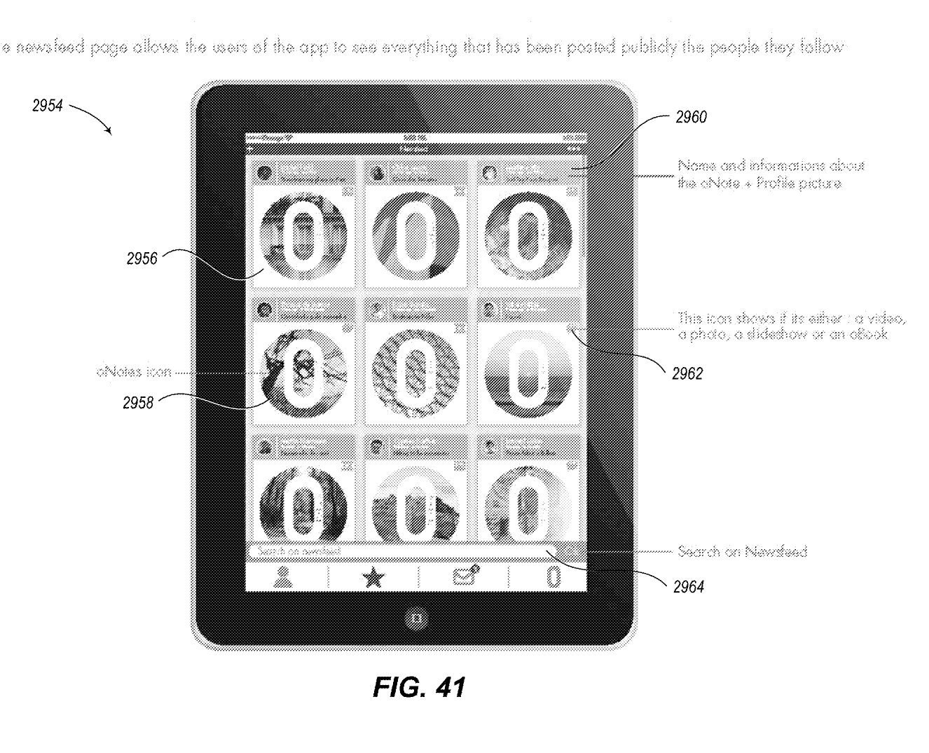

FIGS. 29 and 30 illustrate various functions accessible from a home screen 2900 of the social media application. At the top left of the screen, there is a plus (“+”) icon 2902 a user can tap on to create a new scent message or to create a new folder. A settings icon 2904 is located at the top right of the screen. The setting icon 2904 is discussed below with reference to FIG. 58. At the bottom left of the screen, there is My Library/Profile icon 2906 that allows the user to access content, folders, and scent messages. Next to the My Library/Profile icon 2906 is a Newsfeed icon 2908. When the user selects the Newsfeed icon 2908, the screen displays a list of digital posts created by social contacts of the user, or digital posts of other users which the user is “following” (see FIGS. 41-43). To the right of the Newsfeed icon 2908 is an Inbox icon 2910 that causes a user's scent message inbox to be displayed when selected. At the bottom right of the screen is an Associated Media icon 2912 that allows the user to purchase or rent content (e.g., books, movies, etc.) that has one or more scents associated therewith.

FIG. 30 illustrates additional items accessible from the home screen 2900 of the social media application. At the top of the screen, a folder window 2914 is provided that includes a plurality of folder icons 2916 selectable by the user. Each of the folders 2916 may include one or more scent messages, content, etc. In the middle of the screen there is an available scent message window 2918 that displays scent message icons 2920 for scents available on the mobile device. A content window 2922 is positioned at the bottom of the screen that shows content stored on a memory of the mobile device. In the illustrated embodiment, the content window 2922 includes icons for books, movies, and music, but icons for other types of content may also be provided.

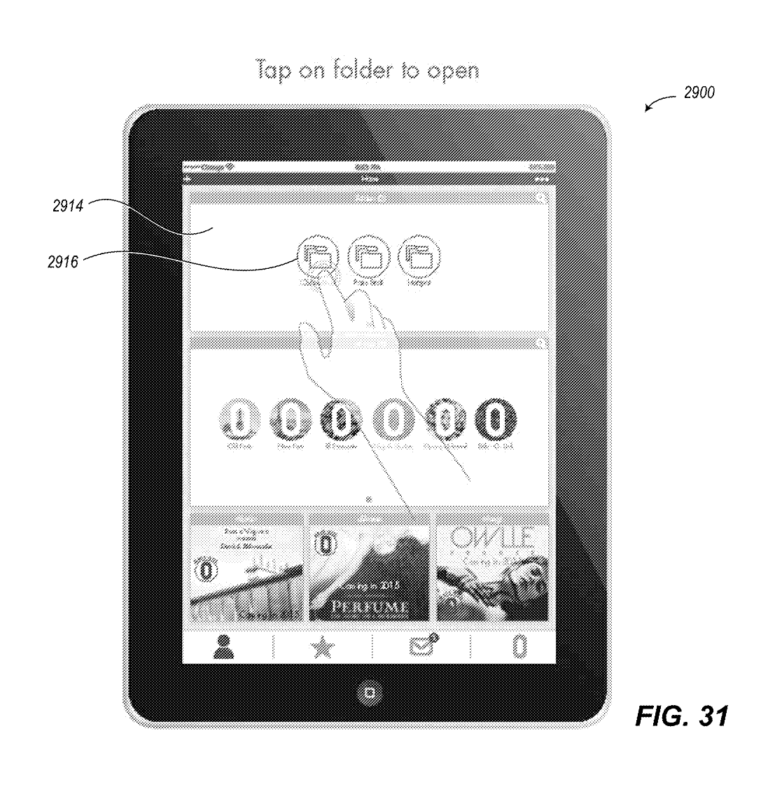

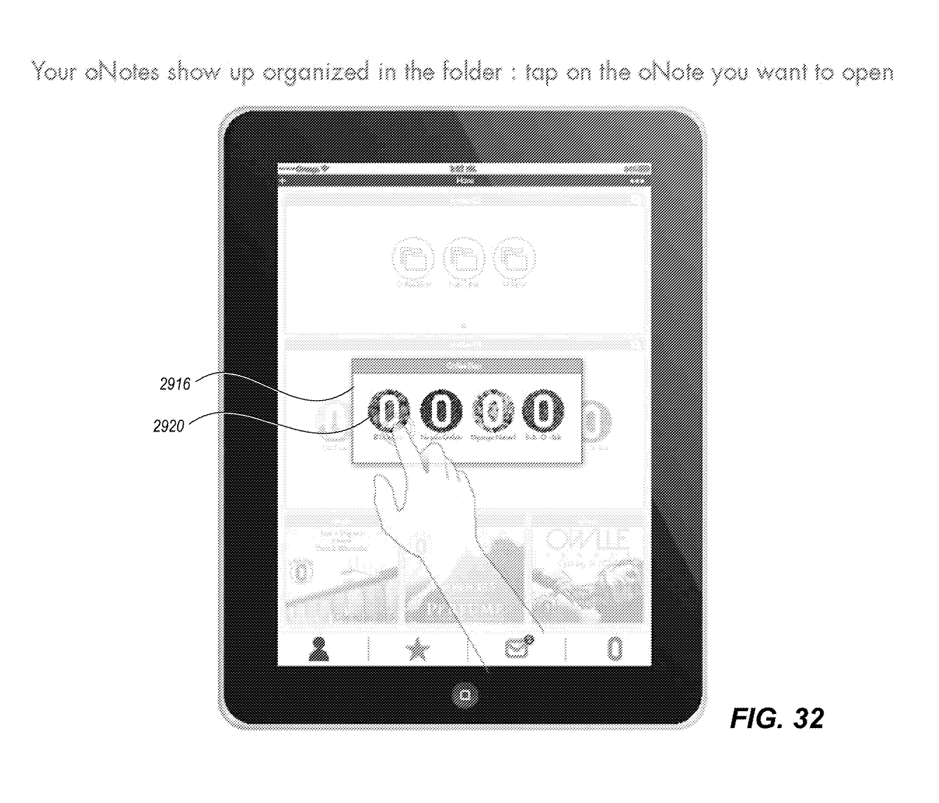

As shown in FIG. 31, the user can tap on one of the folder icons 2916 from the home screen 2900 of the social media application to open the folder. FIG. 32 shows the scent messages 2920 stored within the selected folder 2916. In this example, the selected folder 2916 includes four scent messages 2920. The user can open one of the scent messages 2920 by tapping on the scent message he or she wishes to open.

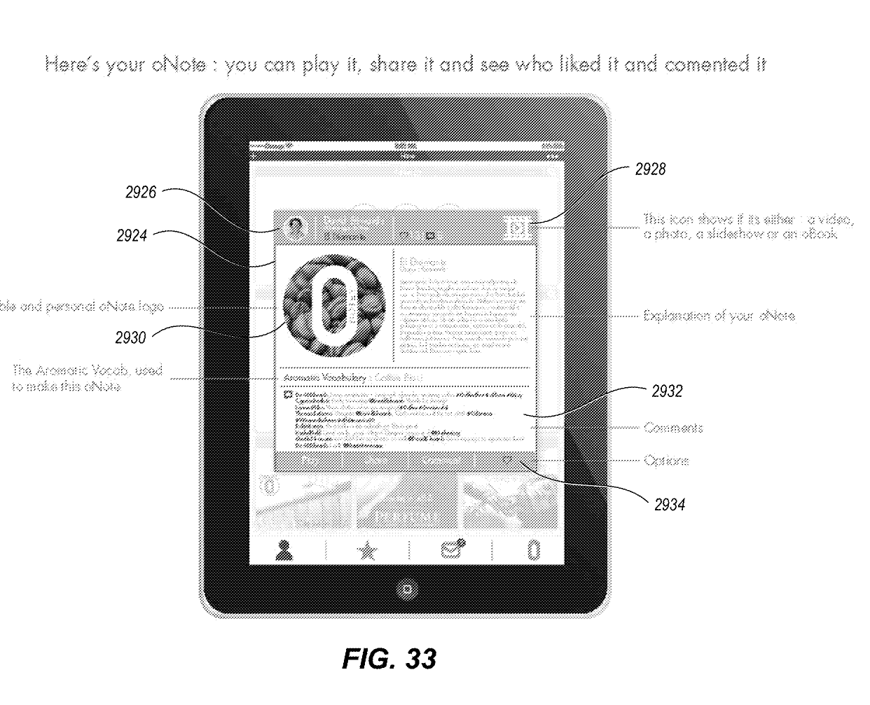

As shown in FIG. 33, when the user selects a scent message, a scent message window 2924 opens that displays information about the scent message. Information 2926 about the creator of the scent message is listed at the top of the window. This information may include the creator's name, photo, current location, status, etc. An icon 2928 at the top right of the window specifies whether the scent message includes a video, a photo, a slideshow, or a book.

The scent message window 2924 also includes a logo 2930 for the scent message and an explanation or description of the message. A comments section 2932 of the window 2924 displays comments made by one or more users associated with the social media application or other applications. Option icons 2934 are presented at the bottom of the scent message window 2924.

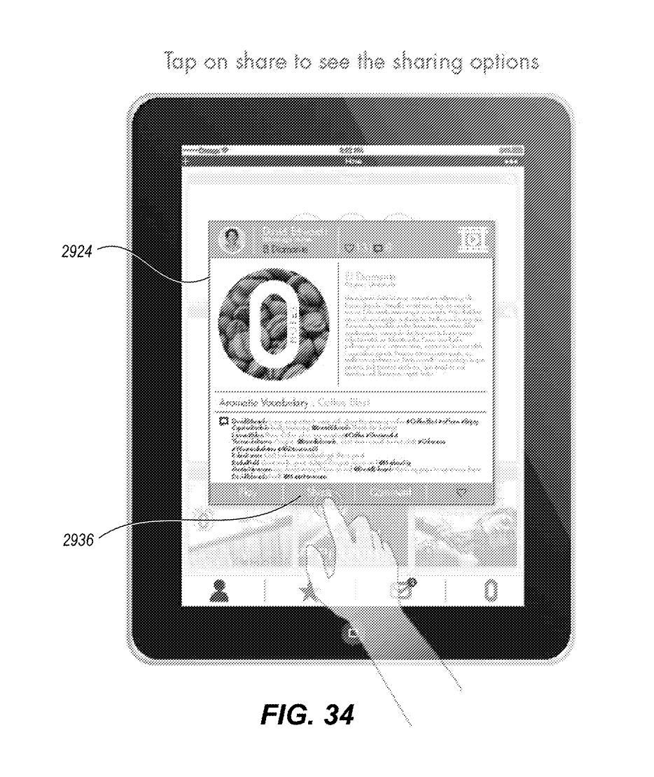

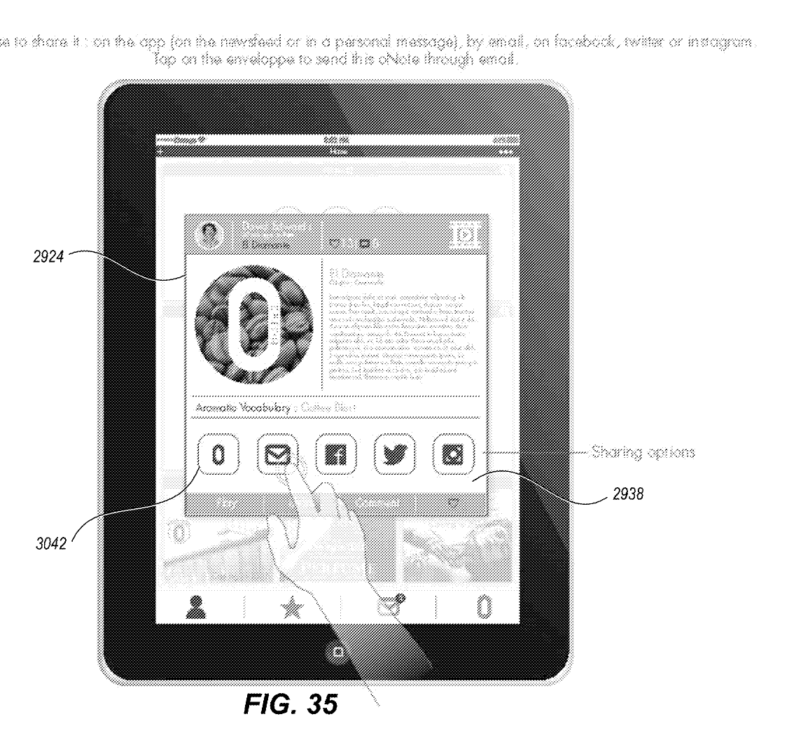

FIG. 34 illustrates the user selecting a “share” icon 2936 from the list of option icons 2934. FIG. 35 illustrates a list of sharing options 2938 provided to the user responsive to the user selecting the share icon 2936. In this example, the user is presented with five options to share the scent message. In other embodiments, more or less sharing options may be provided. In the illustrated example, the user is provided with options to share the scent message within the social media application (e.g., on the Newsfeed or in a personal message to one or more other users), by email, by Facebook®, Twitter®, or Instagram®. The user may tap on the appropriate icon to share the scent message in one or more ways.

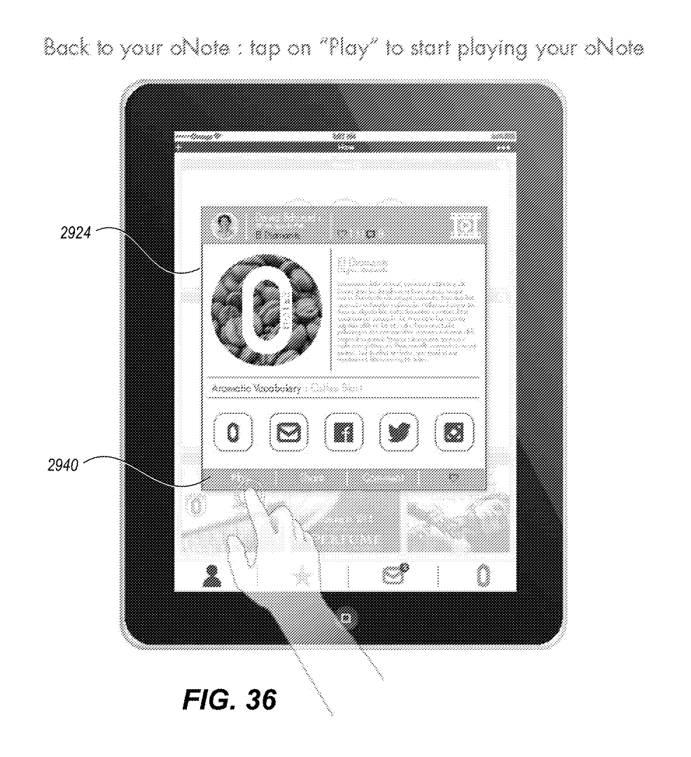

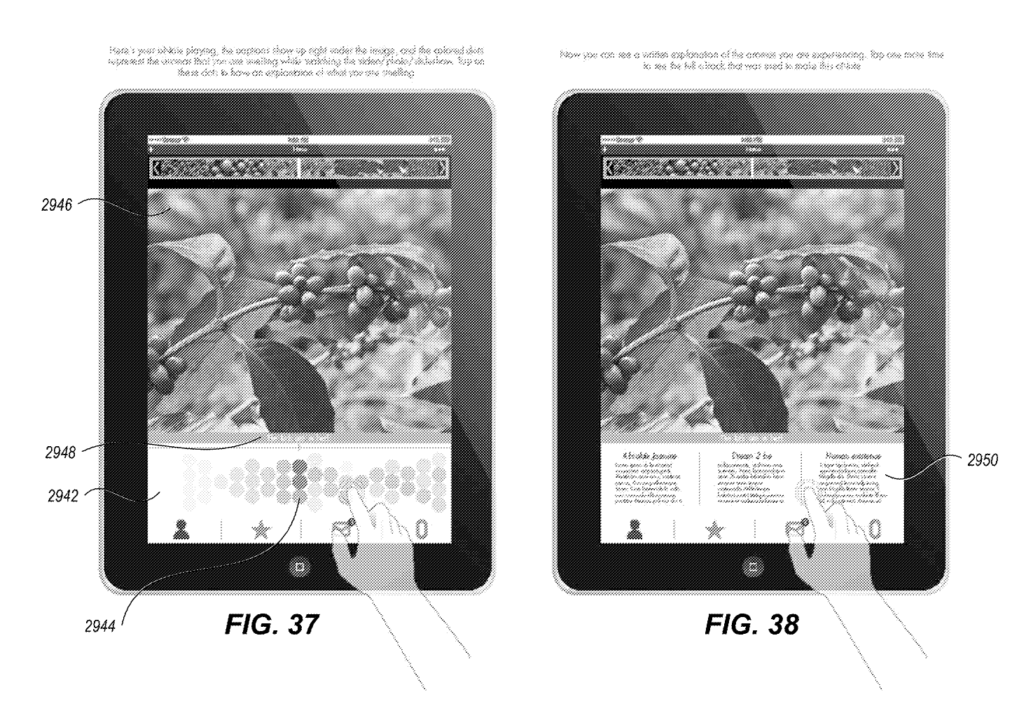

FIG. 36 illustrates the user selecting a play option 2940 in the scent message window 2924. When the play option 2940 is selected, the scent message begins to play on the display of the mobile device, as shown in FIG. 37. If the mobile device is connected to a scent dispensing device, the scents of the scent message will also be dispensed by the connected dispensing device. A bottom section 2942 of the screen illustrates a graph that includes colored dots 2944 that each represents scents. The dots 2944 scroll from the right of the screen to the left such that the dots in the center of the screen represent scents that are currently being presented on the screen and/or dispensed by a connected dispensing device, the dots on the left of the screen represent scents that have already been presented, and the dots on the right of the screen represent upcoming scents in the scent message. In the illustrated embodiment, the center column of dots 2944 is highlighted and the dots to the left and right of the center column of dots are greyed out, which allows the user to quickly view which aromas are currently being presented.

During playback of the scent message one or more images 2946 and captions 2948 may be displayed. The timing of the display of the images 2946 and captions 2948 may be synchronized with the scents in the message.

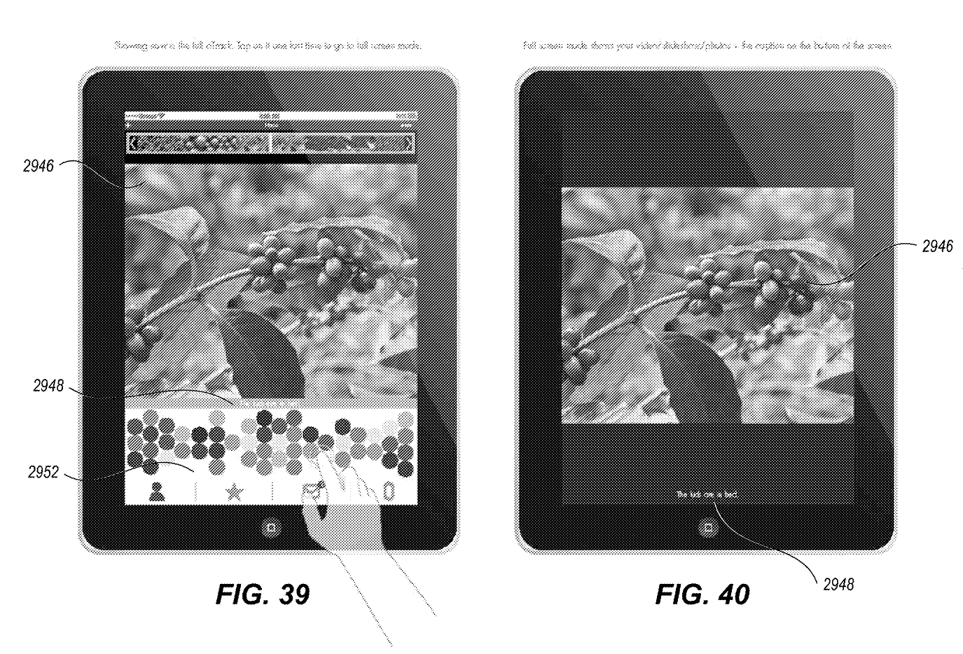

As shown in FIGS. 37 and 38, when the user taps on one of the dots 2944, a written explanation 2950 of the aromas is provided. The user may tap on the written explanation 2950 to cause the entire “track” 2952 of the scent message to be presented (FIG. 39). As shown in FIG. 40, the user may then tap on the track 2952 to put the display of the mobile device in a full screen mode that shows the video/slideshow/photos 2946, the caption 2948 at the bottom of the screen, and plays any audio associated with the scent message through speakers of the mobile device.

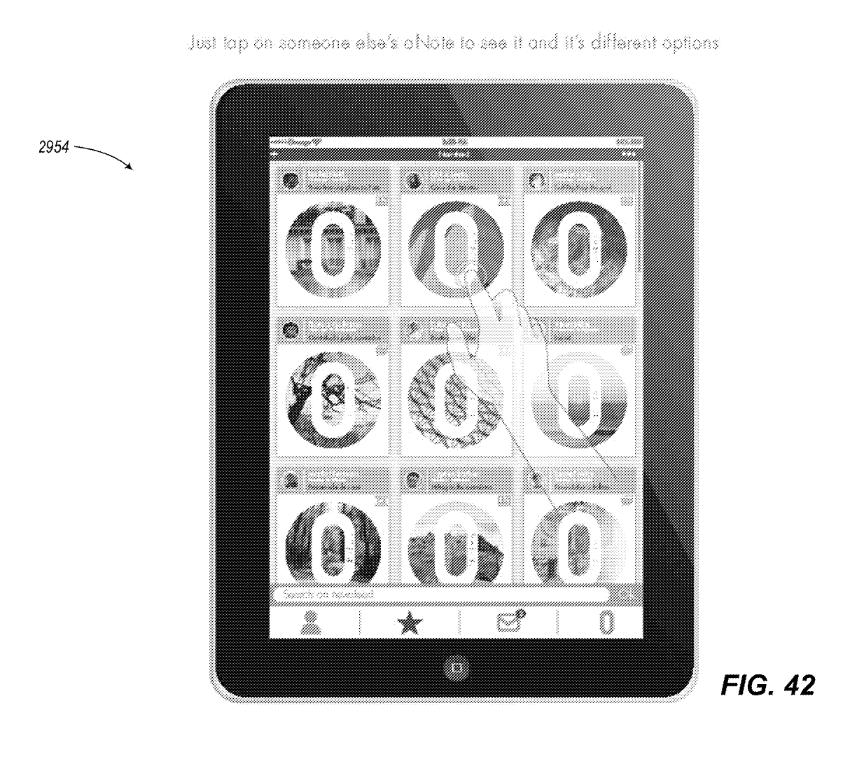

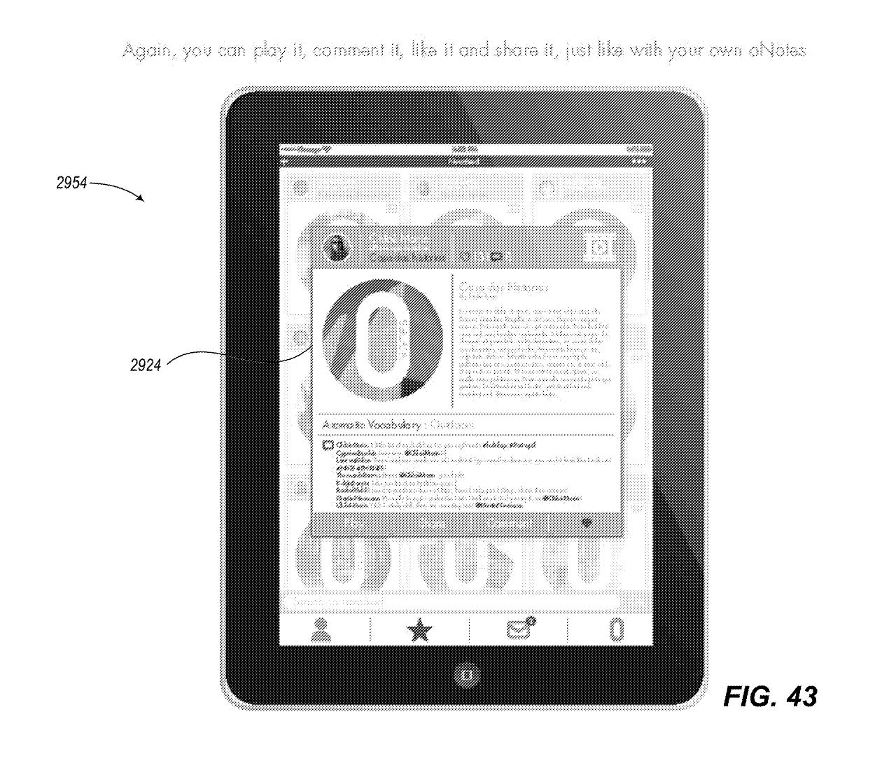

FIGS. 41-43 are screenshots illustrating the newsfeed page 2954 of the social media application, according to one illustrated embodiment. The newsfeed page 2954 allows the user to view everything (e.g., scent messages, content, etc.) that has been posted publicly by the people they are connected to and/or the people they follow. As shown in FIG. 41, each of the scent messages is represented as a digital post 2956 that includes a message icon 2958, an information bar 2960, and a content icon 2962 that indicates if the message includes a video, photo, slideshow, or a book. A search bar 2964 is provided at the bottom of the newsfeed page 2954 to allow the user to search the newsfeed. As shown in FIGS. 42 and 43, the user can tap on another user's scent message to open it in a scent message window 2924. As described above, from the scent message window 2924 the user can play the scent message, comment on the scent message, or share the scent message, as if the scent message were the user's own scent message.

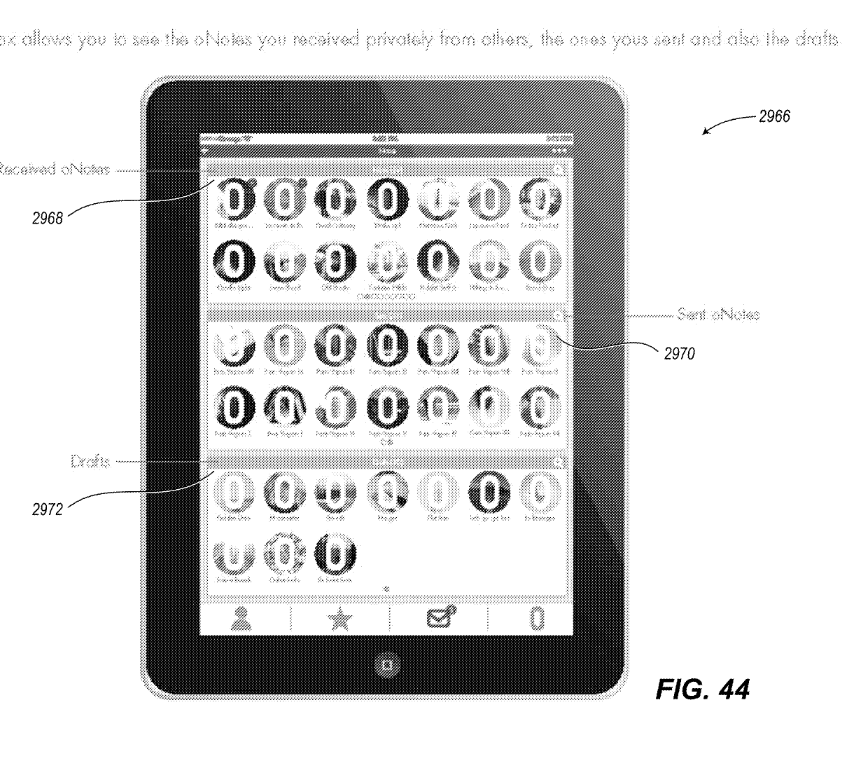

FIG. 44 is a screenshot of a mailbox 2966 for the social media application, according to one illustrated embodiment. A top window 2968 displays scent messages received privately from other users of the social media application. Scent messages that have not been opened may be marked or highlighted as such. A middle window 2970 display scent messages sent by the user to other users of the social media application. A bottom window 2972 displays draft sent messages that have not yet been sent by the user.

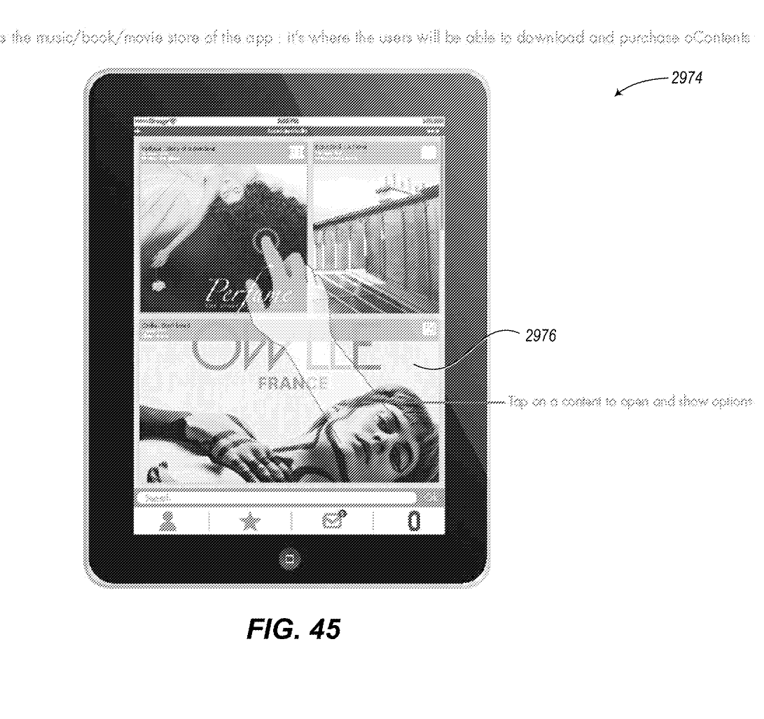

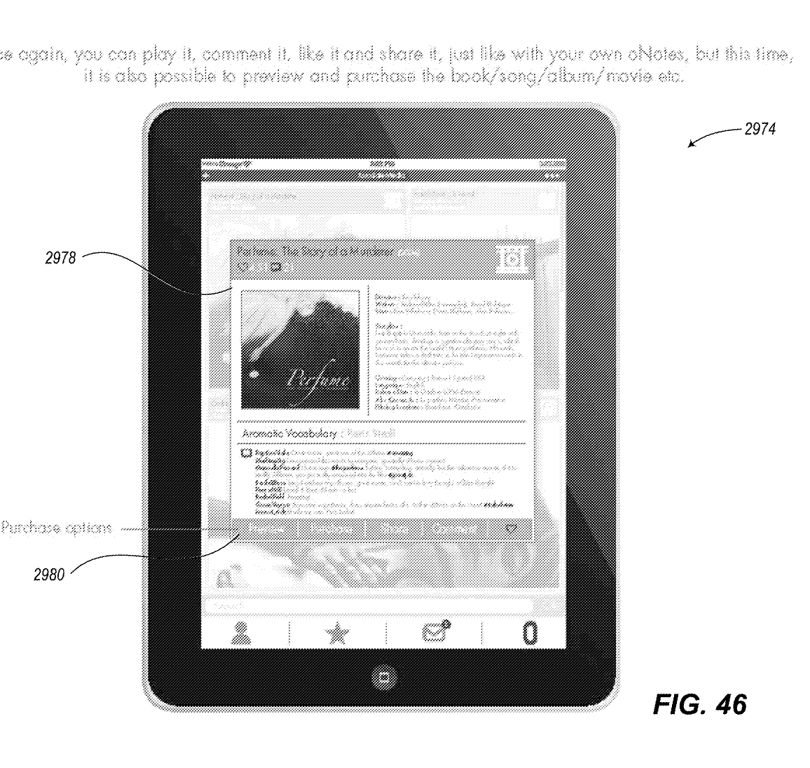

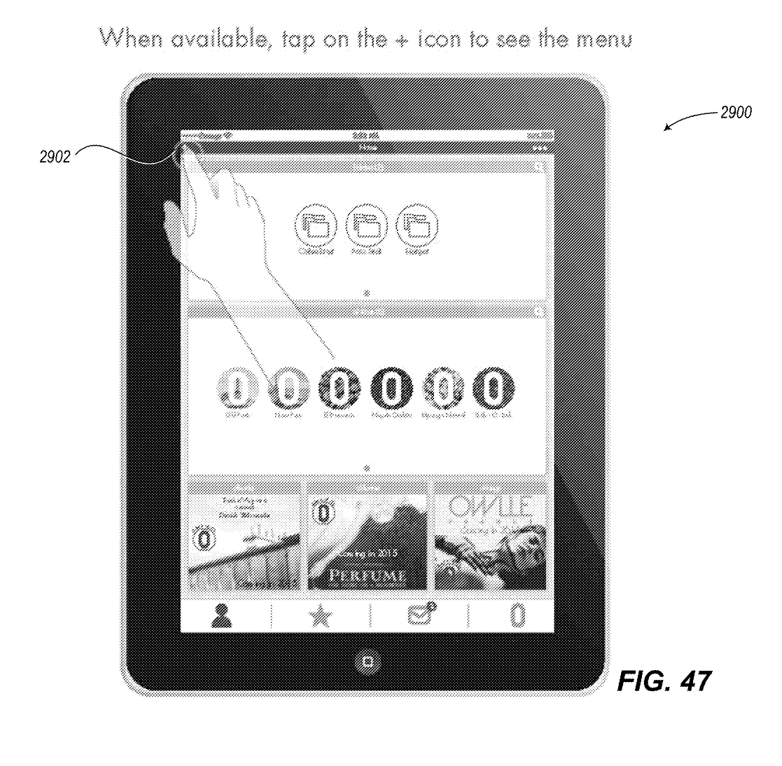

FIGS. 45 and 46 illustrate an associated media store 2974 of the social media application that allows the user to purchase or rent content (e.g., books, movies, etc.) that has one or more scents associated therewith. The associated media store 2974 may be accessed by tapping on the Associated Media icon 2912 displayed on the home screen 2900 (FIG. 29). As shown in FIG. 45, the user can view, search for, and select content 2976 available for download and purchase. The content 2976 may include, but is not limited to: images, audio, video, books, etc. When the user selects a content 2976, a content window 2978 opens that displays information about the content and various options (FIG. 46). The content window 2976 is similar to the scent message window 2924 discussed above. The user can preview, purchase, and/or download the content by tapping on one or more icons 2980. Through the content window 2976 the user can also play the content, comment on the content, and share the content with others by tapping on the icons 2980.

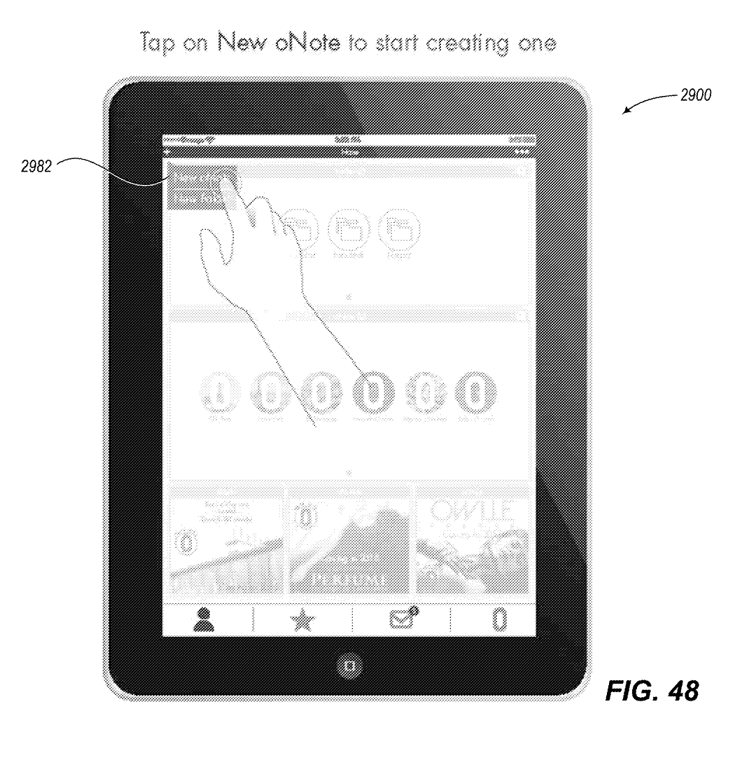

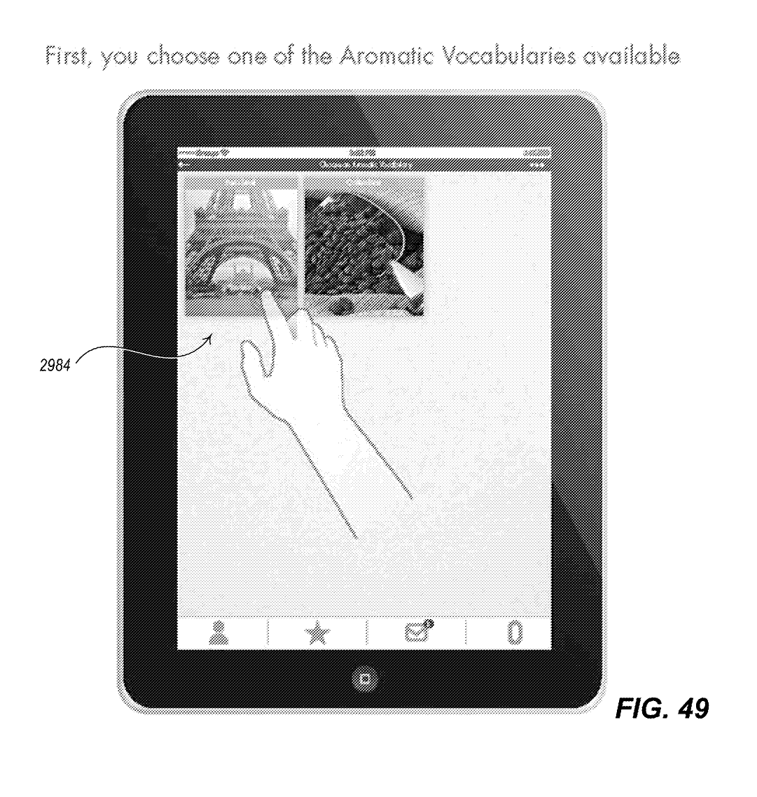

FIGS. 47-56 are screenshots illustrating the process for creating a new scent message using the social media application. The user first taps on the plus icon 2902 located in the top left corner of the home screen 2900 and selects an icon 2982 for a new scent message (FIGS. 47 and 48). As shown in FIG. 49, the user is then presented with one or more aromatic vocabularies 2984 that are available to generate the new scent message. In the illustrated example, two aromatic vocabularies 2984 are available: Paris Stroll and Coffee Stroll.

In some embodiments, each aromatic vocabulary 2984 may include sixteen scents. The sixteen scents may be divided into four scent cartridges containing four scents apiece. For example, the Paris Stroll vocabulary may include four scent cartridges titled Flesh, Floral, Vegetation, and Violence. The Flesh scent cartridge may include scents for Baby, Virgin, Orgy, and Aura. The Floral scent cartridge may include scents for Noblesse, Baldini Boutique, Absolu Jasmin, and Absolu Lavande. The Vegetation scent cartridge may include scents for Sea, Nuit Napolitaine, Amor et psyche, and Salon Rouge. The Violence scent cartridge may include scents for Human Existence, Paris 1738, Ermite, and Atelier Grimaldi.

As another example, the Coffee Stroll vocabulary may include four scent cartridges titled Earth, Countryside, Passion, and Exoticism. The Earth scent cartridge may include scents for Roasty, Watery Fruit, Licorice, and Red Fruit Seed. The Countryside scent cartridge may include scents for Bergamot, Apricot Pit, Berry, and Malty. The Passion scent cartridge may include scents for Cassis, Passion Fruit, Legumineux, and Animal. The Exoticism scent cartridge may include scents for Smokey, Exotic Wood, Milk Chocolate, and Milky.

In some embodiments, a Base Stroll vocabulary is also provided. For example, a scent dispensing device may include eight scent cartridges, four of which are the Base Stroll vocabulary and four of which are another vocabulary (e.g., Paris Stroll or Coffee Stroll). The Base Stroll vocabulary may be used alone or with other vocabularies. In one embodiment, the Base Stroll vocabulary includes four scent cartridges titled Confection, Plantation, Gardening, and Nibbling. The Confection scent cartridge includes scents for Buttery, Caramel, Red Sugar, and Espelette Pepper. The Plantation scent cartridge includes scents for Zesty, Cocoa Bean, Balsamic, and Fermented Yogurt. The Gardening scent cartridge includes scents for Green Vegetation, Jasmine, Malty Cereal, and Butyric. The Nibbling scent cartridge includes scents for Cedar, Nut, Chocolate Powder, and Grilled Bread.

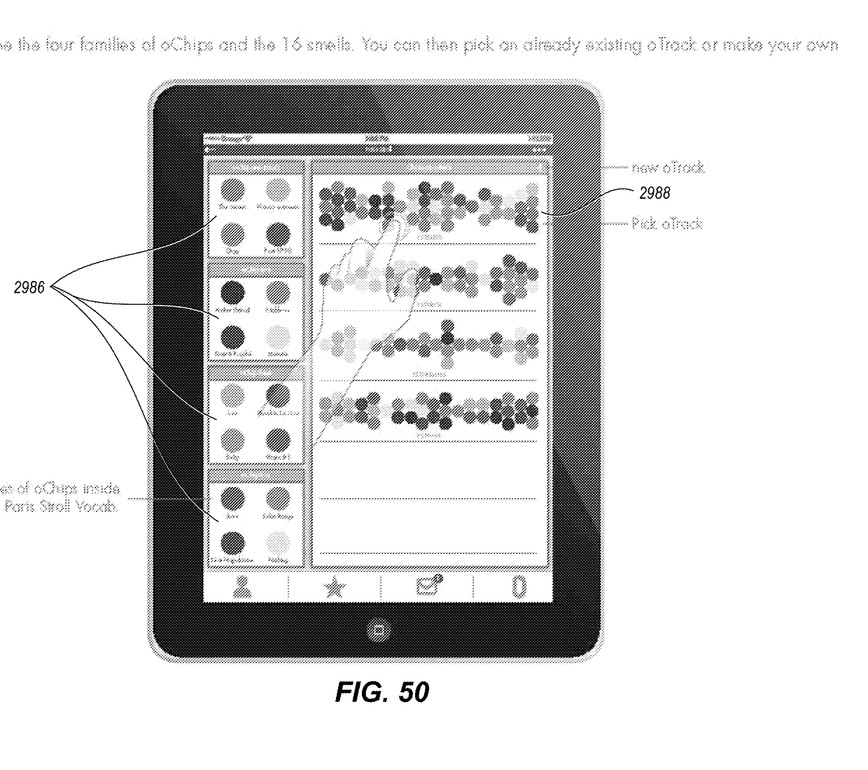

After selecting one of the available aromatic vocabularies 2984, the user is presented with the scents 2986 of the four selected scent cartridges associated with the selected aroma vocabulary (FIG. 50). The user can select a scent message 2988 (also referred to as a “track”) or create a new scent message by selecting one or more scents 2986 of the selected vocabulary 2984 to be played over time (e.g., a sequence of one or more scents played over time).

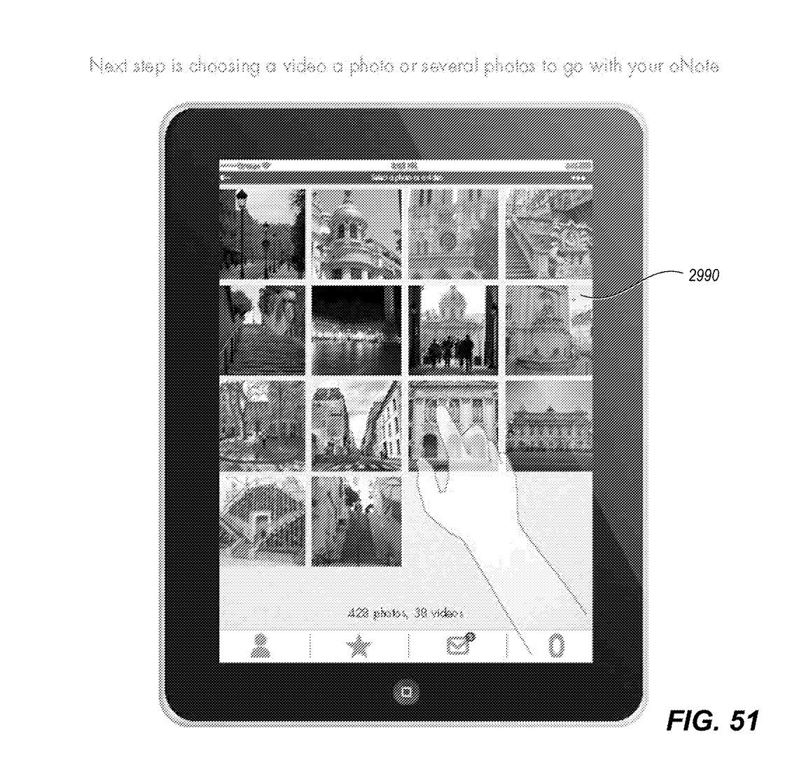

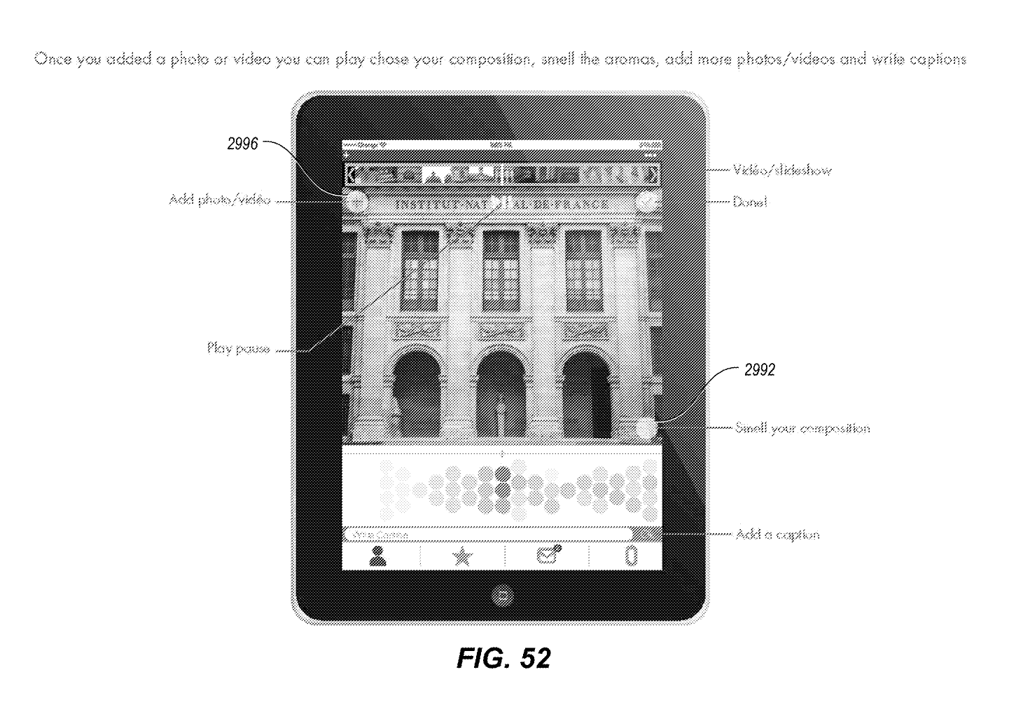

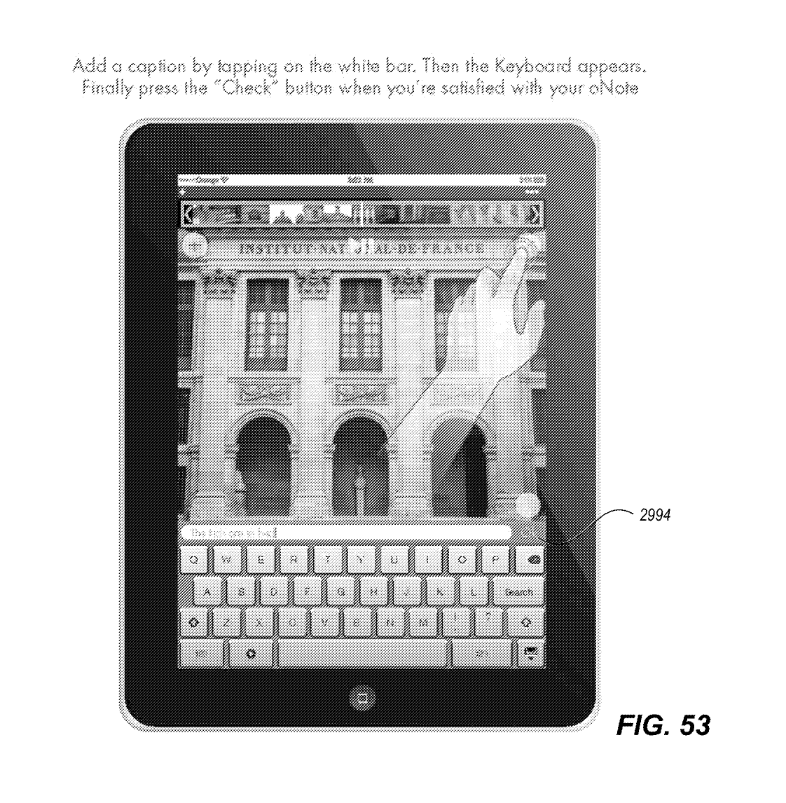

After the user has selected the scents 2986 for the scent message, the user may select one or more videos or photos 2990 to accompany the scent message (FIG. 51). As shown in FIG. 52, the graphical user interface allows the user to create the scent message as a composition, adding videos, photos (e.g., by tapping on an icon 2996), and/or text at various times when one or more scents of the scent message are to be dispensed. From this interface the user can also tap on an icon 2992 to smell the composition. As shown in FIG. 53, the user can use an on-screen keyboard 2994 to add a caption associated with a particular scent, photo, and/or video.

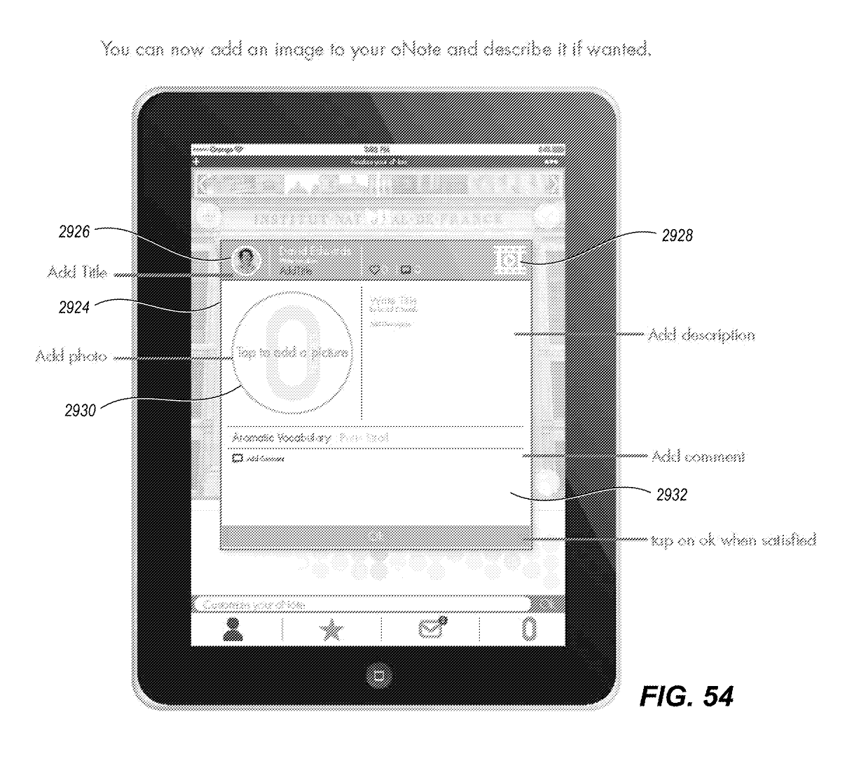

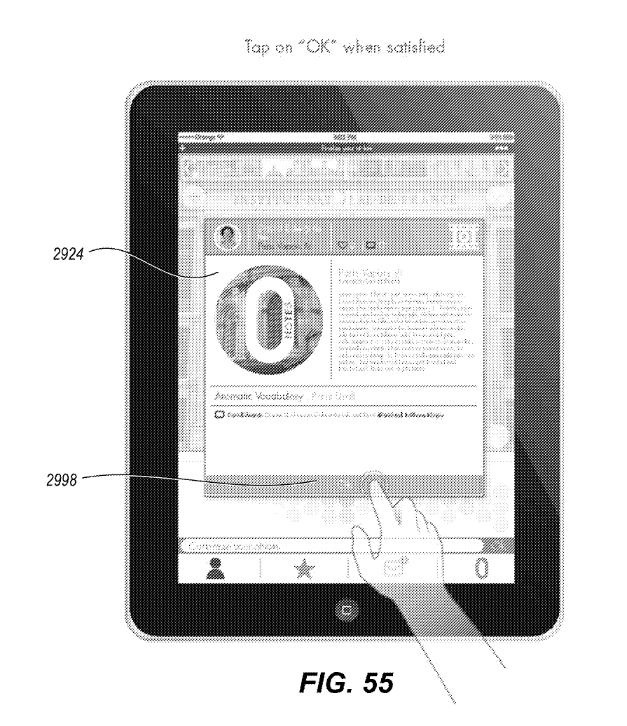

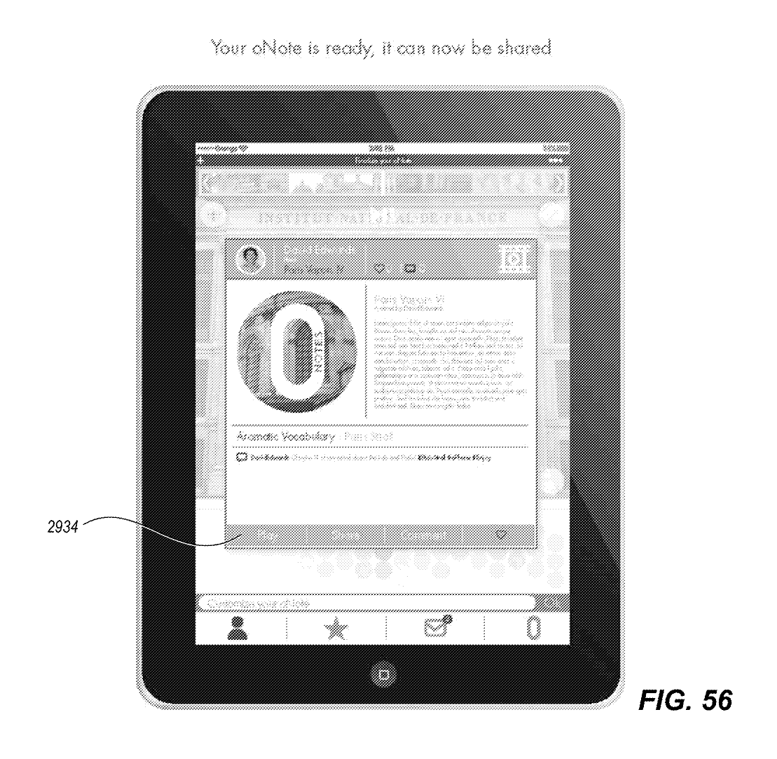

FIG. 54 illustrates the scent message window 2924 also shown in FIG. 33 before the user has added information about the newly created scent message. As discussed above, the user can add information about the scent message including a title, a photo, a description, and comments. As shown in FIG. 55, the user can tap on an OK icon 2998 once the user is satisfied with the information that has been added for the scent message. Then, once the scent message has been created, the user can then play, share, or comment on the scent message by selecting the appropriate icon 2934, as discussed above (FIG. 56).

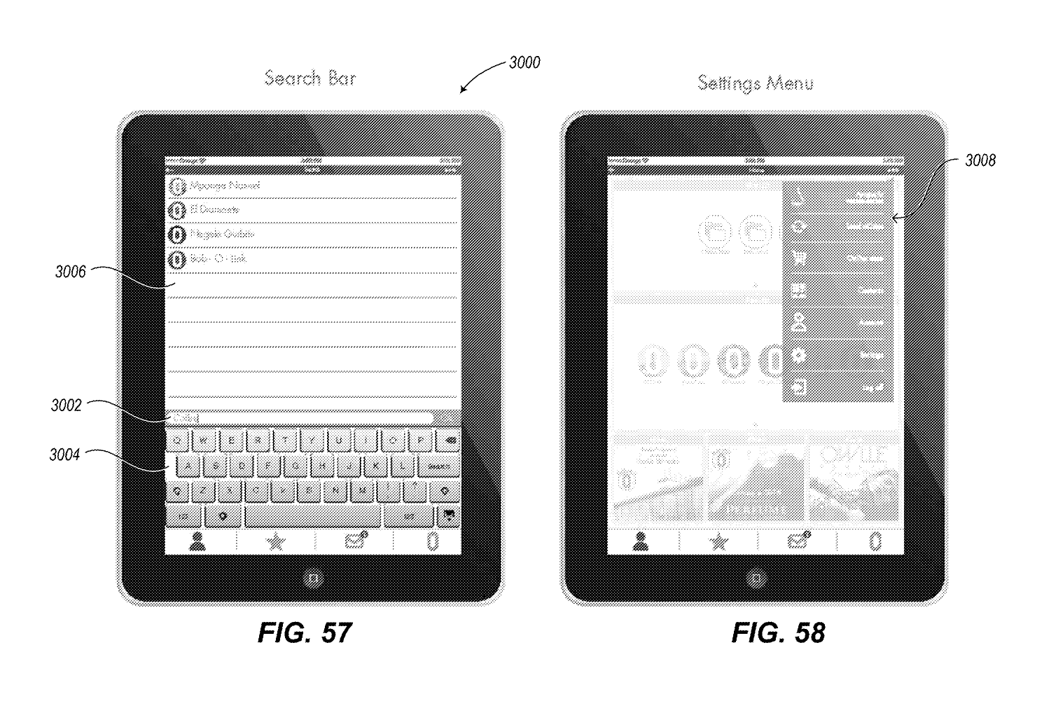

FIG. 57 is a screenshot of a search window 3000 of the social media application. The user may type text into a search bar 3002 using an on-screen keyboard 3004, and the application will search through various locations (e.g., the user's mailbox, newsfeed, folders, etc.) to locate scent messages responsive to the search terms. The results are displayed in a search results section 3006 at the top of the search window 3000.

FIG. 58 illustrates a settings menu 3008 of the social media application. The setting menu 3008 allows the user to select or download one or more aromatic vocabularies. The user can also “load” scent cartridges into the social media application. For example, the social media application may communicate with a scent dispensing device associated with the user to determine which scent cartridges are currently loaded in the scent dispensing device. The settings menu 3008 may also allow the user to manage contacts, manage a user account, and purchase content or products through an online store.

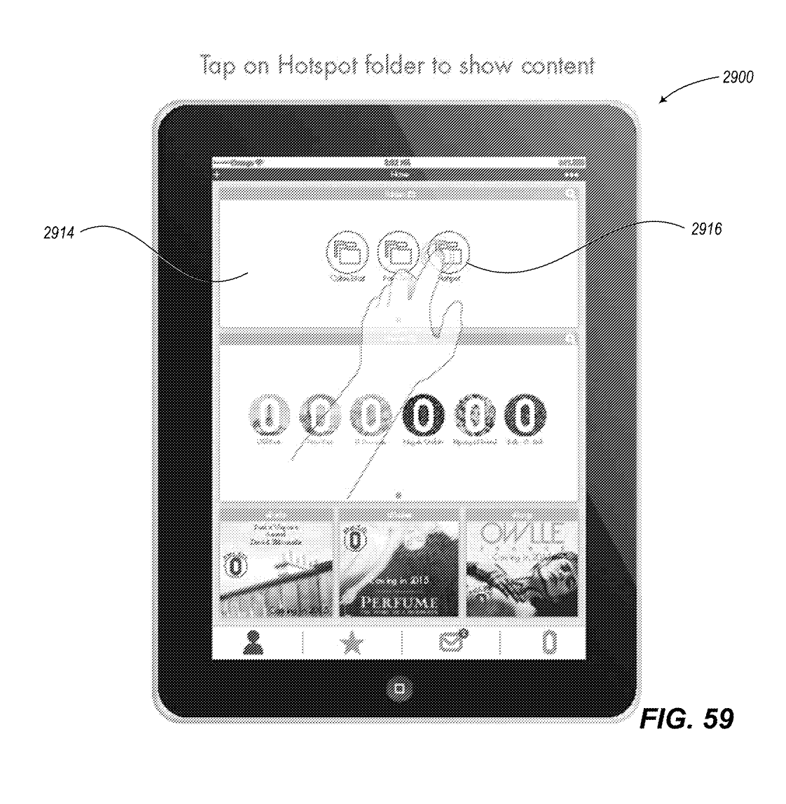

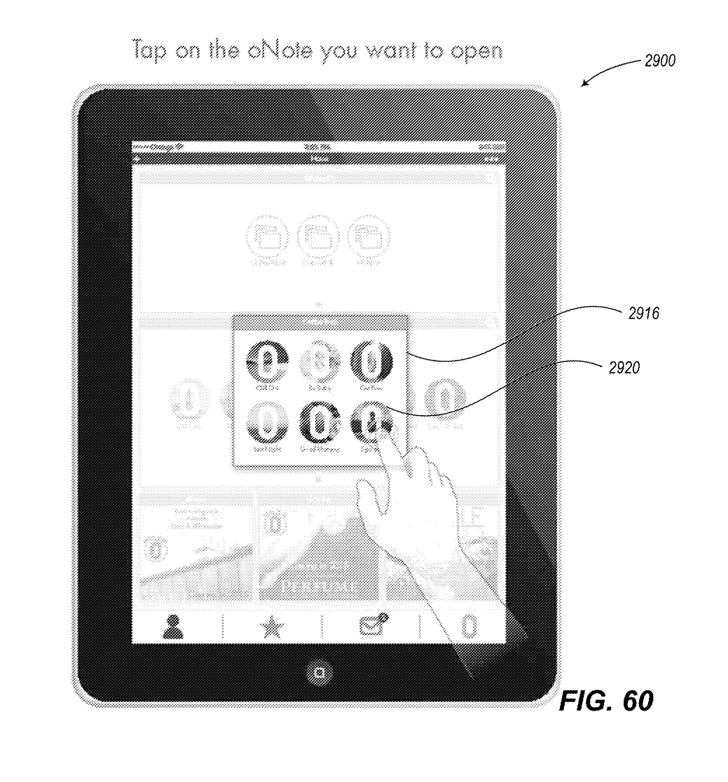

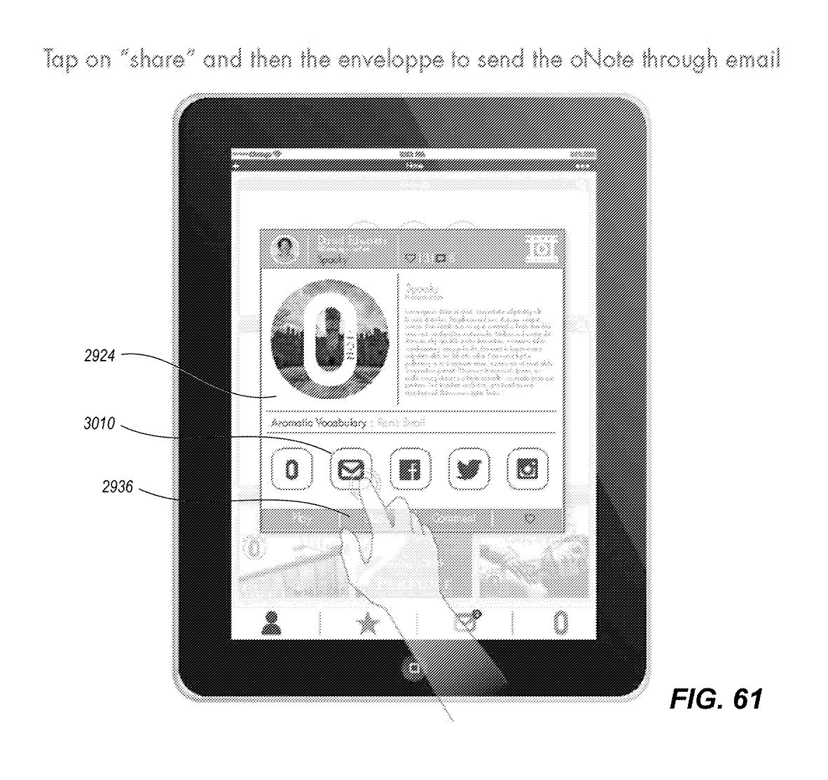

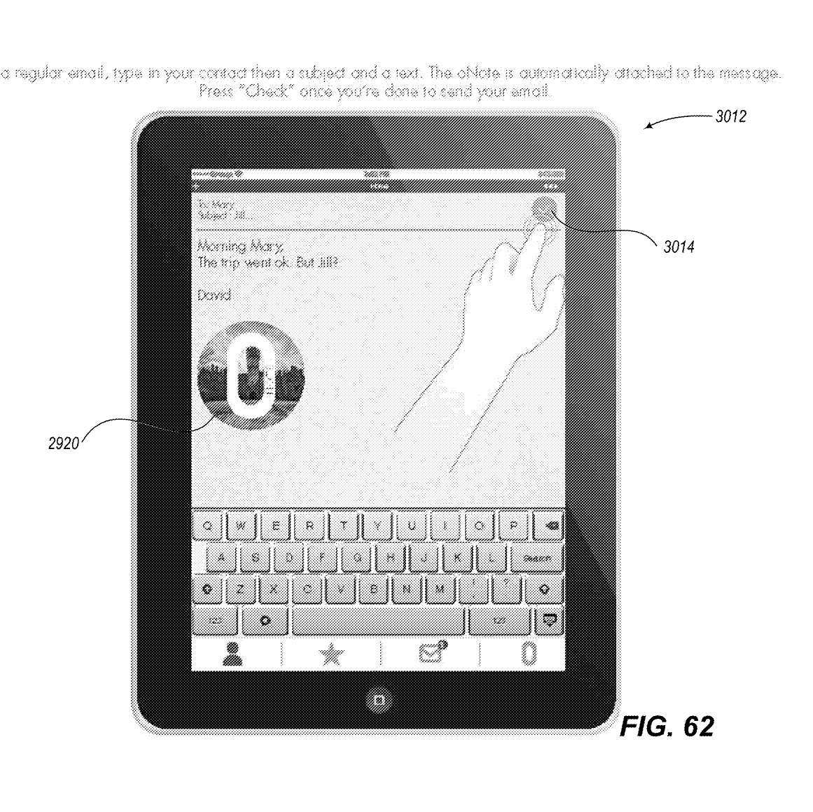

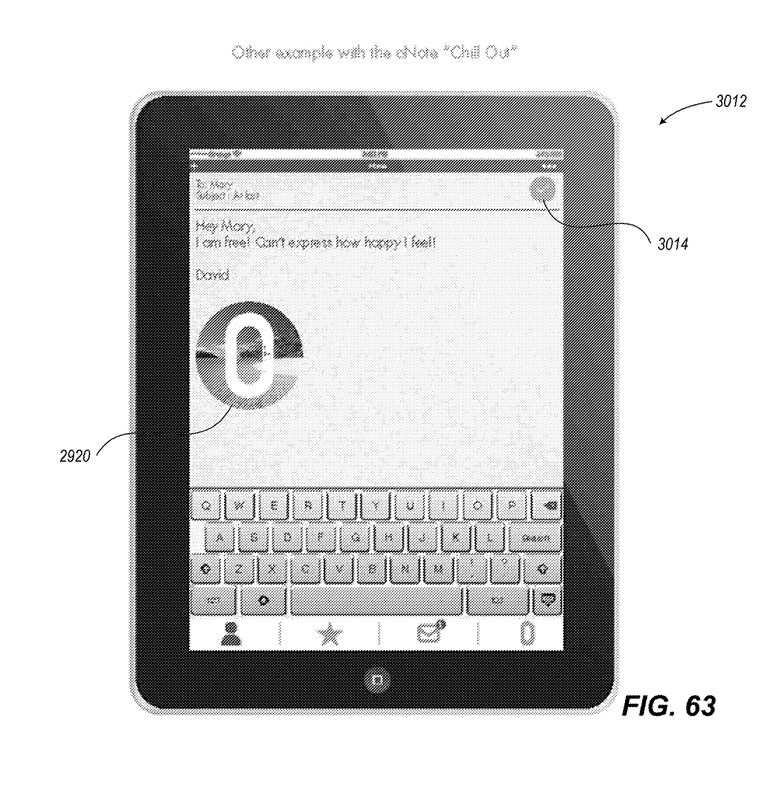

FIGS. 59-63 are screenshots illustrating the process for sending a scent message as an email using the social media application. The user first selects a folder 2916 and a scent message 2920 to open from the home screen 2900 (FIGS. 59 and 60). In the scent message window 2924, the user selects the share icon 2936 then selects an email icon 3010 that is shaped like an envelope (FIG. 61). An email window 3012 pops up that allows the user to type in one or more recipients, a subject, and text (FIGS. 62 and 63). The selected scent message 2920 is automatically attached to the email message. The user can then select a send button 3014 to send the email message to the email account of the selected recipients. The recipients may then open the email (e.g., using a browser or an email client), select the scent message, and open the scent message using the social media application executing on the recipients' computing devices. If the recipient has not yet joined the network of the social media application, the recipient may be directed to a site where they can download or join the social media application.

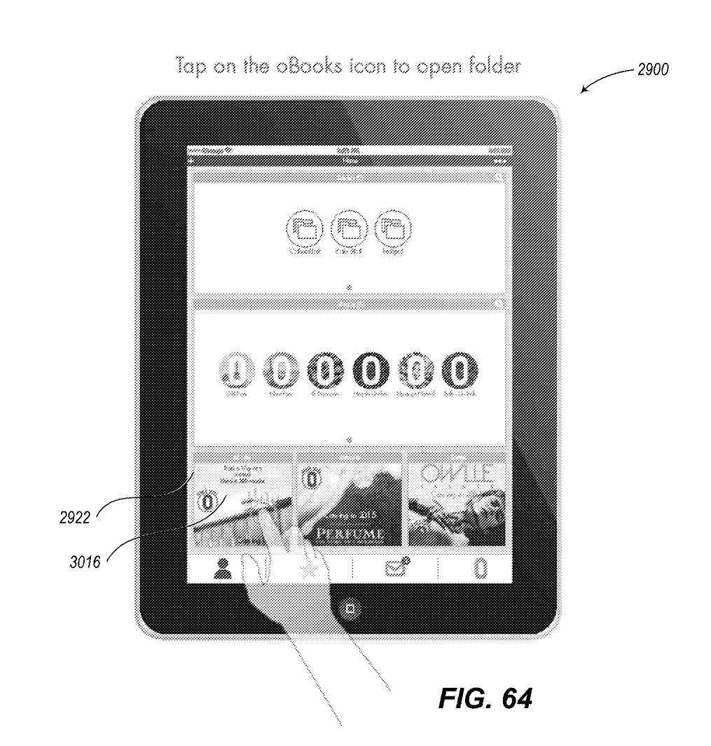

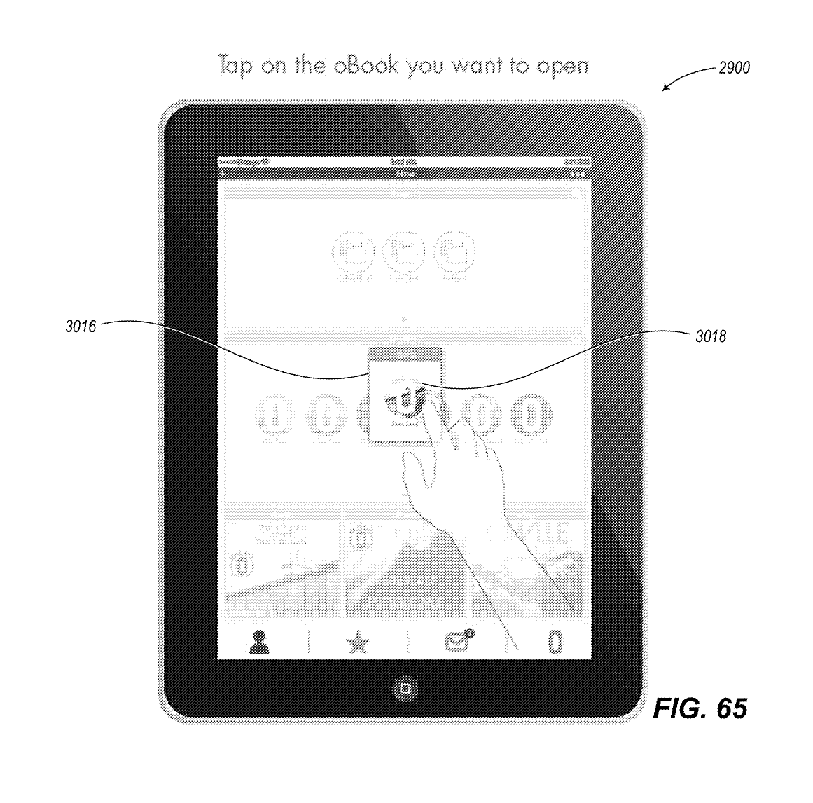

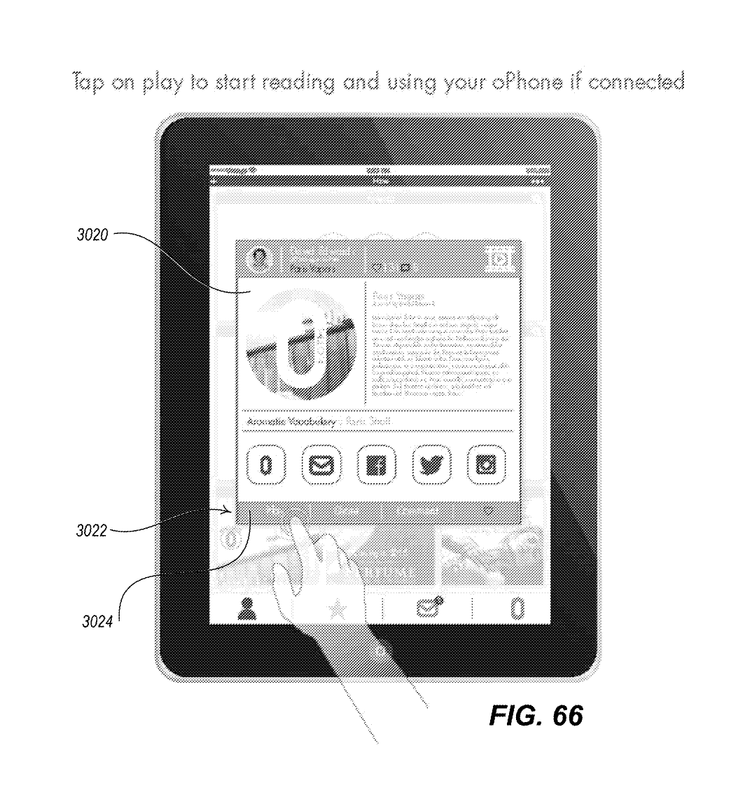

FIGS. 64-71 are screenshots illustrating a process for opening and viewing an electronic book in the social media application. The user first selects a books icon 3016 from the content section 2922 of the home screen 2900 of the social media application (FIG. 64). The user then taps on a book 3018 to open (FIG. 65). A book window 3020 opens that includes information about the selected book 3018 and options 3022 to play, share, or comment on the book. The user selects a play icon 3024 to begin playback of the book 3018 on the mobile device (FIG. 66).

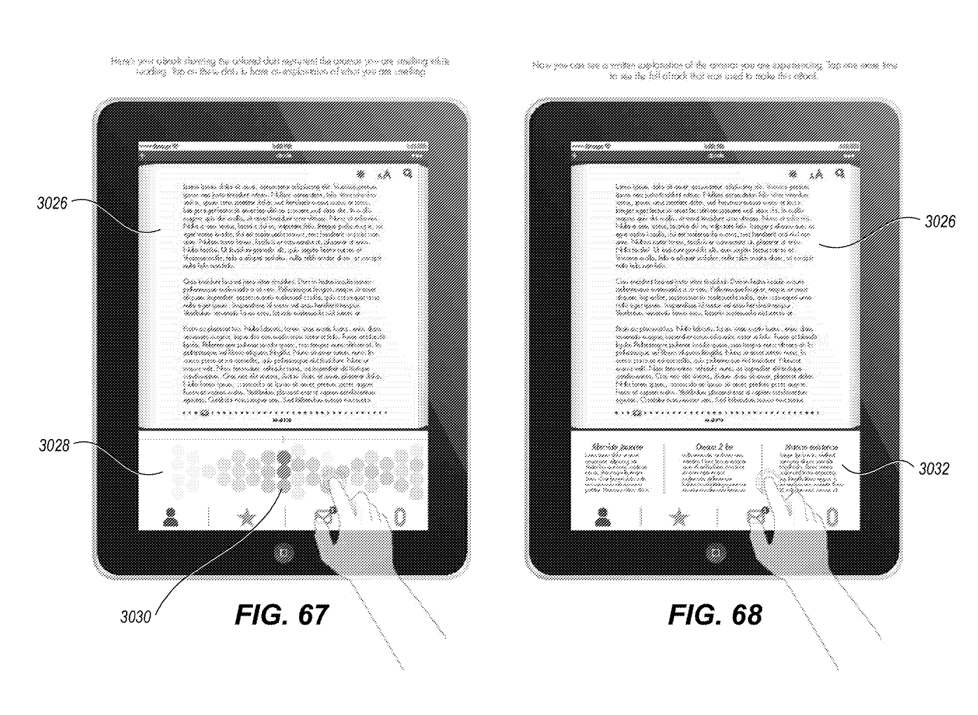

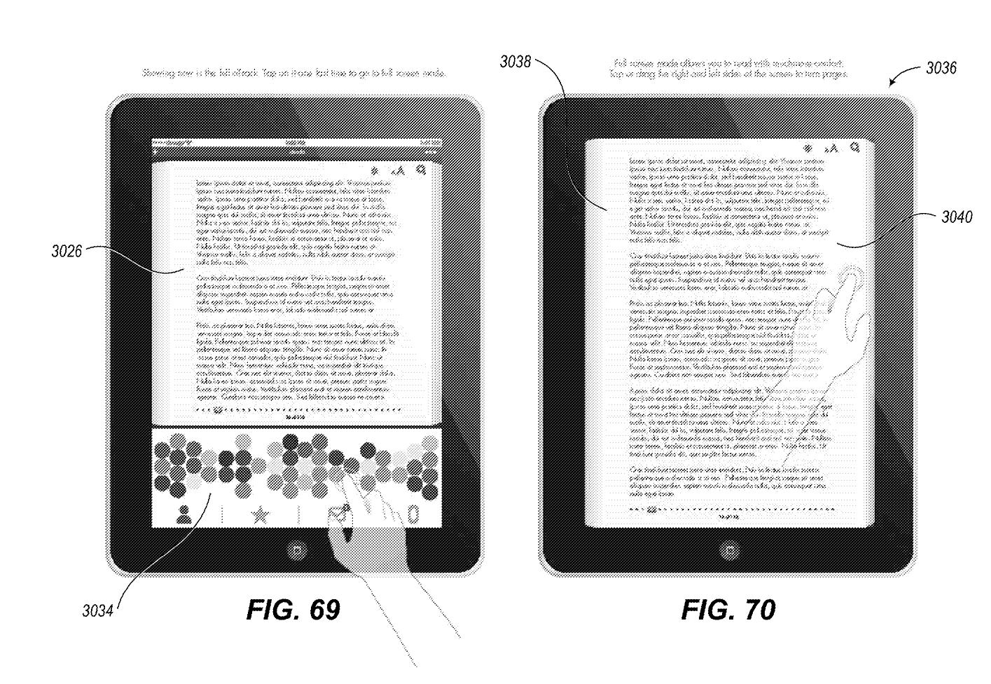

As shown in FIG. 67, the pages of the book 3018 are then displayed in an upper portion 3026 of the screen. A lower portion 3028 of the screen displays dots 3030 representing scents (or a scent track) associated with the book 3018 that can be dispensed by a scent dispensing device while the user reads the book. The social media application may control the dispensing of the scents to correspond to the user's location in the book 3018. As shown in FIG. 68, a written explanation 3032 of the scent currently being dispensed is displayed on the screen of the mobile device when the user taps on the dots 3030 at the bottom of the screen. When the user taps on the written explanation 3032, the entire scent track 3034 may be displayed to the user (FIG. 69).

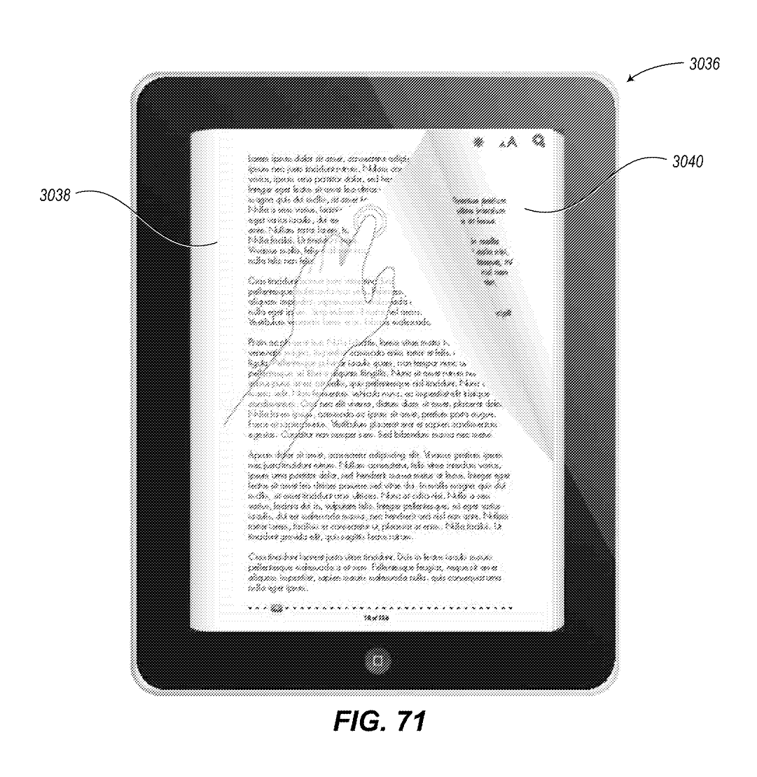

FIGS. 70 and 71 illustrate a user-friendly full screen reading mode display 3036 of the social media application. The user may tap or drag his or her finger at the left side 3038 and the right side 3040 of the screen to turn the pages in the book 3018.

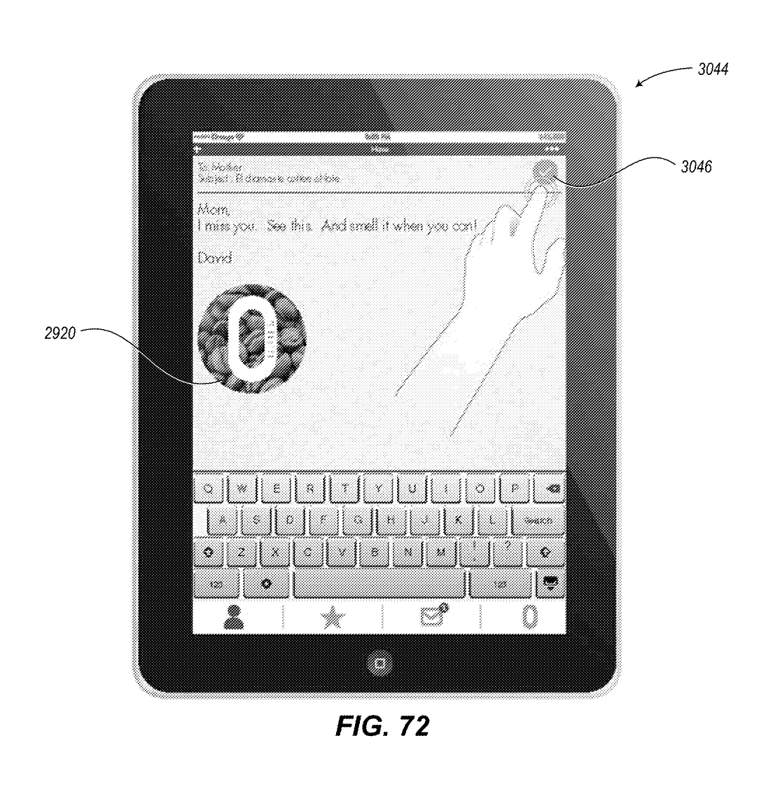

FIG. 72 is a screenshot illustrating process for sharing a scent message 2920 using a private message within the social media application. As discussed above with reference to FIGS. 34 and 35, the user may open the scent message 2920, select the share icon 2936 (FIG. 34), and select a private message icon 3042 (FIG. 35). A private message window 3044 shown in FIG. 72 is then opened which allows the user to add one or more recipients, a subject, and text, to the private message. The user can tap on a send icon 3046 to send the private message to the one or more selected recipients. The recipients will then be able to view the received scent message 2920 using the mailbox of the social media application, as described above with reference to FIG. 44.

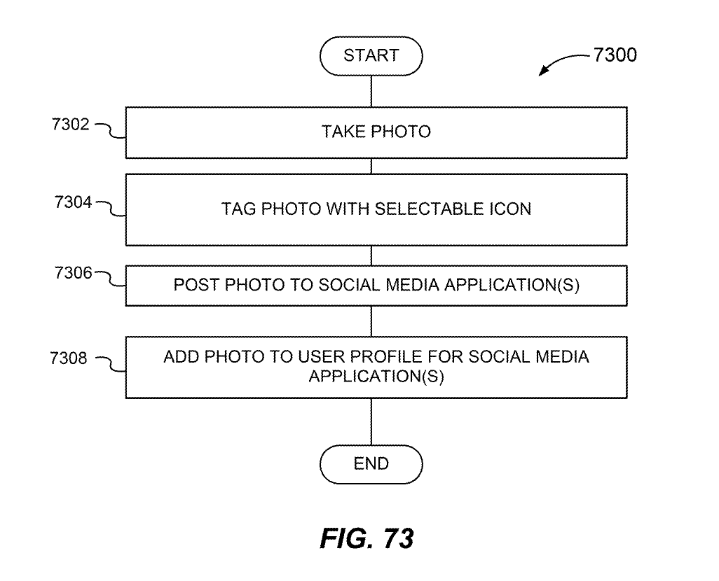

FIG. 73 is a flowchart of a method 7300 of operating a scent dispensing system, according to one illustrated embodiment. One or more acts included in the method 7300 may be performed by the first mobile device 1604 or the second mobile device 1608, for example, after a processing unit (e.g., processing unit 1812) of the first mobile device 1604 loads a software application including computer-executable instructions into RAM (e.g., RAM 1822) and executes the instructions. The application may instruct or cause the processing unit to cause a touch screen (e.g., touch screen 1852) to display a series of prompts, receive information input in response to the prompts, store the received information in RAM (e.g., RAM 1822) of system memory (e.g., system memory 1814), process and/or transform the received information, and transmit information corresponding to the received information via a network interface (e.g., network interface 1860). One or more acts included in the method 7300 may also be performed by the server 1606, for example, after a processing unit (e.g., processing unit 1912a) of the server loads a software application including computer-executable instructions into RAM (e.g., RAM 1922) and executes the instructions.

At 7302, a user takes, captures, or otherwise acquires a photo on a computing device. The photo may depict nearly anything including a location, event, food, beverage, product, or the like. At 7304, the user may operate the application to tag or associate the photo with a selectable icon. For example, the selectable icon may be a graphical icon that depicts a logo for the social media application discussed above with reference to FIGS. 29-72. The selectable icon may also depict a logo for a particular scent message (e.g., the logo 2930 shown in FIG. 33). The selectable icon embeds a link or reference to one or more resources (e.g., scent messages, webs sites, applications, etc.).

At 7306, the user may post the photo containing the selectable icon to one or more social media applications, such as Facebook®, Instagram®, Twitter®, Vine®, Snapchat®, and the like. Users of the social media applications may view the photo and select the selectable icon (e.g., by tapping on the icon, by hovering over the icon, etc.). When a user of the social media application selects the selectable icon associated with the photo, one or more actions may occur. For example, in some embodiments, the user's computing device may be directed to a location where it can download the social media application discussed above with reference to FIGS. 29-72. If the user already has the social media application installed on the computing device, selecting the selectable icon may cause the social media application to open on the user's computing device. In the case where the selectable icon is associated with a particular scent message, the scent message may be provided to the computing device for playback thereon when the user selects the selectable icon.

At 7308, the user may add the photo and associated selectable icon to the user's profile on one or more social media applications. For example, if the user likes a particular brand of coffee, the user may take a photo of the coffee and add a selectable icon to the photo that encodes a link to a scent message that includes a scent for the coffee. When another user selects the selectable icon, the other user's computing device may be controlled to provide the user with the scent message. The receiving user may then play back the scent message on his or her computing device and experience the scent using a scent dispensing device connected to the computing device.

Although the selectable icon is discussed above with reference to a photo, it should be appreciated that links associated with scent messages and/or the social media application of FIGS. 29-72 may be embedded in other types of content, such as videos, messages, audio, digital posts, and the like.

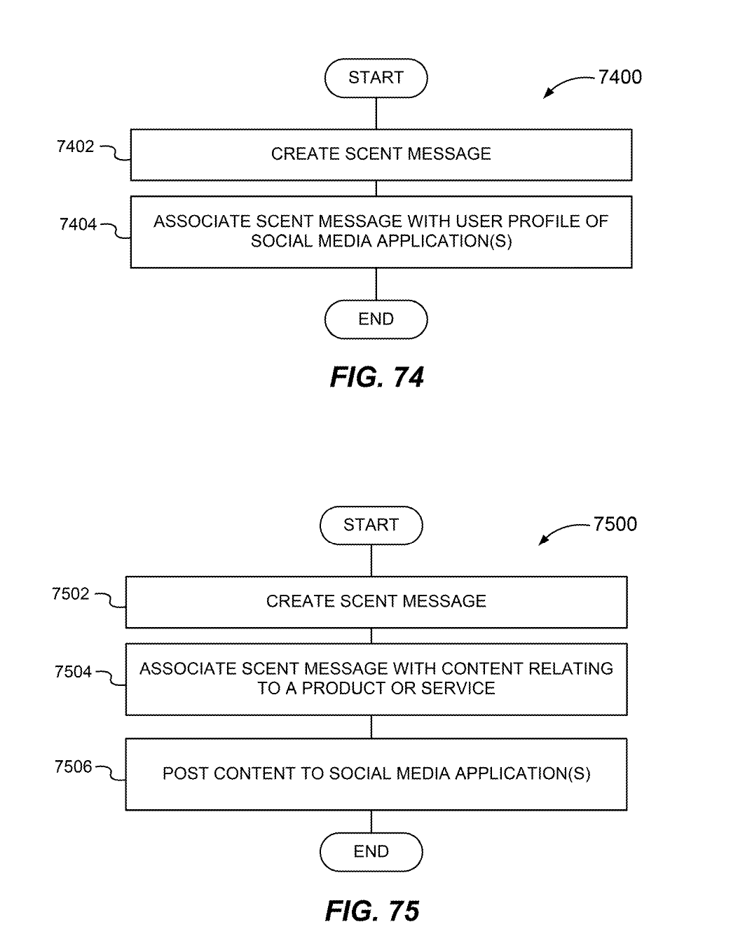

FIG. 74 is a flowchart of a method 7400 of creating an olfactive identity for a user of a social media application. Generally, an olfactive identity is a module of either a single or composite of scents. An olfactory identity can be associated with a user's social media platform account profile, similar to basic information such as name or birthday. Alternatively, it can be used transitorily, such as for a status update.

At 7402, the user operates the social media application to create a scent message comprising a single scent or a composition of scents for use as the user's olfactive identity. The process for creating a scent message is discussed above with reference to FIGS. 47-56. In some embodiments, the user may obtain a scent message previously created by the user or by another entity or user. At 7404, the user operates the social media application to associate the scent message with the user's profile for one or more social media applications. Subsequently, an icon for the olfactive identity may appear on one or more pages associated with the user (e.g., a profile page). Other users may select the icon for the olfactive identity so that they may experience it using a computing device and/or a scent dispensing device.

FIG. 75 illustrates a flowchart of a method 7500 for associating scent messages with one or more products or services. At 7502, a scent message is created. The process for creating a scent message is discussed above with reference to FIGS. 47-56. In some embodiments, a scent message may have been previously created. At 7504, the scent message is associated with content relating to a product or service. The content may be, for example, a photo or a video. At 7506, the content may be posted to one or more social media applications. Users of the social media applications may then select the content via graphical user interfaces associated with the one or more social media applications. Selecting the content causes the scent message to be provided to the user, as described above.

In one example, a user may operate an application executing on a computing device to generate a grocery shopping list. The application may associate one or more scent messages with one or more items on the user's shopping list. For example, coffee may be one of the items on the shopping list, and the application may provide the user with a scent message that relates to coffee. The user can therefore get a “virtual taste” of one or more types of coffee using the computing device and/or a connected scent dispensing device, as discussed above.

As another example, a café owner may add one or more scent messages to a web site associated with the café, or a social media application page associated with the café. Users interested in the café may select the one or more scent messages to experience one or more products offered by the café without having to be physically present. Similarly, customers of the café may create a digital post of a coffee that they experienced at the café so that their social media contacts or followers can get a virtual taste of the coffee using their computing device and/or a scent dispensing device.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments. For example, instead of starting operation of the fan at 2304, the first scent dispensing device 1602 may start operation of the fan after the one or more scent cartridges are oriented at 2310. Additionally, instead of stopping operation of the fan at 2320, the first scent dispensing device 1602 may stop operation of the fan before returning each of the one or more scent cartridges to the default position at 2318.

In addition, the first scent dispensing device 1602 may include a display device and a user input device (e.g., a touch screen) that enables a user to specify scents and/or durations of scents to be dispensed by the first scent dispensing device 1602 (e.g., without receiving any message from the first mobile device 1604). The microcontroller of the first scent dispensing device 1602 may store instructions that cause the first scent dispensing device 1602 to perform the method shown in FIG. 21. Additionally, the microcontroller of the first scent dispensing device 1602 may store instructions that cause the first scent dispensing device 1602 to display a selectable icon that, when selected, causes the microcontroller to display a user interface that enables a user to specify scents to be dispensed by the first scent dispensing device 1602. For example, the user interface may include a plurality of selectable icons, wherein each selectable icon includes an identifier of the scent medium 1234 included in one of the chambers 1232 of one of the scent cartridges loaded in the first scent dispensing device 1602. In response to one or more of the icons being selected, the microcontroller causes a corresponding scent or scent combination to be dispensed for a predetermined or a user-specified amount of time.

U.S. provisional patent application Ser. No. 61/944,866 filed Feb. 26, 2014, is incorporated herein by reference, in its entirety.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A computer-implemented method of messaging in a social network environment, the method comprising:
receiving a scent message at a social network service over a communications network, the scent message comprising at least one of a scent specification file or a reference to a scent specification file stored in a data storage, the scent specification file specifies at least one scent dispensable by a scent dispensing device; and
sending the scent message to a receiving client device of a receiving user of the social network service over the communications network.

2. The computer-implemented method of claim 1, further comprising:
sending the scent specification file to the receiving client device.

3. The computer-implemented method of claim 2, further comprising:
in response to receiving the scent specification file, causing scent dispensing instructions to be sent from the receiving client device to a scent dispensing device.

4. The computer-implemented method of claim 3, further comprising:
causing at least one scent to be dispensed according to the scent dispensing instructions receive by the scent dispensing device.

5. The computer-implemented method of claim 4 wherein the scent message comprises at least one of an audio portion and a visual portion, the method further comprising:
presenting the at least one of the audio portion and the visual portion by the receiving client device during at least a portion of the dispensing of the at least one scent at the scent dispensing device.

6. The computer-implemented method of claim 1 wherein the scent message comprises at least one of an audio portion and a visual portion, the method further comprising:
presenting the at least one of the audio portion and the visual portion by the receiving client device.

7. The computer-implemented method of claim 1 wherein the scent message comprises a reference to at least one of an audio portion and a visual portion, the at least one of the audio portion and the visual portion stored in a data storage.

8. The computer-implemented method of claim 1, further comprising:
receiving the scent specification file from a sending client device over the communications network; and
sending the scent specification file to the receiving client device.

9. The computer-implemented method of claim 8 wherein the scent message comprises a reference to the scent specification file stored in the data storage, the method further comprising:
receiving a request including the reference to the scent specification file;
retrieving the scent specification file from the data storage; and
sending the scent specification file to the receiving client device responsive to the received request.

10. The computer-implemented method of claim 9 wherein the receiving a request includes receiving a request originating at the receiving client device.

11. The computer-implemented method of claim 1 wherein the scent specification file includes timing information for the dispensing of the at least one scent on a scent dispensing device.

12. The computer-implemented method of claim 11 wherein the timing information specifies the at least one scent is dispensed sequentially a number N times.

13. The computer-implemented method of claim 11 wherein the scent message comprises at least one of an audio portion and a visual portion, and the timing information associates playback of the at least one scent with the at least one of the audio portion and the visual portion.

14. The computer-implemented method of claim 11 wherein the scent specification file specifies a plurality of scents and comprises a visual portion, the visual portion providing a time-based visual illustration of the scent specification file.

15. The computer-implemented method of claim 1 wherein sending the scent message comprises sending a personal message to the receiving client device through the social network service.

16. The computer-implemented method of claim 1 wherein sending the scent message comprises generating a digital post associated with the scent message on the social network service that is viewable on the receiving client device.

17. The computer-implemented method of claim 1 wherein sending the scent message comprises sending an email to the receiving client device.

18. The computer-implemented method of claim 1 wherein the scent message comprises at least one of an audio portion and a visual portion.

19. The computer-implemented method of claim 1 wherein the scent specification file specifies a sequence of scents.

20. The computer-implemented method of claim 1, further comprising:
receiving a comment from a client device of a user of the social network service; and
associating the comment with the scent message.

21. The computer-implemented method of claim 20 wherein sending the scent message comprises generating a digital post associated with the scent message on the social network service that is accessible on the receiving client device, and associating the comment with the scent message comprises adding the received comment to the generated digital post.

22. The computer-implemented method of claim 1, further comprising:
receiving a modification instruction associated with the scent message from a client device; and
generating a modified scent specification file according to the modification instruction.

23. The computer-implemented method of claim 1, further comprising:
causing a presentation of a scent sequence specification user interface on a display of a sending client device, the scent sequence specification user interface including a scent palette of a set of user selectable scent icons, each of the user selectable scent icons corresponding to a respective scent, the scent sequence specification user interface further including an array of scent specification fields which are selectively populatable via selections of the user selectable scent icons from the scent palette;
receiving inputs via the scent sequence specification user interface; and
generating the scent specification file based at least in part on the inputs received via the scent sequence specification user interface.

24. The computer implemented method of claim 23, further comprising:
storing the scent specification file in a data storage.

25. The computer-implemented method of claim 23 wherein causing the presentation of the scent sequence specification user interface includes causing a presentation of the scent sequence specification user interface including two or more categories of scents.

26. The computer-implemented method of claim 23 wherein causing the presentation of the scent sequence specification user interface includes causing a presentation of a first array of user selectable scent icons each of which represents a respective scent of a first category of scent, and at least a second array of user selectable scent icons each of which represents a respective scent of a second category of scent, the second category of scent different from the first category of scent.

27. The computer-implemented method of claim 1, further comprising storing the scent specification file on a data storage of a service other than the social network service.

28. A computer-implemented method of messaging in a social network environment, the method comprising:
receiving a digital post from a sending client device at a social network service over a communications network, the digital post identifying at least one scent dispensable by a scent dispensing device; and
sending the received digital post to a receiving client device of a receiving user of the social network service for viewing on a display of the receiving client device.

29. The computer-implemented method of claim 28, further comprising:
receiving a selection of the digital post from the receiving client device; and
responsive to receiving the selection of the digital post, sending a scent specification file to the receiving client device, the scent specification file encoding instructions for dispensing the at least one scent.

30. The computer-implemented method of claim 28, further comprising:
sending scent dispensing instructions from the receiving client device to a scent dispensing device.

31. The computer-implemented method of claim 28 wherein receiving a selection of the digital post comprises detecting that the receiving user has selected a link using a user interface of the receiving client device.

32. The computer-implemented method of claim 28 wherein receiving a digital post includes receiving a digital post that includes at least one of an audio portion and a visual portion.

33. The computer-implemented method of claim 32 wherein receiving a digital post includes receiving a digital post that includes a visual portion comprising at least one of a text portion, an image portion, and a video portion.

34. The computer-implemented method of claim 28 wherein the digital post comprises a selectable reference to a scent message, the scent message specifying the at least one scent.

35. The computer-implemented method of claim 34 wherein the scent message comprises at least one of an audio portion and a visual portion.

36. The computer-implemented method of claim 34 wherein the scent message comprises at least one of an audio portion, a visual portion, a reference to an audio portion stored in a data storage, and a reference to a visual portion stored in a data storage.

37. A client device to facilitate participation in a social network service for a user of the client device, comprising:
a user interface comprising a display;
a communications interface that provides communication with a scent dispensing device of the user and communication with the social network service;
a processor coupled to the user interface and the communications interface; and
a computer-readable storage medium that stores instructions that, when executed by the processor, cause the client device to:
present a digital post on the display, the digital post providing an indication of at least one scent specified by a user of the social network service different than the user of the client device;
receive a selection of the digital post from the user via the user interface; and
receive a scent specification file that includes instructions for the dispensing the at least one scent.

38. The client device of claim 37 wherein the instructions cause the client device to:
send at least a portion of the scent specification file to the scent dispensing device.

39. The client device of claim 38 wherein the communications interface is a wireless communications interface, and the instructions cause the client device to send at least a portion of the scent specification file to the scent dispensing device over the wireless communications interface.

40. The client device of claim 37 wherein the digital post comprises a reference to a scent message stored in a data storage, the scent message specifies the at least one scent, and the instructions cause the client device to:
receive the scent message from the data storage via the communications interface.

41. The client device of claim 40 wherein the scent message comprises at least one of an audio portion and a visual portion.

42. The client device of claim 41 wherein the scent message associates the at least one scent with the at least one of the audio portion and the visual portion.

43. The client device of claim 37 wherein the communications interface comprises a short-range radio and antenna interface.

44. The client device of claim 37 wherein the instructions cause the client device to:
receive inputs from the user via the user interface;
modify a scent specification file for the specified at least one scent based at least in part on the received inputs to generate at least one modified scent specification file;
generate a digital post associated with the at least one modified scent specification file; and
send the digital post to a computing device of the social network service such that the digital post is subsequently viewable by at least one other client device connected to the social network service.

45. The client device of claim 37 wherein the scent dispensing device receives a consumable scent cartridge and stores a contents indicator for the consumable scent cartridge when the consumable scent cartridge is removably disposed within the scent dispensing device;
wherein the instructions cause the client device to:
send a message to the scent dispensing device requesting the stored contents indicator; and
receive a message from the scent dispensing device that includes the requested contents indicator.

46. The client device of claim 45 wherein the consumable scent cartridge includes a memory that stores the contents indicator, and the scent dispensing device comprises a memory access portion operative to access the memory of the consumable scent cartridge to read the contents indicator.

47. The client device of claim 46 wherein the memory access portion comprises at least one electrical contact that interfaces with an electrical contact of the consumable scent cartridge that is communicatively coupled to the memory of the consumable scent cartridge.

48. The client device of claim 45 wherein the instructions cause the client device to:
identify a social network service contact of the user;
send a request for a contents indicator for a scent dispensing device associated with the social media service contact; and
receive the contents indicator from a computing device associated with the social network service.

49. The client device of claim 37 wherein the consumable scent cartridge contains a consumable quantity of scent medium, and the instructions cause the client device to:
monitor a present level of the quantity of scent medium present in the consumable scent cartridge; and
provide an indication of the present level to the user via the user interface.

50. The client device of claim 37 wherein the instructions cause the client device to track at least one of a number of uses and a duration of use for the consumable scent cartridge.

51. The client device of claim 37 wherein the scent dispensing device comprises a sensor operative to measure a physical characteristic of the quantity of scent medium, and the instructions cause the client device to monitor a signal that corresponds to an output of the sensor.

52. The client device of claim 37 wherein the communications interface provides communication with a plurality of scent dispensing devices, each of the plurality of scent dispensing devices operative to dispense a plurality of scents, and the instructions cause the client device to:
receive inputs from the user via the user interface, the inputs defining at least one scent specification file and a selection of at least one of the plurality of scent dispensing devices; and
send the at least one scent specification file to the selected at least one of the plurality of scent dispensing devices over the communications interface, wherein each of the scent dispensing devices in the selected at least one of the plurality of scent dispensing devices dispenses a scent according to the scent specification file.

53. The client device of claim 52 wherein the communications interface comprises a wireless interface.

54. The client device of claim 52 wherein the instructions cause the client device to send the same selected at least one scent specification file to at least two of the plurality of scent dispensing devices.

55. The client device of claim 52 wherein the selected at least one scent specification file comprises at least two scent specification files, and the instructions cause the client device to send the at least two scent specification files to different ones of the plurality of scent dispensing devices.

56. A client device to facilitate participation in a social network service for a user of the client device, comprising:
a user interface comprising a display;
a communications interface operative to provide communication with an external device;
a processor coupled to the user interface and the communications interface; and
a computer-readable storage medium that stores instructions that, when executed by the processor, cause the client device to:
present a scent sequence specification selection interface on the display, the scent sequence specification selection interface including a scent palette of a set of user-selectable scent icons, each of the user selectable scent icons corresponding to a respective scent, the scent sequence specification selection interface further including an array of scent specification fields which are selectively populatable via selections of the user selectable scent icons from the scent palette;
receive inputs from the user via the user interface;
generate a scent specification file based at least in part on the received inputs;
generate a digital post associated with the scent specification file; and
send the digital post to a computing device of the social network service so that the digital post is subsequently viewable by at least one other client device connected to the social network service.

57. The client device of claim 56 wherein the instructions cause the client device to receive inputs from the user via the user interface specifying at least one of text, audio, and video, and to associate the at least one of text, audio, and video with the digital post.

58. The client device of claim 56 wherein the scent specification file is stored on a data storage, and the digital post includes a reference to the scent specification file accessible by at least one other client device connected to the social network service.

59. The client device of claim 56 wherein the scent specification file specifies at least one scent and specifies timing information for dispensing of the at least one scent on a scent dispensing device.

60. A client device to facilitate participation in a social network for a user of the client device, the client device comprising:
a user interface comprising a display;
a communications interface that provides communication with a scent dispensing device, the scent dispensing device operative to dispense a plurality of scents;
a processor coupled to the user interface and the communications interface; and
a computer-readable storage medium that stores instructions that, when executed by the processor, cause the client device to:
establish a link with a media player that provides media content for consumption by the user;
receive time-based signals from the media player that relate to the media content; and
control the dispensing of scents by the scent dispensing device according to the received time-based signals.

61. The client device of claim 60 wherein the media player comprises a video player and the time-based signals comprise video time code signals.

62. The client device of claim 60 wherein the media player comprises an audio player and the time-based signals comprise audio watermark signals.

63. The client device of claim 60 wherein the media player comprises an electronic book reader and the time-based signals are indicative of the user's location in a textual document.

64. A client device to facilitate participation in a social network for a user of the client device, comprising:
a user interface comprising a display;
a communications interface that provides communication with a scent dispensing device, the scent dispensing device operative to dispense a plurality of scents;
a processor coupled to the user interface and the communications interface; and
a computer-readable storage medium that stores instructions that, when executed by the processor, cause the client device to:
establish a link with a sensing device comprising a sensor operative to sense input and generate a sensor output dependent on the sensed input;
receive signals from the sensing device that correspond to the sensor output; and
control the dispensing of scents by the scent dispensing device according to the received signals.

65. The client device of claim 64 wherein the sensor of the sensing device senses a physical characteristic of the user, and the instructions cause the client device to control the dispensing of scents by the scent dispensing device dependent on the sensed physical characteristic of the user.

66. A computer-implemented method of messaging in a social network environment, the method comprising:
providing an image file;
providing a graphical icon comprising a reference to a resource, the resource relating at least one of a scent message or a scent message application;
associating the graphical icon with the image file; and
posting the image file and the associated graphical icon to a social network service where the graphical icon is selectable by a user of the social network service.

67. The method of claim 66, further comprising:
receiving a selection of the graphical icon from a client computing device; and
providing the resource to the client computing device responsive to receiving the selection.

68. The method of claim 67 wherein providing the resource to the client computing device comprises serving a web page to the client computing device.

69. The method of claim 67 wherein providing the resource to the client computing device comprises sending a scent message to the client computing device.

70. A computer-implemented method of messaging in a social network environment, the method comprising:
providing a content file that relates to at least one product or service;
associating a reference to a resource with the content file, the resource relating to at least one scent dispensable by a scent dispensing device;
posting the content file to a social network service;
receiving a selection relating to the content file from a client computing device; and
causing the resource to be sent to the client computing device responsive to receiving the selection.

71. The method of claim 70 wherein causing the resource to be sent to the client computing device comprises causing an application to be sent to the client computing device for execution by a processor of the client computing device, and the application causes the client computing device to present one or more scent messages to a user of the client computing device.

72. The method of claim 70 wherein causing the resource to be sent to the client computing device comprises causing a scent message to be sent to the client computing device.
